(19) United States
(12) Patent Application Publication
(10) Pub. No.: US 2011/0039721 A1
(43) Pub. Date: Feb. 17, 2011

(54) METHOD FOR PREDICTION ABOUT CARCINOGENICITY OF SUBSTANCE IN RODENT

(75) Inventors: Yoshikuni Yakabe, Saitama (JP); Hiroshi Matsumoto, Saitama (JP); Fumiyo Saito, Saitama (JP); Koichi Saito, Osaka-shi (JP); Kayo Sumida, Osaka-shi (JP); Koji Nakayama, Tokyo (JP); Masaru Sekijima, Tokyo (JP)

Correspondence Address: BIRCH STEWART KOLASCH & BIRCH, PO BOX 747, FALLS CHURCH, VA, 22040-0747, US

(73) Assignees: Chemicals Evaluation and Research Institute, Tokyo (JP); Sumitomo Chemical Co., Ltd., Tokyo (JP); Mitsubishi Chemical Medience Corporation, Tokyo (JP)

(21) Appl. No.: 12/810,100

(22) PCT Filed: Dec. 26, 2008
(86) PCT No.: PCT/JP2008/073865

§ 371 Date: Sep. 21, 2010

(30) Foreign Application Priority Data
Dec. 28, 2007 (JP) 2007-340406

(51) Int. Cl. C40B 30/04

(52) U.S. Cl. 506/9

(57) ABSTRACT

Disclosed is a method for predicting about the carcinogenicity of a substance of interest in a rodent, which comprises the steps of: administering a solution of the substance to a test group and administering a solvent used in the solution to a control group; extracting mRNA from each of the test group and the control group, and measuring the expression level of mRNA for each of genes obtained by selecting at least one gene from (A) genes each comprising a nucleotide sequence depicted in any one of SEQ ID NOs: 1 to 5, (B) genes each comprising a nucleotide sequence depicted in any one of SEQ ID NOs: 6 to 8 and (C) genes each comprising a nucleotide sequence depicted in any one of SEQ ID NOs: 9 to 32; determining whether or not a significant difference in the level of mRNA expressed from the gene is observed between the test group and the control group; and determining that the substance has carcinogenicity when a significant difference in the level of the expression of mRNA from any one of the genes is observed between the test group and the control group and the direction of increase or decrease in the level of the expression of mRNA from any one of the genes is the same as the tendency which is previously defined for each gene.

### TECHNICAL FIELD

The present invention relates to a carcinogenicity prediction method for predicting the carcinogenicity of a test substance in a rodent by measuring the expression level of mRNA expressed from given genes after administering the test substance to a rodent such as a rat or a mouse.

### BACKGROUND ART

Evaluation of long-term toxicity is one of the evaluation items of the hazard of a chemical substance. In order to evaluate the long-term toxicity of a chemical substance such as carcinogenicity, it is necessary to perform an animal experiment requiring considerable expense and a long testing period.

In an animal experiment for evaluating the carcinogenicity of a chemical substance, the chemical substance is continuously administered to a test animal until cancer is developed in the test animal or until the test animal dies. Since cancer is developed after a long latent period, a long-term animal experiment is needed.

On the other hand, due to a significant advancement of technology associated with genomic information in recent years, the evaluation of the hazard of a chemical substance is starting to be performed at the gene level. For example, Patent Document 1 describes a method for predicting the toxic activity of a chemical substance by detecting a difference in the expression of a gene in a tissue or a cell exposed to the chemical substance.

Also in the evaluation of the carcinogenicity of a chemical substance, it is predicted that there is a gene related to the mechanism of carcinogenesis. It is considered that the carcinogenicity of a chemical substance at the genetic level can be evaluated by detecting a difference in the expression of such a gene. However, the mechanism of carcinogenesis caused by a chemical substance at the genetic level has hardly been elucidated. Accordingly, it is very difficult to predict the carcinogenicity of a chemical substance from a difference in the gene expression.

The present inventors comprehensively obtained the information of the gene expression profiling of rats using a DNA microarray and found a method for predicting the carcinogenicity of a test substance from the gene-expression patterns, which was applied for a patent previously (Patent Document 2).

In this method, carcinogens are divided into three groups in advance according to the similarity of the gene-expression pattern. This method is a prediction method in which the gene-expression pattern common in each of these 3 groups is compared with the gene expression pattern for a test substance, and the carcinogenicity of the test substance is predicted from the degree of consistency of the gene expression pattern. In this method, the gene-expression patterns for a lot of carcinogens are obtained in advance, and the gene-expression patterns are prepared in advance for each group of carcinogens. Subsequently, the degree of consistency between these prepared gene-expression patterns and the gene expression pattern for the test substance is calculated. In order to calculate this degree of consistency, it is necessary to acquire an enormous quantity of data and to perform a computation processing. Therefore, the development of a simpler method for predicting the carcinogenicity of a test substance has been demanded.
Patent Document 1: JP-A-2003-304888 (Claims)
Patent Document 2: JP-A-2007-54022 (Claims)

### DISCLOSURE OF THE INVENTION

### Problems that the Invention is to Solve

An object of the invention is to provide a simple carcinogenicity prediction method which is a method for predicting the carcinogenicity of a test substance in a rodent in a short period by detecting an increase or a decrease in the expression of genes which have relevance to be involved in the mechanism of carcinogenesis at an early stage of development of cancer, and does not require acquisition of an enormous quantity of data or complicated calculation.

### Means for Solving the Problems

The present inventors examined in detail the expression level of mRNA expressed from the respective genes for each of the three groups of carcinogens. As a result, the inventors found that a group of genes for which the expression level of mRNA is different between a group with the administration of carcinogens and a group with the administration of non-carcinogens apparently exists for each group of carcinogens. It was confirmed that by using these genes in combination, the carcinogenicity of a test substance can be predicted, and thus, the invention has been completed.

That is, the invention for achieving the above object is as described below.

(1) A method for predicting the carcinogenicity of a test substance in a rodent, comprising the steps of:

administering a solution of the test substance prepared by dissolving or dispersing the test substance in a solvent to a test group and administering the solvent used for the preparation of the solution of the test substance to a control group;

extracting mRNA from each group after a period of administration of the solution of the test substance or the solvent to each group;

measuring the expression level of mRNA expressed from each of genes obtained by selecting one or more genes from each of the following (A) to (C):

(A) genes each comprising a nucleotide sequence depicted in any one of SEQ ID NOs: 1 to 5;

(B) genes each comprising a nucleotide sequence depicted in any one of SEQ ID NOs: 6 to 8; and

(C) genes each comprising a nucleotide sequence depicted in any one of SEQ ID NOs: 9 to 32;

determining whether or not a significant difference in the expression level of mRNA expressed from each of the selected genes is observed between the test group and the control group by a significant difference test; and

determining that the test substance has carcinogenicity when a significant difference in the expression level of mRNA expressed from any one of the selected genes is observed between the test group and the control group and the direction of increase or decrease in the expression level of the mRNA in the test group relative to the control group is the same as that previously defined for each gene from which the mRNA is expressed.

(2) A method for predicting the carcinogenicity of a test substance in a rodent, comprising the steps of:

administering a solution of the test substance prepared by dissolving or dispersing the test substance in a solvent to a test group and administering the solvent used for the preparation of the solution of the test substance to a control group;

extracting mRNA from each group after a period of administration of the solution of the test substance or the solvent to each group;

measuring the expression level of mRNA expressed from each of genes obtained by selecting one or more genes from each of the following (A) to (C):

(A) genes each comprising a nucleotide sequence depicted in any one of SEQ ID NOs: 1 to 5;

(B) genes each comprising a nucleotide sequence depicted in any one of SEQ ID NOs: 6 to 8; and

(C) genes each comprising a nucleotide sequence depicted in any one of SEQ ID NOs: 9 to 32;

determining whether or not a significant difference in the expression level of mRNA expressed from each of the selected genes is observed between the test group and the control group by a significant difference test; and

determining that the test substance has carcinogenicity when a significant difference in the expression level of mRNA expressed from any one of the selected genes is observed between the test group and the control group and the direction of increase or decrease in the expression level of the mRNA in the test group relative to the control group is the same as that previously defined for each gene from which the mRNA is expressed, and determining that the test substance has no carcinogenicity when a significant difference in the expression level of mRNA is not observed between the test group and the control group for all of the selected genes, or even if a significant difference in the expression level of mRNA expressed from any one of the selected genes is observed between the test group and the control group, when the direction of increase or decrease in the expression level of the mRNA expressed from the gene in the test group relative to the control group is not the same as that previously defined for each gene.

(3) The method for predicting the carcinogenicity of a test substance in a rodent according to (1) or (2), wherein the period of administration of the solution of the test substance is from 1 to 90 days.

(4) The method for predicting the carcinogenicity of a test substance in a rodent according to (1) or (2), wherein a test animal in the test group and the control group is a rat, a mouse, a hamster, or a guinea pig.

(5) The method for predicting the carcinogenicity of a test substance in a rodent according to (1) or (2), wherein the gene selected from (A) is a gene comprising a nucleotide sequence depicted in SEQ ID NO: 2, the gene selected from (B) is a gene comprising a nucleotide sequence depicted in SEQ ID NO: 7, and the gene selected from (C) is a gene comprising a nucleotide sequence depicted in SEQ ID NO: 10.

(6) A method for predicting the carcinogenicity of a test substance in a rodent, comprising the steps of:

administering a solution of the test substance prepared by dissolving or dispersing the test substance in a solvent to a test group and administering the solvent used for the preparation of the solution of the test substance to a control group;

extracting mRNA from each group after a period of administration of the solution of the test substance or the solvent to each group;

measuring the expression level of mRNA expressed from each of genes obtained by selecting one or more genes from each of the following (A) to (C):

(A) genes each comprising a nucleotide sequence depicted in any one of SEQ ID NOs: 1 to 5;

(B) genes each comprising a nucleotide sequence depicted in any one of SEQ ID NOs: 6 to 8; and

(C) genes each comprising a nucleotide sequence depicted in any one of SEQ ID NOs: 9 to 32; and the following gene (D):

(D) a gene comprising a nucleotide sequence depicted in SEQ ID NO: 33;

determining whether or not a significant difference in the expression level of mRNA expressed from each of the genes is observed between the test group and the control group by a significant difference test; and

determining that the test substance has carcinogenicity when a significant difference in the expression level of mRNA expressed from any one of the genes is observed between the test group and the control group and the direction of increase or decrease in the expression level of the mRNA in the test group relative to the control group is the same as that previously defined for each gene from which the mRNA is expressed.

(7) The method for predicting the carcinogenicity of a test substance in a rodent according to (6), wherein the period of administration of the solution of the test substance is from 1 to 90 days.

(8) The method for predicting the carcinogenicity of a test substance in a rodent according to (6), wherein the gene selected from (A) is a gene comprising a nucleotide sequence depicted in SEQ ID NO: 2, the gene selected from (B) is a gene comprising a nucleotide sequence depicted in SEQ ID NO: 7, and the gene selected from (C) is a gene comprising a nucleotide sequence depicted in SEQ ID NO: 10.

### ADVANTAGE OF THE INVENTION

In the invention, by measuring the expression level of mRNA expressed from given genes, the carcinogenicity of a test substance in a rodent such as a rat, a mouse, a hamster, or a guinea pig can be predicted. The calculation necessary for the prediction is calculation of a significant difference in the expression level of mRNA between a test group and a control group. The comparison of the expression level of mRNA may be performed for only about three or four genes, and the method needs only extremely simple data processing.

The administration of the test substance to a rodent is performed for a short period of time ranging from about 1 to 90 days. Therefore, a long-term animal experiment in which, for example, repeated administration of a compound is performed until cancer is developed in a test animal is not needed.

According to the invention, the carcinogenicity of a test substance in a rodent can be predicted with high accuracy by a short-term test and simple data processing.

### BEST MODE FOR CARRYING OUT THE INVENTION

The method for predicting the carcinogenicity of a test substance of the invention is performed by the following procedure.

First, in order to administer a test substance to a test group, a solution of the test substance is prepared by dissolving or dispersing the test substance in a solvent.

The test substance to be used as a target for the method for predicting the carcinogenicity in the invention is an arbitrary chemical substance. The form of the test substance may be any form of a solid, a powder, a liquid, and a mixture thereof. The test substance is appropriately formed into a solution or a dispersion and is subjected to a test.

The solvent to be used for dissolving the test substance is not particularly limited and any solvent can be used as long as it is a non-carcinogenic vehicle capable of dissolving or dispersing the test substance. For example, a solvent widely used in an animal experiment such as corn oil or purified water can be exemplified. When the test substance is dispersed, a non-carcinogenic dispersant such as a detergent can be used.

The dose of the test substance is preferably a dose which causes a moderate increase or decrease in the expression level of mRNA in a test animal due to stimulation with the test substance. The dose thereof can be determined based on the lethal dose 50% (LD₅₀) value of the test substance in the test animal. The daily dose thereof is preferably from 1/250 to ½ the LD₅₀ value, more preferably from 1/50 to ½ the LD₅₀ value, furthermore preferably from 1/10 to ½ the LD₅₀ value.

The thus prepared solution of the test substance is administered to the test group, and the solvent used for the preparation of the solution of the test substance is administered to the control group. The volume of the solvent to be administered to the control group is set to the same volume as the solution of the test substance administered to the test group. The test animal in the test group and the control group is a rodent such as a rat, a mouse, a hamster, or a guinea pig.

The period of administration to each group is set to 1 to about 90 days. From the viewpoint that the test is performed more rapidly, the administration period is preferably from 1 to 28 days, more preferably from 1 to 14 days. It is preferred that during the administration period, the solution of the test substance or the solvent is repeatedly administered once to several times a day (preferably once a day).

The method for administration of the solution of the test substance or the solvent to the test animal is not particularly limited, and a widely used method such as oral administration, intraperitoneal administration, or intravenous administration can be used.

After completion of the administration period, a tissue is immediately collected from each of the test animals in the test group and the control group. After mRNA is extracted and purified from the tissue of each of the test animals by a known method, the expression level of mRNA is measured.

Examples of the tissue to be collected for measuring the expression level of mRNA include liver, intestine, lung, kidney, stomach, spleen, brain, and blood.

As the method for measuring the expression level of mRNA, a known method such as a method in which fluorescently labeled cDNA or cRNA prepared from the mRNA is hybridized to a DNA microarray or microplate on which cDNA or DNA having a sequence complementary to the mRNA has been immobilized, Northern blotting, quantitative RT-PCR, or an RNase protection assay can be used.

In the case where the expression level of mRNA is measured using a DNA microarray, it is possible to use a commercially available product such as GeneChip (trade name, manufactured by Affymetrix, Inc.) or Rat Oligo Microarray Kit (trade name, manufactured by Agilent Co., Ltd.) as the array.

The mRNA to be measured for the expression level is mRNA expressed from each of genes in the following (A) to (C):

(A) genes each comprising a nucleotide sequence depicted in any one of SEQ ID NOs: 1 to 5;

(B) genes each comprising a nucleotide sequence depicted in any one of SEQ ID NOs: 6 to 8; and

(C) genes each comprising a nucleotide sequence depicted in any one of SEQ ID NOs: 9 to 32.

In the invention, one or more genes are selected from each of the above (A) to (C), and the expression level of mRNA expressed from each of the selected genes is measured. The number of genes to be selected from each of the groups (A) to (C) is an arbitrary number of 1 or greater with the proviso that the number of genes belonging to the respective groups is the upper limit. The number of genes to be selected from each of the groups (A) to (C) may be the same or different. From the viewpoint that the operation is simplified while maintaining the accuracy of prediction of carcinogenicity to be high, the number of genes to be selected from (A) to (C) is preferably from 1 to about 3, more preferably 1 or 2, and most preferably 1, respectively.

The expression level of mRNA expressed from each of the selected genes is measured for each of the test group and the control group. Thereafter, the measured expression level of mRNA is compared between the test group and the control group. When the measured expression level of mRNA satisfies both of the following two requirements (1) and (2), the test substance is determined to have carcinogenicity.

(1) A significant difference in the expression level of mRNA expressed from at least any one of the genes measured for the expression level of mRNA is observed between the test group and the control group.

(2) The direction of increase or decrease in the expression level of mRNA expressed from at least any one of the genes for which a significant difference in the expression level of mRNA was observed in (1) in the test group relative to the expression level of mRNA in the control group is the same as that defined for each gene.

The determination as to whether or not a significant difference in the expression level of mRNA is observed between the test group and the control group is performed by a significant difference test. In the significant difference test, a known test method such as a t-test, a U-test, an F-test, a Dunnett method, a Tukey method, a Kruskal-Wallis test, a Wilcoxon test, or a Steel-Dwass method can be adopted.

The direction defined for each gene is a direction which indicates a change, either an increase or a decrease in the expression level of mRNA expressed from each gene when a carcinogen was administered to a rodent. Specifically, it is the direction of increase or decrease shown in the following Table 1.

TABLE 1

| | | Direction of increase (+) |
|---|---|---|
| Gene group | SEQ ID NO | or decrease (−) |
| A | 1 to 4 | + |
| | 5 | − |
| B | 6, 7 | + |
| | 8 | − |
| C | 9 to 18 | + |
| | 19 to 32 | − |

The present inventors have found that the gene expression patterns obtained when each of a lot of carcinogens was administered to a rodent are divided into three patterns according to the similarity thereof. The groups of the carcinogens divided into three patterns are as follows.

### (Group 1)

2,4-diaminotoluene, quinoline, diethylnitrosamine, 2-nitropropane, N-nitrosomorpholine, furan, N-nitrosodimethylamine, N-nitrosopiperidine, 2-acetylaminofluorene, 2-amino-3,8-dimethylimidazo[4,5-f]quinoxaline, methylcarbamate, thioacetoamide, urethane, acetoamide, methapyrilene hydrochloride, 3′-methyl-4-dimethylaminoazobenzene, 1,4-dioxane

### (Group 2)

safrole, clofibrate, di(2-ethylhexyl)phthalate, hexachlorobenzene, α-hexachlorocyclohexane, D,L-ethionine, chlorendic acid, 2-amino-1-methyl-6-phenylimidazo[4,5-b]-pyridine, 7,12-dimethylbenz[a]anthracene, 3-methylcholanthrene, 4-nitroquinoline-1-oxide, N-ethyl-N-nitrosourea, benzo[a]pyrene, 4-dimethylaminoazobenzene, aldrin, di(2-ethylhexyl)adipate, trichloroethylene, butylated hydroxyanisole, d-limonene, tetrachloroethylene, 1,4-dichlorobenzene, phenyloin sodium salt, trichloroacetic acid

### (Group 3)

ethynyl estradiol, chloroform, benz[a]anthracene, pentachloroethane, diethylstilbestrol, phenobarbital

The above-mentioned genes in (A), (B), and (C) are genes for which the expression level of mRNA significantly increases or decreases to the direction as shown in Table 1 when the carcinogens in Group 1, Group 2, and Group 3 were administered to a rodent, respectively. The genes in (A) to (C) are genes for which the expression level of mRNA is not significantly increased or decreased by the administration of the carcinogens in other groups or non-carcinogens. Therefore, when the expression level of mRNA expressed from any one of the genes selected from each of (A) to (C) significantly increases or decreases to the direction as shown in Table 1, the test substance is determined to have carcinogenicity, and in the case where there is no such a gene, the test substance is determined to have no carcinogenicity.

Among the genes in the above (A) to (C), a combination with particularly high prediction accuracy is a combination selected from the genes each comprising a nucleotide sequence depicted in the sequence identification number (SEQ ID NO) shown below.
(A) SEQ ID NOs: 1 to 4
(B) SEQ ID NOs: 6 and 7
(C) SEQ ID NOs: 9, 10, 14, 15, 17, 21, 22, 30, 31, and 32

Among the combinations selected from the above-mentioned genes, combinations shown below are more preferred.
(A) SEQ ID NO: 1, (B) SEQ ID NO: 7, (C) SEQ ID NO: 10
(A) SEQ ID NO: 3, (B) SEQ ID NO: 7, (C) SEQ ID NO: 10
(A) SEQ ID NO: 4, (B) SEQ ID NO: 7, (C) SEQ ID NO: 10
(A) SEQ ID NO: 2, (B) SEQ ID NO: 7, (C) SEQ ID NO: 9
(A) SEQ ID NO: 2, (B) SEQ ID NO: 7, (C) SEQ ID NO: 10
(A) SEQ ID NO: 2, (B) SEQ ID NO: 7, (C) SEQ ID NO: 14
(A) SEQ ID NO: 2, (B) SEQ ID NO: 7, (C) SEQ ID NO: 15
(A) SEQ ID NO: 2, (B) SEQ ID NO: 7, (C) SEQ ID NO: 17
(A) SEQ ID NO: 2, (B) SEQ ID NO: 7, (C) SEQ ID NO: 21
(A) SEQ ID NO: 2, (B) SEQ ID NO: 7, (C) SEQ ID NO: 22
(A) SEQ ID NO: 2, (B) SEQ ID NO: 7, (C) SEQ ID NO: 30
(A) SEQ ID NO: 2, (B) SEQ ID NO: 7, (C) SEQ ID NO: 31
(A) SEQ ID NO: 2, (B) SEQ ID NO: 7, (C) SEQ ID NO: 32

Further, among the above-mentioned combinations, the most preferred combination is a combination of (A) a gene having a nucleotide sequence depicted in SEQ ID NO: 2, (B) a gene having a nucleotide sequence depicted in SEQ ID NO: 7, and (C) a gene having a nucleotide sequence depicted in SEQ ID NO: 10.

As another prediction method of the invention, there is a method in which the expression level of mRNA expressed from a gene comprising a nucleotide sequence depicted in SEQ ID NO: 33 as a gene (D) is also measured in addition to the genes in the above (A) to (C).

The gene (D) is basically a gene for which the expression level of mRNA decreases when a carcinogen in Group 2 was administered to a rodent.

The carcinogens in Group 2 have a tendency that a gene for which a significant difference in the expression level of mRNA is observed is different between liver carcinogens and the other carcinogens. In the case of the genes in the above (B), a significant difference in the expression level of mRNA is sometimes not observed by the administration of carcinogens other than liver carcinogens. Therefore, by using the gene in (B) and the gene (D) in combination, the accuracy of the prediction for the carcinogens in Group 2 is improved. Therefore, by measuring the expression level of mRNA expressed from each of the genes in the above (A) to (C) and the gene (D), the occurrence of cases where a carcinogen in Group 2 is erroneously determined to be a non-carcinogen is decreased, and the accuracy of the prediction of carcinogenicity is further increased.

### EXAMPLES

### Examination Example 1

A test solution was prepared by dissolving each of the carcinogens and the non-carcinogens shown in Tables 2 to 6 in the corresponding solvent shown in Tables 2 to 6. Each of the thus prepared test solutions and the solvents used for the preparation was administered by oral gavage to rats in each group. As the rats, male rats (F344 SPF rats) at 5 weeks of age obtained from Charles River Laboratories Japan, Inc. were used. The animals were divided into groups, each containing four individuals. The volume of the solvent administered to the vehicle control group was set to the same volume as that of the test solution administered to the carcinogen administration group or the non-carcinogen administration group. The administration of the test solution or the solvent was performed once daily for 28 days. Apiece was excised from the liver of each of the rats after a lapse of 28 days from the initiation of the administration, and the total RNA was extracted and purified. By using an in-house oligo-DNA microarray (number of UniGene ID based on UniGene database released on 2007/05/16: 6,689, length of gene per probe: 60 mer), the amount of each mRNA contained in the total RNA was measured.

The substance numbers (Substance No.) of the used carcinogens and non-carcinogens, the solvents used for the preparation of the test solutions, and the doses administered to the rats are shown in Tables 2 to 6.

TABLE 2

| | Substance | | Dose |
|---|---|---|---|
| Chemical substance | No. | Solvent | (mg/kg/day) |
| Clofibrate | TS001 | Corn oil | 250 |
| Di(2-ethylhexyl)phthalate | TS002 | Corn oil | 300 |
| Carbon tetrachloride | TS003 | Corn oil | 50 |
| 2,4-Diaminotoluene | TS004 | Water | 10 |
| 2,6-Diaminotoluene | TS005 | Water | 10 |
| Quinoline | TS006 | Corn oil | 25 |
| 8-Hydroxyquinoline | TS007 | Corn oil | 25 |
| Phenobarbital | TS008 | Water | 100 |
| D-Mannitol | TS009 | Water | 1000 |
| L-Ascorbic acid | TS010 | Water | 1000 |
| Diethylnitrosamine | TS011 | Water | 20 |
| 2-Nitro-p-phenylenediamine | TS012 | 1 w/v % | 100 |
| | | CMCNa | |
| 2-Nitropropane | TS013 | Corn oil | 40 |
| N-Nitrosomorpholine | TS014 | Water | 10 |
| Aldrin | TS015 | Corn oil | 0.3 |
| Dichloro-diphenyl-trichloroethane | TS016 | Corn oil | 25 |
| Dieldrin | TS017 | Corn oil | 0.3 |

TABLE 3

| | Substance | | Dose |
|---|---|---|---|
| Chemical substance | No. | Solvent | (mg/kg/day) |
| Di(2-ethylhexyl)adipate | TS018 | Corn oil | 1000 |
| Ethinylestradiol | TS019 | Corn oil | 0.5 |
| Hexachlorobenzene | TS020 | Corn oil | 5 |
| α-Hexachlorocyclohexane | TS021 | Corn oil | 20 |
| Trichloroethylene | TS022 | Corn oil | 700 |
| Butylated hydroxyanisole | TS023 | Corn oil | 750 |
| D-Limonene | TS024 | Corn oil | 1000 |
| Safrole | TS025 | Corn oil | 300 |
| 1,4-Dichlorobenzene | TS026 | Corn oil | 300 |
| 1,4-Dioxane | TS027 | Water | 1000 |
| Furan | TS028 | Corn oil | 10 |
| Methyl carbamate | TS029 | Water | 500 |
| Thioacetoamide | TS030 | Water | 20 |
| Acetaminophen | TS031 | 1% CMC- | 700 |
| | | 0.1% Tween 80 | |
| 2-Chloroethanol | TS032 | Water | 40 |

TABLE 4

| | Substance | | Dose |
|---|---|---|---|
| Chemical substance | No. | Solvent | (mg/kg/day) |
| 2-Chloromethylpyridine HCl | TS033 | Water | 150 |
| DL-Menthol | TS034 | Corn oil | 1000 |
| 4-Nitro-o-phenylenediamine | TS035 | 1 w/v % CMCNa | 250 |
| 1-Nitropropane | TS036 | Corn oil | 80 |
| Quercetin | TS037 | 1 w/v % CMCNa | 200 |
| Benzoin | TS038 | 5.0 w/v % aqueous | 500 |
| | | solution of gum arabic | |
| Iodoform | TS039 | Corn oil | 200 |
| Lithocholic acid | TS040 | 5.0 w/v % aqueous | 1000 |
| | | solution of gum arabic | |
| N-Nitrosodimethylamine | TS041 | Water | 0.2 |
| N-Nitrosopiperidine | TS042 | Water | 10 |
| 2-Acetylaminofluorene | TS043 | Corn oil | 6 |
| 2-amino-3,8-dimethylimidazo[4,5-f]quinoxaline | TS044 | 1 w/v % CMCNa | 20 |
| 2-amino-1-methyl-6-phenylimidazo[4,5-b]-pyridine | TS045 | 1 w/v % CMCNa | 5 |
| Benz[a]anthracene | TS046 | Corn oil | 50 |
| 7,12-Dimethylbenz [a]anthracene | TS047 | Corn oil | 1 |
| 3-Methylcholanthrene | TS048 | Corn oil | 2 |
| 4-Nitroquinoline-1-oxide | TS049 | Corn oil | 2 |
| N-Ethyl-N-nitrosourea | TS050 | Water | 3 |

TABLE 5

| | Substance | | Dose |
|---|---|---|---|
| Chemical substance | No. | Solvent | (mg/kg/day) |
| Trichloroacetic acid | TS051 | Water | 300 |
| Tannic acid | TS052 | Water | 1000 |
| Methapyrilene HCl | TS053 | Water | 50 |
| Urethane | TS054 | Water | 80 |
| Pentachloroethane | TS055 | Corn oil | 200 |
| Chloroform | TS056 | Corn oil | 90 |
| Lindane | TS057 | Corn oil | 10 |
| 2-Chloro-p-phenylenediamine SO₄ | TS058 | 1 w/v % | 100 |
| | | CMCNa | |
| p-Phenylenediamine 2HCl | TS059 | Water | 60 |
| 2,5-Toluenediamine SO₄ | TS060 | 1 w/v % | 50 |
| | | CMCNa | |
| 4-Acetylaminofluorene | TS061 | Corn oil | 40 |
| α-Tocopherol (Vitamin E) | TS062 | Corn oil | 1000 |
| Benzo[a]pyrene | TS063 | Corn oil | 15 |
| 1-Nitropyrene | TS064 | Corn oil | 5 |
| Tetrachloroethylene | TS066 | Corn oil | 100 |
| Acetamide | TS067 | Water | 1180 |
| Diethylstilbestrol | TS068 | Corn oil | 10 |
| Phenytoin Na | TS069 | Water | 160 |
| D,L-Ethionine | TS070 | Corn oil | 30 |
| Aspirin | TS071 | Corn oil | 27 |

TABLE 6

| | Substance | | Dose |
|---|---|---|---|
| Chemical substance | No. | Solvent | (mg/kg/day) |
| 4-(Chloroacetyl)acetanilide | TS072 | Corn oil | 250 |
| Phthalamide | TS073 | Corn oil | 1000 |
| Caprolactam | TS074 | Water | 375 |
| 4-Aminoazobenzene | TS075 | Corn oil | 50 |
| 3′-Methyl-4- | TS076 | Corn oil | 50 |
| dimethylaminoazobenzene | | | |
| 4-Dimethylaminoazobenzene | TS077 | Corn oil | 50 |
| Chlorendic acid | TS078 | Water | 100 |
| 1-Chloro-2-propanol | TS079 | Water | 100 |
| 3-Chloro-p-toluidine | TS080 | Corn oil | 300 |
| Glutaraldehyde | TS081 | Water | 50 |
| 4-Nitroanthranilic acid | TS082 | Corn oil | 1,000 |
| 1-Nitronaphthalene | TS083 | Corn oil | 100 |
| Sodium benzoate | TS084 | Water | 1000 |
| Indomethacin | TS085 | Corn oil | 5 |
| Methyleugenol | TS086 | 0.5 w/v % MC | 40 |
| o-Nitrotoluene | TS087 | Corn oil | 300 |
| Tris(2-chloroethyl)phosphate | TS088 | Corn oil | 88 |

The expression level of mRNA was compared between each of the chemical substance administration groups and the corresponding vehicle control group, and genes that satisfy the requirements described in (A) to (D) were selected, respectively.

(A) Genes for which the number of substances causing a significant change in the expression level among the carcinogens (17 substances) in Group 1 shown in Table 7 is 14 or more and the number of substances causing a significant change in the expression level among the non-carcinogens (26 substances) is 8 or less.

(B) Genes for which the number of substances causing a significant change in the expression level among the carcinogens (23 substances) in Group 2 shown in Table 7 is 13 or more and the number of substances causing a significant change in the expression level among the non-carcinogens (26 substances) is 8 or less.

(C) Genes for which the number of substances causing a significant change in the expression level among the carcinogens (6 substances) in Group 3 shown in Table 7 is 5 or more and the number of substances causing a significant change in the expression level among the non-carcinogens (26 substances) is 8 or less.

(D) Genes for which the expression level is significantly changed by a carcinogen by which the expression level for the gene in (B) is not changed among the carcinogens in Group 2 shown in Table 7.

TABLE 7

| | | Substance No. |
|---|---|---|
| Carcin- | Group 1 | TS004, TS006, TS011, TS013, TS014, TS027, TS028 |
| ogen | | TS029, TS030, TS041, TS042, TS043, TS044, TS053, |
| | | TS054, TS067, TS076 |
| | Group 2 | TS001, TS002, TS015, TS018, TS020, TS021, TS022, |
| | | TS023, TS024, TS025, TS026, TS045, TS047, TS048, |
| | | TS049, TS050, TS051, TS063, TS066, TS069, TS070, |
| | | TS077, TS078 |
| | Group 3 | TS008, TS019, TS046, TS055, TS056, TS068 |

| | |
|---|---|
| Non-carcinogen | TS005, TS007, TS009, TS010, TS032, TS033, TS034, |
| | TS035, TS038, TS039, TS040, TS057, TS058, TS059, |
| | TS060, TS062, TS071, TS072, TS073, TS074, TS079, |
| | TS080, TS082, TS083, TS084, TS085 |

The determination as to whether or not a significant difference in the expression level of mRNA is observed between the carcinogen administration group or the non-carcinogen administration group and the vehicle control group was performed as follows. The case where the expression level of mRNA in the carcinogen administration group or the non-carcinogen administration group is 1.5 times or more or 1/1.5 or less of the expression level of the corresponding mRNA expressed in the control group was determined to be significant. In this connection, the determination as to whether or not the change is significant was performed by taking into consideration the direction of increase or decrease in the expression level. In the case where the direction of increase or decrease is different as compared with the case where another carcinogen was administered, the change was determined to be not significant.

The gene numbers (Gene No.) of the genes selected by the above-mentioned method, the sequence identification numbers (SEQ ID NO) depicting the nucleotide sequences of the probes used in the detection of mRNA expressed from the genes, Unigene numbers (Unigene No.) of the genes, the sequence identification numbers (SEQ ID NO) depicting the nucleotide sequences of the genes listed in the Unigene database, the direction of the change in the expression level when the carcinogens were administered, and the number of substances which caused a change in the expression level are shown in Table 8.

TABLE 8

| | | Nucleotide | | Nucleotide | | Number of substances causing | |
|---|---|---|---|---|---|---|---|
| | | sequence of | | sequence of | | change in the expression level | |
| | | probe | | Unigene | Direction of | Carcinogens in | Non- |
| | Gene No. | (SEQ ID NO) | Unigene No. | (SEQ ID NO) | change | Groups 1 to 3 | carcinogens |
| A | 4218 | 1 | Rn.167075 | 34 | + | 14 | 2 |
| | 4846 | 2 | Rn.144554 | 35 | + | 17 | 2 |
| | 5600 | 3 | Rn.9836 | 36 | + | 14 | 2 |
| | 6182 | 4 | Rn.5834 | 37 | + | 15 | 6 |
| | 2026 | 5 | Rn.19133 | 38 | − | 14 | 6 |
| B | 2045 | 6 | Rn.19329 | 39 | + | 14 | 6 |
| | 2203 | 7 | Rn.21240 | 40 | + | 14 | 4 |
| | 1494 | 8 | Rn.1430 | 41 | − | 13 | 8 |
| C | 533 | 9 | Rn.106184 | 42 | + | 5 | 8 |
| | 813 | 10 | Rn.201760 | 43 | + | 5 | 3 |
| | 893 | 11 | Rn.164817 | 44 | + | 6 | 6 |
| | 1119 | 12 | Rn.9757 | 45 | + | 6 | 5 |
| | 1163 | 13 | Rn.11766 | 46 | + | 5 | 5 |
| | 1334 | 14 | Rn.120914 | 47 | + | 5 | 4 |
| | 2494 | 15 | Rn.23969 | 48 | + | 5 | 1 |
| | 3929 | 16 | Rn.4620 | 49 | + | 5 | 5 |
| | 6620 | 17 | Rn.120914 | 50 | + | 5 | 4 |
| | 6742 | 18 | Rn.9779 | 51 | + | 5 | 6 |
| | 154 | 19 | Rn.185941 | 52 | − | 6 | 8 |
| | 725 | 20 | Rn.108075 | 53 | − | 5 | 5 |
| | 1131 | 21 | Rn.144946 | 54 | − | 5 | 6 |
| | 1562 | 22 | Rn.14744 | 55 | − | 5 | 3 |
| | 1741 | 23 | Rn.1647 | 56 | − | 6 | 6 |
| | 1993 | 24 | Rn.18728 | 57 | − | 6 | 5 |
| | 2546 | 25 | Rn.24561 | 58 | − | 6 | 7 |
| | 3776 | 26 | Rn.43232 | 59 | − | 5 | 5 |
| | 4095 | 27 | Rn.119024 | 60 | − | 6 | 6 |
| | 4973 | 28 | Rn.118529 | 61 | − | 6 | 8 |
| | 5634 | 29 | Rn.9862 | 62 | − | 6 | 8 |
| | 5878 | 30 | Rn.143213 | 63 | − | 5 | 0 |
| | 6026 | 31 | Rn.167685 | 64 | − | 5 | 3 |
| | 6303 | 32 | Rn.123063 | 65 | − | 5 | 7 |
| D | 5726 | 33 | Rn.9939 | 66 | − | | |

The following Tables 9 to 14 show the behavior of each gene selected by the requirements (A) to (D) when a chemical substance was administered. The case of “+” indicates that a significant difference in the expression level of mRNA was observed between the chemical substance administration group and the vehicle control group by the administration of the chemical substance and the expression level of mRNA was changed in the direction defined for the gene. The case of “−” indicates that a significant difference in the expression level of mRNA was not observed between the chemical substance administration group and the vehicle control group or the direction of the change was not the same as that previously defined.

TABLE 9

| Substance No. | | | TS004 | TS006 | TS011 | TS013 | TS014 | TS027 | TS028 | TS029 |
|---|---|---|---|---|---|---|---|---|---|---|
| Liver carcinogenicity | | | Cr+ | Cr+ | Cr+ | Cr+ | Cr+ | Cr+ | Cr+ | Cr+ |
| Carcinogenicity | | | C+ | C+ | C+ | C+ | C+ | C+ | C+ | C+ |
| Mutagenicity by Ames test | | | M+ | M+ | M+ | M+ | M+ | M− | M+ | M− |
| | | | Training | Training | Training | Training | Training | Training | Training | Training |
| | Gene No. | Unigene No. | Behavior of gene caused by administration of chemical substance | | | | | | | |
| (A) | 4218 | Rn.167075 | + | − | + | + | + | + | + | + |
| | 4846 | Rn.144554 | + | + | + | + | + | + | + | + |
| | 5600 | Rn.9836 | + | − | + | + | + | + | + | + |
| | 6182 | Rn.5834 | + | − | + | + | + | + | + | + |
| | 2026 | Rn.167075 | + | + | + | + | + | + | + | + |
| (B) | 2045 | Rn.19329 | − | − | − | − | − | − | − | − |
| | 2203 | Rn.21240 | − | − | − | − | − | − | − | − |
| | 1494 | Rn.1430 | + | + | + | + | + | + | + | + |
| (D) | 5726 | Rn.9939 | − | − | − | − | − | − | − | − |
| (C) | 533 | Rn.106184 | − | − | + | + | − | + | + | + |
| | 813 | Rn.201760 | − | + | − | − | + | + | + | − |
| | 893 | Rn.164817 | − | − | + | − | − | − | − | − |
| | 1119 | Rn.9757 | − | − | − | − | − | + | + | − |
| | 1163 | Rn.11766 | − | − | − | − | + | − | − | − |
| | 1334 | Rn.120914 | − | − | − | − | − | − | − | − |
| | 2494 | Rn.23969 | − | − | + | − | − | − | − | − |
| | 3929 | Rn.4620 | − | − | − | − | − | − | + | − |
| | 6620 | Rn.120914 | − | − | − | − | − | − | − | − |
| | 6742 | Rn.9779 | − | − | − | − | − | + | + | − |
| | 154 | Rn.185941 | − | − | + | + | − | + | + | + |
| | 725 | Rn.108075 | + | − | − | + | − | − | − | − |
| | 1131 | Rn.144946 | − | − | − | − | − | − | − | − |
| | 1562 | Rn.14744 | − | − | + | + | − | + | + | + |
| | 1741 | Rn.1647 | − | − | + | − | − | + | + | + |
| | 1993 | Rn.18728 | − | − | + | + | + | + | + | + |
| | 2546 | Rn.24561 | − | − | + | − | − | − | − | − |
| | 3776 | Rn.43232 | − | − | − | − | − | − | + | + |
| | 4095 | Rn.119024 | − | − | + | − | − | − | + | − |
| | 4973 | Rn.118529 | − | − | + | + | − | − | + | − |
| | 5634 | Rn.9862 | − | − | − | − | − | − | + | − |
| | 5878 | Rn.143213 | − | − | − | − | − | − | + | − |
| | 6026 | Rn.167685 | − | − | + | − | − | − | − | − |
| | 6303 | Rn.123063 | − | − | + | + | − | − | + | + |
| Substance No. | | | TS030 | TS041 | TS042 | TS043 | TS044 | TS053 | TS054 | TS067 |
| Liver carcinogenicity | | | Cr+ | Cr+ | Cr+ | Cr+ | Cr+ | Cr+ | Cr+ | Cr+ |
| Carcinogenicity | | | C+ | C+ | C+ | C+ | C+ | C+ | C+ | C+ |
| Mutagenicity by Ames test | | | M− | M+ | M+ | M+ | M+ | M− | M− | M− |
| | | | Training | Training | Training | Training | Training | Training | Training | Training |
| | Gene No. | Unigene No. | Behavior of gene caused by administration of chemical substance | | | | | | | |
| (A) | 4218 | Rn.167075 | + | + | + | + | + | + | − | − |
| | 4846 | Rn.144554 | + | + | + | + | + | + | + | + |
| | 5600 | Rn.9836 | + | + | + | + | + | + | − | − |
| | 6182 | Rn.5834 | + | + | + | + | + | + | + | − |
| | 2026 | Rn.167075 | + | − | + | + | − | + | − | + |
| (B) | 2045 | Rn.19329 | − | − | − | − | − | − | − | − |
| | 2203 | Rn.21240 | − | − | − | − | − | − | − | − |
| | 1494 | Rn.1430 | + | − | + | − | − | + | − | − |
| (D) | 5726 | Rn.9939 | + | − | + | − | − | − | + | − |
| (C) | 533 | Rn.106184 | + | − | + | − | − | + | − | + |
| | 813 | Rn.201760 | + | − | + | − | − | − | − | − |
| | 893 | Rn.164817 | + | − | − | + | − | + | − | − |
| | 1119 | Rn.9757 | − | − | − | − | − | + | − | − |
| | 1163 | Rn.11766 | − | − | − | + | + | − | − | − |
| | 1334 | Rn.120914 | − | − | − | − | − | − | − | − |
| | 2494 | Rn.23969 | + | − | − | − | − | + | − | − |
| | 3929 | Rn.4620 | − | − | − | − | − | − | − | − |
| | 6620 | Rn.120914 | − | − | − | − | − | − | − | − |
| | 6742 | Rn.9779 | − | + | − | − | − | − | − | − |
| | 154 | Rn.185941 | + | − | − | − | − | + | − | + |
| | 725 | Rn.108075 | + | − | − | + | + | − | − | − |
| | 1131 | Rn.144946 | − | − | + | − | − | − | − | − |
| | 1562 | Rn.14744 | + | − | + | + | − | + | − | − |
| | 1741 | Rn.1647 | + | − | − | − | − | + | − | − |
| | 1993 | Rn.18728 | + | − | + | + | − | + | − | − |
| | 2546 | Rn.24561 | − | − | − | − | − | + | − | − |
| | 3776 | Rn.43232 | + | − | − | − | − | + | − | − |
| | 4095 | Rn.119024 | + | − | − | + | − | + | − | − |
| | 4973 | Rn.118529 | + | − | − | + | − | + | − | − |
| | 5634 | Rn.9862 | − | − | − | − | − | + | − | − |
| | 5878 | Rn.143213 | − | − | − | − | − | + | − | − |
| | 6026 | Rn.167685 | − | − | − | − | + | + | − | − |
| | 6303 | Rn.123063 | + | − | + | + | − | + | − | + |

TABLE 10

| Substance No. | | | TS076 | TS001 | TS002 | TS015 | TS018 | TS020 | TS021 | TS022 |
|---|---|---|---|---|---|---|---|---|---|---|
| Liver carcinogenicity | | | Cr+ | Cr+ | Cr+ | Cr− | Cr− | Cr+ | Cr+ | Cr− |
| Carcinogenicity | | | C+ | C+ | C+ | C+ | C+ | C+ | C+ | C+ |
| Mutagenicity by Ames test | | | M+ | M− | M− | M− | M− | M− | M− | M− |
| | | | Training | Training | Training | Training | Training | Training | Training | Training |
| | Gene No. | Unigene No. | Behavior of gene caused by administration of chemical substance | | | | | | | |
| (A) | 4218 | Rn.167075 | + | − | − | − | − | − | − | − |
| | 4846 | Rn.144554 | + | − | − | − | − | − | − | + |
| | 5600 | Rn.9836 | + | − | − | − | − | − | − | − |
| | 6182 | Rn.5834 | + | + | − | + | + | + | + | + |
| | 2026 | Rn.167075 | + | + | + | − | − | − | − | − |
| (B) | 2045 | Rn.19329 | + | + | + | + | + | + | + | + |
| | 2203 | Rn.21240 | − | + | + | + | + | + | + | + |
| | 1494 | Rn.1430 | + | + | + | − | + | + | + | + |
| (D) | 5726 | Rn.9939 | − | − | − | − | − | − | − | − |
| (C) | 533 | Rn.106184 | + | + | + | − | + | + | + | − |
| | 813 | Rn.201760 | − | + | + | − | − | − | + | − |
| | 893 | Rn.164817 | − | + | − | − | − | − | − | − |
| | 1119 | Rn.9757 | − | − | − | − | − | − | − | − |
| | 1163 | Rn.11766 | − | + | − | − | − | − | − | − |
| | 1334 | Rn.120914 | − | − | − | − | − | − | − | − |
| | 2494 | Rn.23969 | − | − | − | + | − | − | − | − |
| | 3929 | Rn.4620 | − | − | − | − | − | − | − | − |
| | 6620 | Rn.120914 | − | − | − | − | − | − | − | − |
| | 6742 | Rn.9779 | − | + | + | − | − | − | + | + |
| | 154 | Rn.185941 | + | − | − | − | − | − | − | − |
| | 725 | Rn.108075 | + | + | + | − | − | − | − | − |
| | 1131 | Rn.144946 | − | − | + | − | − | − | − | − |
| | 1562 | Rn.14744 | + | − | − | − | − | − | − | − |
| | 1741 | Rn.1647 | + | − | − | − | − | − | + | − |
| | 1993 | Rn.18728 | + | − | − | − | − | − | − | − |
| | 2546 | Rn.24561 | − | − | − | − | − | − | − | − |
| | 3776 | Rn.43232 | − | − | − | − | − | − | − | − |
| | 4095 | Rn.119024 | + | + | + | − | + | − | + | − |
| | 4973 | Rn.118529 | + | + | + | − | + | − | + | − |
| | 5634 | Rn.9862 | − | − | − | − | − | − | + | − |
| | 5878 | Rn.143213 | − | − | − | − | − | − | − | − |
| | 6026 | Rn.167685 | − | − | − | − | − | − | − | − |
| | 6303 | Rn.123063 | + | − | − | − | − | − | + | − |
| Substance No. | | | TS023 | TS024 | TS025 | TS026 | TS045 | TS047 | TS048 | TS049 |
| Liver carcinogenicity | | | Cr− | Cr− | Cr+ | Cr− | Cr− | Cr− | Cr− | Cr− |
| Carcinogenicity | | | C+ | C+ | C+ | C+ | C+ | C+ | C+ | C+ |
| Mutagenicity by Ames test | | | M− | M− | M− | M− | M+ | M+ | M+ | M+ |
| | | | Training | Training | Training | Training | Training | Training | Training | Training |
| | Gene No. | Unigene No. | Behavior of gene caused by administration of chemical su bstance | | | | | | | |
| (A) | 4218 | Rn.167075 | − | − | + | − | − | − | − | − |
| | 4846 | Rn.144554 | − | − | + | − | − | − | − | − |
| | 5600 | Rn.9836 | − | − | + | − | − | − | − | − |
| | 6182 | Rn.5834 | − | − | + | − | − | − | − | − |
| | 2026 | Rn.167075 | − | − | − | − | − | − | + | − |
| (B) | 2045 | Rn.19329 | − | − | + | − | + | − | − | − |
| | 2203 | Rn.21240 | + | − | + | − | + | − | − | − |
| | 1494 | Rn.1430 | − | + | + | + | − | − | − | − |
| (D) | 5726 | Rn.9939 | − | − | − | + | + | + | + | + |
| (C) | 533 | Rn.106184 | − | + | + | + | − | − | − | − |
| | 813 | Rn.201760 | − | − | + | − | − | − | − | − |
| | 893 | Rn.164817 | − | − | − | − | − | − | − | − |
| | 1119 | Rn.9757 | − | − | − | − | − | − | − | − |
| | 1163 | Rn.11766 | + | − | − | − | − | + | − | − |
| | 1334 | Rn.120914 | − | − | − | − | − | − | − | − |
| | 2494 | Rn.23969 | − | − | − | − | + | − | − | − |
| | 3929 | Rn.4620 | − | − | − | − | − | − | − | − |
| | 6620 | Rn.120914 | − | − | − | − | − | − | − | − |
| | 6742 | Rn.9779 | − | − | + | − | − | − | − | − |
| | 154 | Rn.185941 | + | − | + | − | − | − | − | − |
| | 725 | Rn.108075 | + | − | + | − | − | + | − | − |
| | 1131 | Rn.144946 | − | − | − | − | − | − | − | − |
| | 1562 | Rn.14744 | − | − | − | − | − | − | − | − |
| | 1741 | Rn.1647 | − | − | + | − | − | − | − | − |
| | 1993 | Rn.18728 | − | − | − | − | − | − | − | − |
| | 2546 | Rn.24561 | − | − | − | − | − | − | − | − |
| | 3776 | Rn.43232 | − | − | + | − | − | − | − | − |
| | 4095 | Rn.119024 | + | − | + | + | − | − | − | − |
| | 4973 | Rn.118529 | + | − | + | − | − | − | − | − |
| | 5634 | Rn.9862 | − | − | + | − | − | − | + | − |
| | 5878 | Rn.143213 | − | − | − | − | − | − | − | − |
| | 6026 | Rn.167685 | − | − | − | + | − | − | − | − |
| | 6303 | Rn.123063 | − | − | + | + | − | − | − | − |

TABLE 11

| Substance No. | | | TS050 | TS051 | TS063 | TS066 | TS069 | TS070 | TS077 | TS078 |
|---|---|---|---|---|---|---|---|---|---|---|
| Liver carcinogenicity | | | Cr− | Cr− | Cr− | Cr− | Cr− | Cr+ | Cr+ | Cr+ |
| Carcinogenicity | | | C+ | C+ | C+ | C+ | C+ | C+ | C+ | C+ |
| Mutagenicity by Ames test | | | M+ | M− | M+ | M− | M− | M− | M+ | M− |
| | | | Training | Training | Training | Training | Training | Training | Training | Training |
| | Gene No. | Unigene No. | Behavior of gene caused by administration of chemical substance | | | | | | | |
| (A) | 4218 | Rn.167075 | − | − | − | − | − | − | − | − |
| | 4846 | Rn.144554 | − | − | − | − | − | − | − | − |
| | 5600 | Rn.9836 | − | − | − | − | − | − | − | − |
| | 6182 | Rn.5834 | + | − | + | + | + | − | + | − |
| | 2026 | Rn.167075 | − | − | + | − | − | − | − | + |
| (B) | 2045 | Rn.19329 | − | − | + | + | + | − | + | + |
| | 2203 | Rn.21240 | − | − | + | − | + | + | − | + |
| | 1494 | Rn.1430 | − | − | − | − | + | + | + | + |
| (D) | 5726 | Rn.9939 | + | + | − | − | − | − | + | − |
| (C) | 533 | Rn.106184 | − | − | − | + | − | − | − | − |
| | 813 | Rn.201760 | − | − | − | − | − | − | − | − |
| | 893 | Rn.164817 | − | − | − | − | − | − | − | − |
| | 1119 | Rn.9757 | − | − | − | − | − | − | − | − |
| | 1163 | Rn.11766 | − | − | − | − | − | − | − | + |
| | 1334 | Rn.120914 | − | − | − | − | − | − | − | − |
| | 2494 | Rn.23969 | − | − | − | − | − | − | − | − |
| | 3929 | Rn.4620 | − | − | − | − | + | − | − | − |
| | 6620 | Rn.120914 | − | − | − | − | − | − | − | − |
| | 6742 | Rn.9779 | − | − | − | − | − | − | − | − |
| | 154 | Rn.185941 | − | − | − | − | + | − | − | − |
| | 725 | Rn.108075 | − | + | − | − | + | + | − | − |
| | 1131 | Rn.144946 | − | − | − | − | − | − | − | − |
| | 1562 | Rn.14744 | − | − | − | − | − | − | − | − |
| | 1741 | Rn.1647 | − | − | − | − | + | − | − | − |
| | 1993 | Rn.18728 | − | − | − | − | − | − | − | − |
| | 2546 | Rn.24561 | − | − | − | − | − | − | − | − |
| | 3776 | Rn.43232 | − | − | − | − | − | − | − | − |
| | 4095 | Rn.119024 | − | + | − | − | + | − | − | − |
| | 4973 | Rn.118529 | − | + | − | − | + | − | − | + |
| | 5634 | Rn.9862 | − | − | + | − | + | − | − | + |
| | 5878 | Rn.143213 | − | − | − | − | − | − | − | − |
| | 6026 | Rn.167685 | − | − | − | − | − | − | + | − |
| | 6303 | Rn.123063 | + | − | − | − | − | − | + | − |
| Substance No. | | | TS008 | TS019 | TS046 | TS055 | TS056 | TS068 | TS005 | TS007 |
| Liver carcinogenicity | | | Cr+ | Cr+ | Cr− | Cr− | Cr+ | Cr− | Cr− | Cr− |
| Carcinogenicity | | | C+ | C+ | C+ | C+ | C+ | C+ | C− | C− |
| Mutagenicity by Ames test | | | M− | M− | M+ | M− | M− | M− | M+ | M+ |
| | | | Training | Training | Training | Training | Training | Training | Training | Training |
| | Gene No. | Unigene No. | Behavior of gene caused by administration of chemical substance | | | | | | | |
| (A) | 4218 | Rn.167075 | − | − | − | − | − | + | − | − |
| | 4846 | Rn.144554 | + | + | − | − | − | + | − | − |
| | 5600 | Rn.9836 | − | − | − | − | − | + | − | − |
| | 6182 | Rn.5834 | − | + | + | − | − | + | − | − |
| | 2026 | Rn.167075 | − | − | + | − | + | − | − | − |
| (B) | 2045 | Rn.19329 | − | − | − | − | − | − | − | − |
| | 2203 | Rn.21240 | − | + | + | − | − | − | − | − |
| | 1494 | Rn.1430 | + | − | − | + | + | − | − | − |
| (D) | 5726 | Rn.9939 | − | − | + | + | − | − | − | + |
| (C) | 533 | Rn.106184 | + | + | − | + | + | + | − | − |
| | 813 | Rn.201760 | + | − | + | + | + | + | − | − |
| | 893 | Rn.164817 | + | + | + | + | + | + | − | − |
| | 1119 | Rn.9757 | + | + | + | + | + | + | − | − |
| | 1163 | Rn.11766 | − | + | + | + | + | + | − | − |
| | 1334 | Rn.120914 | + | + | − | + | + | + | − | − |
| | 2494 | Rn.23969 | + | + | − | + | + | + | − | − |
| | 3929 | Rn.4620 | + | + | − | + | + | + | − | − |
| | 6620 | Rn.120914 | + | + | − | + | + | + | − | − |
| | 6742 | Rn.9779 | + | − | + | + | + | + | − | − |
| | 154 | Rn.185941 | + | + | + | + | + | + | − | − |
| | 725 | Rn.108075 | + | + | + | − | + | + | − | − |
| | 1131 | Rn.144946 | − | + | + | + | + | + | + | − |
| | 1562 | Rn.14744 | + | + | − | + | + | + | − | − |
| | 1741 | Rn.1647 | + | + | + | + | + | + | − | − |
| | 1993 | Rn.18728 | + | + | + | + | + | + | − | − |
| | 2546 | Rn.24561 | + | + | + | + | + | + | − | − |
| | 3776 | Rn.43232 | − | + | + | + | + | + | − | − |
| | 4095 | Rn.119024 | + | + | + | + | + | + | − | − |
| | 4973 | Rn.118529 | + | + | + | + | + | + | − | − |
| | 5634 | Rn.9862 | + | + | + | + | + | + | − | − |
| | 5878 | Rn.143213 | − | + | + | + | + | + | − | − |
| | 6026 | Rn.167685 | + | + | − | + | + | + | − | − |
| | 6303 | Rn.123063 | + | + | − | + | + | + | − | − |

TABLE 12

| Substance No. | | | TS009 | TS010 | TS032 | TS033 | TS034 | TS035 | TS038 | TS039 |
|---|---|---|---|---|---|---|---|---|---|---|
| Liver carcinogenicity | | | Cr− | Cr− | Cr− | Cr− | Cr− | Cr− | Cr− | Cr− |
| Carcinogenicity | | | C− | C− | C− | C− | C− | C− | C− | C− |
| Mutagenicity by Ames test | | | M− | M− | M+ | M+ | M− | M+ | M− | M+ |
| | | | Training | Training | Training | Training | Training | Training | Training | Training |
| | Gene No. | Unigene No. | Behavior of gene caused by administration of chemical substance | | | | | | | |
| (A) | 4218 | Rn.167075 | − | − | − | − | − | − | − | − |
| | 4846 | Rn.144554 | − | − | − | − | − | − | − | − |
| | 5600 | Rn.9836 | − | − | − | − | − | − | − | − |
| | 6182 | Rn.5834 | − | − | − | − | − | − | − | − |
| | 2026 | Rn.167075 | − | − | − | − | + | + | + | − |
| (B) | 2045 | Rn.19329 | − | − | − | − | + | − | − | − |
| | 2203 | Rn.21240 | − | − | − | − | + | − | − | − |
| | 1494 | Rn.1430 | − | − | − | − | + | + | − | + |
| (D) | 5726 | Rn.9939 | − | − | − | − | − | − | − | − |
| (C) | 533 | Rn.106184 | − | − | − | − | + | + | − | − |
| | 813 | Rn.201760 | − | − | − | − | − | + | − | − |
| | 893 | Rn.164817 | − | − | − | − | − | − | − | + |
| | 1119 | Rn.9757 | − | − | − | − | − | − | + | − |
| | 1163 | Rn.11766 | − | − | − | − | − | + | − | − |
| | 1334 | Rn.120914 | − | − | − | − | − | + | − | + |
| | 2494 | Rn.23969 | − | − | − | − | − | − | − | − |
| | 3929 | Rn.4620 | − | − | − | − | − | − | − | − |
| | 6620 | Rn.120914 | − | − | − | − | − | + | − | + |
| | 6742 | Rn.9779 | − | − | − | − | − | − | − | + |
| | 154 | Rn.185941 | − | − | − | − | + | − | + | + |
| | 725 | Rn.108075 | − | − | − | − | − | + | − | − |
| | 1131 | Rn.144946 | − | + | − | − | − | − | − | − |
| | 1562 | Rn.14744 | − | − | − | − | − | − | − | − |
| | 1741 | Rn.1647 | − | − | − | − | − | + | − | + |
| | 1993 | Rn.18728 | − | − | − | − | − | + | + | − |
| | 2546 | Rn.24561 | − | − | − | − | − | + | + | − |
| | 3776 | Rn.43232 | − | − | − | − | − | − | − | − |
| | 4095 | Rn.119024 | − | − | − | − | − | − | + | − |
| | 4973 | Rn.118529 | − | − | − | − | − | − | + | − |
| | 5634 | Rn.9862 | − | − | − | − | − | + | + | + |
| | 5878 | Rn.143213 | − | − | − | − | − | − | − | − |
| | 6026 | Rn.167685 | − | − | − | − | − | − | + | − |
| | 6303 | Rn.123063 | − | − | − | − | + | + | + | + |
| Substance No. | | | TS040 | TS057 | TS058 | TS059 | TS060 | TS062 | TS071 | TS072 |
| Liver carcinogenicity | | | Cr− | Cr− | Cr− | Cr− | Cr− | Cr− | Cr− | Cr− |
| Carcinogenicity | | | C− | C− | C− | C− | C− | C− | C− | C− |
| Mutagenicity by Ames test | | | M− | M− | M+ | M+ | M+ | M− | M− | M+ |
| | | | Training | Training | Training | Training | Training | Training | Training | Training |
| | Gene No. | Unigene No. | Behavior of gene caused by administration of chemical substance | | | | | | | |
| (A) | 4218 | Rn.167075 | − | − | − | − | − | − | − | + |
| | 4846 | Rn.144554 | − | − | − | − | − | − | − | + |
| | 5600 | Rn.9836 | − | − | − | − | − | − | − | + |
| | 6182 | Rn.5834 | − | − | − | − | − | − | − | + |
| | 2026 | Rn.167075 | − | − | − | − | − | − | − | + |
| (B) | 2045 | Rn.19329 | − | − | + | − | − | − | − | + |
| | 2203 | Rn.21240 | − | − | − | − | − | − | − | + |
| | 1494 | Rn.1430 | − | − | − | − | − | − | − | + |
| (D) | 5726 | Rn.9939 | − | − | − | + | − | − | − | − |
| (C) | 533 | Rn.106184 | − | + | − | − | − | − | − | + |
| | 813 | Rn.201760 | − | − | − | − | − | − | − | − |
| | 893 | Rn.164817 | − | − | − | + | + | − | − | − |
| | 1119 | Rn.9757 | − | − | + | + | − | − | − | − |
| | 1163 | Rn.11766 | − | − | + | − | + | + | − | + |
| | 1334 | Rn.120914 | − | − | − | + | − | − | − | − |
| | 2494 | Rn.23969 | − | − | + | − | − | − | − | − |
| | 3929 | Rn.4620 | − | − | − | + | + | − | − | − |
| | 6620 | Rn.120914 | − | − | − | + | − | − | − | − |
| | 6742 | Rn.9779 | + | − | − | − | − | + | − | − |
| | 154 | Rn.185941 | − | − | + | + | − | − | − | − |
| | 725 | Rn.108075 | − | − | − | − | − | − | − | + |
| | 1131 | Rn.144946 | − | + | − | − | + | − | + | − |
| | 1562 | Rn.14744 | − | − | − | + | − | − | − | − |
| | 1741 | Rn.1647 | − | − | − | + | − | − | − | − |
| | 1993 | Rn.18728 | − | − | − | + | − | − | − | − |
| | 2546 | Rn.24561 | − | − | + | + | − | − | − | − |
| | 3776 | Rn.43232 | − | − | − | + | − | − | − | + |
| | 4095 | Rn.119024 | − | − | − | + | − | − | − | − |
| | 4973 | Rn.118529 | − | − | − | + | − | − | − | + |
| | 5634 | Rn.9862 | − | − | + | + | + | − | − | − |
| | 5878 | Rn.143213 | − | − | − | − | − | − | − | − |
| | 6026 | Rn.167685 | − | + | − | − | − | − | − | − |
| | 6303 | Rn.123063 | − | + | − | − | − | − | − | − |

TABLE 13

| Substance No. | | | TS073 | TS074 | TS079 | TS080 | TS082 | TS083 | TS084 | TS085 |
|---|---|---|---|---|---|---|---|---|---|---|
| Liver carcinogenicity | | | Cr− | Cr− | Cr− | Cr− | Cr− | Cr− | Cr− | Cr− |
| Carcinogenicity | | | C− | C− | C− | C− | C− | C− | C− | C− |
| Mutagenicity by Ames test | | | M− | M− | M+ | M− | M+ | M+ | M− | M− |
| | | | Training | Training | Training | Training | Training | Training | Training | Training |
| | Gene No. | Unigene No. | Behavior of gene caused by administration of chemical substance | | | | | | | |
| (A) | 4218 | Rn.167075 | − | − | − | + | − | − | − | − |
| | 4846 | Rn.144554 | − | − | − | + | − | − | − | − |
| | 5600 | Rn.9836 | − | − | − | + | − | − | − | − |
| | 6182 | Rn.5834 | − | + | + | + | + | − | + | − |
| | 2026 | Rn.167075 | − | − | − | + | − | + | − | − |
| (B) | 2045 | Rn.19329 | + | + | + | − | − | − | − | − |
| | 2203 | Rn.21240 | − | − | + | + | − | − | − | − |
| | 1494 | Rn.1430 | − | − | − | + | + | + | + | − |
| (D) | 5726 | Rn.9939 | − | − | + | + | − | − | − | − |
| (C) | 533 | Rn.106184 | − | − | − | + | + | + | + | − |
| | 813 | Rn.201760 | − | − | − | + | − | + | − | − |
| | 893 | Rn.164817 | − | − | − | + | + | + | − | − |
| | 1119 | Rn.9757 | − | − | − | − | + | + | − | − |
| | 1163 | Rn.11766 | − | − | − | − | − | − | − | − |
| | 1334 | Rn.120914 | − | − | − | − | − | + | − | − |
| | 2494 | Rn.23969 | − | − | − | − | − | − | − | − |
| | 3929 | Rn.4620 | − | + | − | − | + | + | − | − |
| | 6620 | Rn.120914 | − | − | − | − | − | + | − | − |
| | 6742 | Rn.9779 | − | − | − | − | + | + | + | − |
| | 154 | Rn.185941 | − | − | − | + | + | + | − | − |
| | 725 | Rn.108075 | − | + | − | + | − | + | − | − |
| | 1131 | Rn.144946 | − | − | − | − | + | − | − | − |
| | 1562 | Rn.14744 | − | − | − | − | + | + | − | − |
| | 1741 | Rn.1647 | − | + | − | − | + | + | − | − |
| | 1993 | Rn.18728 | − | − | − | − | + | + | − | − |
| | 2546 | Rn.24561 | − | − | − | + | + | + | − | − |
| | 3776 | Rn.43232 | − | + | − | − | + | + | − | − |
| | 4095 | Rn.119024 | − | + | − | + | + | + | − | − |
| | 4973 | Rn.118529 | − | + | − | + | + | + | + | − |
| | 5634 | Rn.9862 | − | + | − | − | + | − | − | − |
| | 5878 | Rn.143213 | − | − | − | − | − | − | − | − |
| | 6026 | Rn.167685 | − | − | − | − | − | + | − | − |
| | 6303 | Rn.123063 | − | − | − | − | + | + | − | − |

| Substance No. | | | TS003 | TS012 | TS016 | TS017 | TS031 | TS036 | TS037 | TS052 |
|---|---|---|---|---|---|---|---|---|---|---|
| Liver carcinogenicity | | | Cr+ | Cr− | Cr+ | Cr− | Cr− | Cr− | Cr− | Cr+ |
| Carcinogenicity | | | C+ | C+ | C+ | C+ | C− | C− | C− | C+ |
| Mutagenicity by Ames test | | | M− | M+ | M− | M− | M− | M− | M+ | M− |
| | | | Validate | Validate | Validate | Validate | Validate | Validate | Validate | Validate |
| | Gene No. | Unigene No. | Behavior of gene caused by administration of chemical substance | | | | | | | |
| (A) | 4218 | Rn.167075 | + | − | − | − | − | − | − | − |
| | 4846 | Rn.144554 | + | − | − | − | − | − | − | − |
| | 5600 | Rn.9836 | + | − | − | − | − | − | − | − |
| | 6182 | Rn.5834 | + | − | + | + | − | − | − | − |
| | 2026 | Rn.167075 | + | + | − | − | + | − | − | − |
| (B) | 2045 | Rn.19329 | + | − | + | + | − | − | − | − |
| | 2203 | Rn.21240 | + | − | + | + | − | − | − | + |
| | 1494 | Rn.1430 | + | + | + | + | + | − | − | − |
| (D) | 5726 | Rn.9939 | − | − | − | − | − | − | − | − |
| (C) | 533 | Rn.106184 | + | + | + | + | + | − | − | − |
| | 813 | Rn.201760 | − | + | − | − | − | − | − | − |
| | 893 | Rn.164817 | − | − | − | − | − | + | − | − |
| | 1119 | Rn.9757 | − | − | − | − | − | + | − | − |
| | 1163 | Rn.11766 | + | − | − | − | − | − | − | + |
| | 1334 | Rn.120914 | − | − | − | − | − | − | − | − |
| | 2494 | Rn.23969 | − | − | + | − | − | − | − | − |
| | 3929 | Rn.4620 | − | − | − | − | − | + | − | − |
| | 6620 | Rn.120914 | − | − | − | − | − | − | − | − |
| | 6742 | Rn.9779 | − | − | + | − | + | − | − | − |
| | 154 | Rn.185941 | + | − | − | − | − | + | − | − |
| | 725 | Rn.108075 | − | + | − | − | − | + | − | − |
| | 1131 | Rn.144946 | − | + | − | − | − | + | − | − |
| | 1562 | Rn.14744 | − | − | − | − | − | + | − | − |
| | 1741 | Rn.1647 | + | + | + | − | + | + | − | − |
| | 1993 | Rn.18728 | − | − | − | − | − | + | − | − |
| | 2546 | Rn.24561 | − | − | − | − | + | + | − | − |
| | 3776 | Rn.43232 | − | − | − | − | − | + | − | − |
| | 4095 | Rn.119024 | − | − | + | − | − | + | − | − |
| | 4973 | Rn.118529 | + | − | − | − | − | + | − | − |
| | 5634 | Rn.9862 | − | − | + | − | − | − | − | − |
| | 5878 | Rn.143213 | − | + | − | − | − | + | − | − |
| | 6026 | Rn.167685 | − | − | − | − | − | − | − | − |
| | 6303 | Rn.123063 | − | + | − | − | − | − | − | − |

TABLE 14

| Substance No. | | | TS061 | TS064 | TS075 | TS081 | TS086 | TS087 | TS088 |
|---|---|---|---|---|---|---|---|---|---|
| Liver carcinogenicity | | | Cr− | Cr− | Cr+ | Cr− | Cr+ | Cr+ | Cr− |
| Carcinogenicity | | | C− | C+ | C+ | C− | C+ | C+ | C+ |
| Mutagenicity by Ames test | | | M+ | M+ | M+ | M+ | M− | M− | M− |
| | | | Validate | Validate | Validate | Validate | Ext Validate | Ext Validate | Ext Validate |
| | Gene No. | Unigene No. | Behavior of gene caused by administration of chemical substance | | | | | | |
| (A) | 4218 | Rn.167075 | − | − | − | − | − | + | − |
| | 4846 | Rn.144554 | + | − | − | − | + | + | − |
| | 5600 | Rn.9836 | − | − | − | − | + | + | − |
| | 6182 | Rn.5834 | + | − | − | − | + | + | − |
| | 2026 | Rn.167075 | + | − | − | − | − | + | − |
| (B) | 2045 | Rn.19329 | − | − | − | − | − | − | − |
| | 2203 | Rn.21240 | − | + | + | − | − | − | − |
| | 1494 | Rn.1430 | − | − | − | − | − | + | + |
| (D) | 5726 | Rn.9939 | − | − | − | − | − | − | − |
| (C) | 533 | Rn.106184 | − | − | − | + | + | + | − |
| | 813 | Rn.201760 | − | − | − | − | − | − | − |
| | 893 | Rn.164817 | − | − | + | − | − | − | − |
| | 1119 | Rn.9757 | − | − | − | − | − | − | − |
| | 1163 | Rn.11766 | + | − | + | − | − | − | − |
| | 1334 | Rn.120914 | − | − | − | − | − | − | − |
| | 2494 | Rn.23969 | − | − | − | − | − | − | − |
| | 3929 | Rn.4620 | − | − | + | − | − | − | − |
| | 6620 | Rn.120914 | − | − | − | − | − | − | − |
| | 6742 | Rn.9779 | − | − | − | + | − | − | − |
| | 154 | Rn.185941 | − | − | − | − | − | − | − |
| | 725 | Rn.108075 | − | − | − | − | − | + | − |
| | 1131 | Rn.144946 | − | − | − | − | − | − | + |
| | 1562 | Rn.14744 | − | − | − | − | − | − | − |
| | 1741 | Rn.1647 | − | − | − | − | − | − | − |
| | 1993 | Rn.18728 | − | − | + | − | − | − | − |
| | 2546 | Rn.24561 | − | − | + | − | − | − | − |
| | 3776 | Rn.43232 | − | − | − | − | − | − | − |
| | 4095 | Rn.119024 | − | − | + | − | − | − | − |
| | 4973 | Rn.118529 | − | − | + | + | − | + | − |
| | 5634 | Rn.9862 | − | − | − | − | − | − | − |
| | 5878 | Rn.143213 | − | − | − | − | − | − | − |
| | 6026 | Rn.167685 | − | − | − | − | − | − | − |
| | 6303 | Rn.123063 | − | − | − | − | − | + | − |

### Example 1

By using the genes in (A) to (C) selected in Examination Example 1, prediction of the carcinogenicity of each of chemical substances (training substances) which were used for the selection of the genes and chemical substances (validation substances) which were not used for the selection of the genes was performed. The prediction was performed by the following procedure.

One gene was selected from each of (A) to (C), and the expression level of mRNA for each of the selected genes was compared between a chemical substance administration group and a vehicle control group. The chemical substance was determined to have carcinogenicity when the expression level of mRNA for any one of the genes significantly increased or decreased as compared with the vehicle control group and the direction of increase or decrease was the same as that shown in Table 1, and in the other cases, the chemical substance was determined to have no carcinogenicity.

The determination as to whether the expression level of mRNA in the chemical substance administration group significantly increased or decreased as compared with the vehicle control group was performed based on whether or not the expression level of mRNA in the chemical substance administration group was 1.5 times or more or 1/1.5 or less of the expression level of mRNA in the control group.

It was difficult to examine the combinations of all of the genes, however, the following results were obtained. The combination of the genes which gave the highest predictive value was 4846/2203/813. Also in the case of other combinations of the genes, a predictive value of 60% or more was obtained for the validation substances.

The gene numbers (Gene No.) of the genes used for the prediction, the number of substances for which a correct prediction was made, the predictive value calculated from the number of substances for which a correct prediction was made are shown in Tables 15 and 16.

TABLE 15

| | | Training substances | | | | | | Validation substances | | |
|---|---|---|---|---|---|---|---|---|---|---|
| | | | | | Total of | Total of | | Total of | Total of | |
| | | Grp 1 | Grp 2 | Grp 3 | C+ | C− | Total | C+ | C− | Total |
| | | Number of substances | | | | | | | | |
| Gene No. | | 17 | 23 | 6 | 46 | 26 | 72 | 10 | 5 | 15 |
| 4846/2203/813 | Number of substances for which | 17 | 14 | 6 | 37 | 20 | 57 | 9 | 4 | 13 |
| | correct prediction was made | | | | | | | | | |
| | Predictive value (%) | 100.0 | 60.9 | 100.0 | 80.4 | 76.9 | 79.2 | 90.0 | 80.0 | 86.7 |

4846 gene was replaced by another gene

| | | | | | | | | | | |
|---|---|---|---|---|---|---|---|---|---|---|
| 4218/2203/813 | Number of substances for which | 15 | 14 | 6 | 35 | 20 | 55 | 8 | 5 | 13 |
| | correct prediction was made | | | | | | | | | |
| | Predictive value (%) | 88.2 | 60.9 | 100.0 | 76.1 | 76.9 | 76.4 | 80.0 | 100.0 | 86.7 |
| 5600/2203/813 | Number of substances for which | 15 | 14 | 6 | 35 | 20 | 55 | 9 | 5 | 14 |
| | correct prediction was made | | | | | | | | | |
| | Predictive value (%) | 88.2 | 60.9 | 100.0 | 76.1 | 76.9 | 76.4 | 90.0 | 100.0 | 93.3 |
| 6182/2203/813 | Number of substances for which | 16 | 17 | 6 | 39 | 17 | 56 | 9 | 4 | 13 |
| | correct prediction was made | | | | | | | | | |
| | Predictive value (%) | 94.1 | 73.9 | 100.0 | 84.8 | 65.4 | 77.8 | 90.0 | 80.0 | 86.7 |
| 2026/2203/813 | Number of substances for which | 14 | 15 | 6 | 35 | 19 | 54 | 8 | 3 | 11 |
| | correct prediction was made | | | | | | | | | |
| | Predictive value (%) | 82.4 | 65.2 | 100.0 | 76.1 | 73.1 | 75.0 | 80.0 | 60.0 | 73.3 |

2203 gene was replaced by another gene

| | | | | | | | | | | |
|---|---|---|---|---|---|---|---|---|---|---|
| 4846/2045/813 | Number of substances for which | 17 | 14 | 6 | 37 | 17 | 54 | 6 | 4 | 10 |
| | correct prediction was made | | | | | | | | | |
| | Predictive value (%) | 100.0 | 60.9 | 100.0 | 80.4 | 65.4 | 75.0 | 60.0 | 80.0 | 66.7 |
| 4846/1494/813 | Number of substances for which | 17 | 13 | 6 | 36 | 18 | 54 | 7 | 3 | 10 |
| | correct prediction was made | | | | | | | | | |
| | Predictive value (%) | 100.0 | 56.5 | 100.0 | 78.3 | 69.2 | 75.0 | 70.0 | 60.0 | 66.7 |

813 gene was replaced by another gene

| | | | | | | | | | | |
|---|---|---|---|---|---|---|---|---|---|---|
| 4846/2203/533 | Number of substances for which | 17 | 17 | 6 | 40 | 17 | 57 | 9 | 2 | 11 |
| | correct prediction was made | | | | | | | | | |
| | Predictive value (%) | 100.0 | 73.9 | 100.0 | 87.0 | 65.4 | 79.2 | 90.0 | 40.0 | 73.3 |
| 4846/2203/893 | Number of substances for which | 17 | 14 | 6 | 37 | 17 | 54 | 8 | 3 | 11 |
| | correct prediction was made | | | | | | | | | |
| | Predictive value (%) | 100.0 | 60.9 | 100.0 | 80.4 | 65.4 | 75.0 | 80.0 | 60.0 | 73.3 |
| 4846/2203/1119 | Number of substances for which | 17 | 14 | 6 | 37 | 17 | 54 | 8 | 3 | 11 |
| | correct prediction was made | | | | | | | | | |
| | Predictive value (%) | 100.0 | 60.9 | 100.0 | 80.4 | 65.4 | 75.0 | 80.0 | 60.0 | 73.3 |
| 4846/2203/1163 | Number of substances for which | 17 | 15 | 6 | 38 | 18 | 56 | 8 | 4 | 12 |
| | correct prediction was made | | | | | | | | | |
| | Predictive value (%) | 100.0 | 65.2 | 100.0 | 82.6 | 69.2 | 77.8 | 80.0 | 80.0 | 80.0 |
| 4846/2203/1334 | Number of substances for which | 17 | 14 | 6 | 37 | 18 | 55 | 8 | 4 | 12 |
| | correct prediction was made | | | | | | | | | |
| | Predictive value (%) | 100.0 | 60.9 | 100.0 | 80.4 | 69.2 | 76.4 | 80.0 | 80.0 | 80.0 |
| 4846/2203/2494 | Number of substances for which | 17 | 14 | 6 | 37 | 21 | 58 | 8 | 4 | 12 |
| | correct prediction was made | | | | | | | | | |
| | Predictive value (%) | 100.0 | 60.9 | 100.0 | 80.4 | 80.8 | 80.6 | 80.0 | 80.0 | 80.0 |
| 4846/2203/3929 | Number of substances for which | 17 | 14 | 6 | 37 | 17 | 54 | 8 | 3 | 11 |
| | correct prediction was made | | | | | | | | | |
| | Predictive value (%) | 100.0 | 60.9 | 100.0 | 80.4 | 65.4 | 75.0 | 80.0 | 60.0 | 73.3 |

TABLE 16

| | | Training substances | | | | | | Validation substances | | |
|---|---|---|---|---|---|---|---|---|---|---|
| | | | | | Total | Total | | Total | Total | |
| | | Grp 1 | Grp 2 | Grp 3 | of C+ | of C− | Total | of C+ | of C− | Total |
| | | Number of substances | | | | | | | | |
| Gene No. | | 17 | 23 | 6 | 46 | 26 | 72 | 10 | 5 | 15 |
| 4846/2203/6620 | Number of substances for which | 17 | 14 | 6 | 37 | 18 | 55 | 8 | 4 | 12 |
| | correct prediction was made | | | | | | | | | |
| | Predictive value (%) | 100.0 | 60.9 | 100.0 | 80.4 | 69.2 | 76.4 | 80.0 | 80.0 | 80.0 |
| 4846/2203/6742 | Number of substances for which | 17 | 14 | 6 | 37 | 16 | 53 | 8 | 2 | 10 |
| | correct prediction was made | | | | | | | | | |
| | Predictive value (%) | 100.0 | 60.9 | 100.0 | 80.4 | 61.5 | 73.6 | 80.0 | 40.0 | 66.7 |
| 4846/2203/154 | Number of substances for which | 17 | 14 | 6 | 37 | 16 | 53 | 8 | 3 | 11 |
| | correct prediction was made | | | | | | | | | |
| | Predictive value (%) | 100.0 | 60.9 | 100.0 | 80.4 | 61.5 | 73.6 | 80.0 | 60.0 | 73.3 |
| 4846/2203/725 | Number of substances for which | 17 | 16 | 5 | 38 | 19 | 57 | 9 | 3 | 12 |
| | correct prediction was made | | | | | | | | | |
| | Predictive value (%) | 100.0 | 69.6 | 83.3 | 82.6 | 73.1 | 79.2 | 90.0 | 60.0 | 80.0 |
| 4846/2203/1131 | Number of substances for which | 17 | 14 | 6 | 37 | 16 | 53 | 10 | 3 | 13 |
| | correct prediction was made | | | | | | | | | |
| | Predictive value (%) | 100.0 | 60.9 | 100.0 | 80.4 | 61.5 | 73.6 | 100.0 | 60.0 | 86.7 |
| 4846/2203/1562 | Number of substances for which | 17 | 14 | 6 | 37 | 19 | 56 | 8 | 3 | 11 |
| | correct prediction was made | | | | | | | | | |
| | Predictive value (%) | 100.0 | 60.9 | 100.0 | 80.4 | 73.1 | 77.8 | 80.0 | 60.0 | 73.3 |
| 4846/2203/1741 | Number of substances for which | 17 | 14 | 6 | 37 | 16 | 53 | 9 | 2 | 11 |
| | correct prediction was made | | | | | | | | | |
| | Predictive value (%) | 100.0 | 60.9 | 100.0 | 80.4 | 61.5 | 73.6 | 90.0 | 40.0 | 73.3 |
| 4846/2203/1993 | Number of substances for which | 17 | 14 | 6 | 37 | 17 | 54 | 8 | 3 | 11 |
| | correct prediction was made | | | | | | | | | |
| | Predictive value (%) | 100.0 | 60.9 | 100.0 | 80.4 | 65.4 | 75.0 | 80.0 | 60.0 | 73.3 |
| 4846/2203/2546 | Number of substances for which | 17 | 14 | 6 | 37 | 16 | 53 | 8 | 2 | 10 |
| | correct prediction was made | | | | | | | | | |
| | Predictive value (%) | 100.0 | 60.9 | 100.0 | 80.4 | 61.5 | 73.6 | 80.0 | 40.0 | 66.7 |
| 4846/2203/3776 | Number of substances for which | 17 | 14 | 6 | 37 | 18 | 55 | 8 | 3 | 11 |
| | correct prediction was made | | | | | | | | | |
| | Predictive value (%) | 100.0 | 60.9 | 100.0 | 80.4 | 69.2 | 76.4 | 80.0 | 60.0 | 73.3 |
| 4846/2203/4095 | Number of substances for which | 17 | 16 | 6 | 39 | 17 | 56 | 8 | 3 | 11 |
| | correct prediction was made | | | | | | | | | |
| | Predictive value (%) | 100.0 | 69.6 | 100.0 | 84.8 | 65.4 | 77.8 | 80.0 | 60.0 | 73.3 |
| 4846/2203/4973 | Number of substances for which | 17 | 15 | 6 | 38 | 16 | 54 | 8 | 2 | 10 |
| | correct prediction was made | | | | | | | | | |
| | Predictive value (%) | 100.0 | 65.2 | 100.0 | 82.6 | 61.5 | 75.0 | 80.0 | 40.0 | 66.7 |
| 4846/2203/5634 | Number of substances for which | 17 | 15 | 6 | 38 | 14 | 52 | 8 | 4 | 12 |
| | correct prediction was made | | | | | | | | | |
| | Predictive value (%) | 100.0 | 65.2 | 100.0 | 82.6 | 53.8 | 72.2 | 80.0 | 80.0 | 80.0 |
| 4846/2203/5878 | Number of substances for which | 17 | 14 | 6 | 37 | 22 | 59 | 9 | 3 | 12 |
| | correct prediction was made | | | | | | | | | |
| | Predictive value (%) | 100.0 | 60.9 | 100.0 | 80.4 | 84.6 | 81.9 | 90.0 | 60.0 | 80.0 |
| 4846/2203/6026 | Number of substances for which | 17 | 16 | 6 | 39 | 19 | 58 | 8 | 4 | 12 |
| | correct prediction was made | | | | | | | | | |
| | Predictive value (%) | 100.0 | 69.6 | 100.0 | 84.8 | 73.1 | 80.6 | 80.0 | 80.0 | 80.0 |
| 4846/2203/6303 | Number of substances for which | 17 | 17 | 6 | 40 | 16 | 56 | 9 | 4 | 13 |
| | correct prediction was made | | | | | | | | | |
| | Predictive value (%) | 100.0 | 73.9 | 100.0 | 87.0 | 61.5 | 77.8 | 90.0 | 80.0 | 86.7 |

### Example 2

By using the genes obtained by selecting one gene from each of (A) to (C) and the gene (D) shown in Table 7, the carcinogenicity of a chemical substance was predicted in the same manner as in Example 1. It was difficult to examine all of the combinations, however, the following results were obtained. A predictive value of 60% or more was obtained for the validation substances. The genes used for the prediction, the number of substances for which a correct prediction was made, the predictive value calculated from the number of substances for which a correct prediction was made are shown in Tables 17 and 18.

TABLE 17

| | | Training substances | | | | | | Validation substances | | |
|---|---|---|---|---|---|---|---|---|---|---|
| | | | | | Total | Total | Degree of | Total | Total | Degree of |
| | | Grp 1 | Grp 2 | Grp 3 | of C+ | of C− | consistency | of C+ | of C− | consistency |
| | | Number of substances | | | | | | | | |
| | | 17 | 23 | 6 | 46 | 26 | 72 | 10 | 5 | 15 |
| 4846/2203/5726/813 | Number of substances for which | 17 | 21 | 6 | 44 | 18 | 62 | 9 | 4 | 13 |
| | correct prediction was made | | | | | | | | | |
| | Predictive value (%) | 100.0 | 91.3 | 100.0 | 95.7 | 69.2 | 86.1 | 90.0 | 80.0 | 86.7 |

4846 gene was replaced by another gene

| | | | | | | | | | | |
|---|---|---|---|---|---|---|---|---|---|---|
| 4218/2203/5726/813 | Number of substances for which | 15 | 14 | 6 | 35 | 20 | 55 | 8 | 5 | 13 |
| | correct prediction was made | | | | | | | | | |
| | Predictive value (%) | 88.2 | 60.9 | 100.0 | 76.1 | 76.9 | 76.4 | 80.0 | 100.0 | 86.7 |
| 5600/2203/5726/813 | Number of substances for which | 15 | 14 | 6 | 35 | 20 | 55 | 9 | 5 | 14 |
| | correct prediction was made | | | | | | | | | |
| | Predictive value (%) | 88.2 | 60.9 | 100.0 | 76.1 | 76.9 | 76.4 | 90.0 | 100.0 | 93.3 |
| 6182/2203/5726/813 | Number of substances for which | 16 | 17 | 6 | 39 | 17 | 56 | 9 | 4 | 13 |
| | correct prediction was made | | | | | | | | | |
| | Predictive value (%) | 94.1 | 73.9 | 100.0 | 84.8 | 65.4 | 77.8 | 90.0 | 80.0 | 86.7 |
| 2026/2203/5726/813 | Number of substances for which | 14 | 15 | 6 | 35 | 19 | 54 | 8 | 3 | 11 |
| | correct prediction was made | | | | | | | | | |
| | Predictive value (%) | 82.4 | 65.2 | 100.0 | 76.1 | 73.1 | 75.0 | 80.0 | 60.0 | 73.3 |

2203 gene was replaced by another gene

| | | | | | | | | | | |
|---|---|---|---|---|---|---|---|---|---|---|
| 4846/2045/5726/813 | Number of substances for which | 17 | 14 | 6 | 37 | 17 | 54 | 6 | 4 | 10 |
| | correct prediction was made | | | | | | | | | |
| | Predictive value (%) | 100.0 | 60.9 | 100.0 | 80.4 | 65.4 | 75.0 | 60.0 | 80.0 | 66.7 |
| 4846/1494/5726/813 | Number of substances for which | 17 | 13 | 6 | 36 | 18 | 54 | 7 | 3 | 10 |
| | correct prediction was made | | | | | | | | | |
| | Predictive value (%) | 100.0 | 56.5 | 100.0 | 78.3 | 69.2 | 75.0 | 70.0 | 60.0 | 66.7 |

813 gene was replaced by another gene

| | | | | | | | | | | |
|---|---|---|---|---|---|---|---|---|---|---|
| 4846/2203/5726/533 | Number of substances for which | 17 | 17 | 6 | 40 | 17 | 57 | 9 | 2 | 11 |
| | correct prediction was made | | | | | | | | | |
| | Predictive value (%) | 100.0 | 73.9 | 100.0 | 87.0 | 65.4 | 79.2 | 90.0 | 40.0 | 73.3 |
| 4846/2203/5726/893 | Number of substances for which | 17 | 14 | 6 | 37 | 17 | 54 | 8 | 3 | 11 |
| | correct prediction was made | | | | | | | | | |
| | Predictive value (%) | 100.0 | 60.9 | 100.0 | 80.4 | 65.4 | 75.0 | 80.0 | 60.0 | 73.3 |
| 4846/2203/5726/1119 | Number of substances for which | 17 | 14 | 6 | 37 | 17 | 54 | 8 | 3 | 11 |
| | correct prediction was made | | | | | | | | | |
| | Predictive value (%) | 100.0 | 60.9 | 100.0 | 80.4 | 65.4 | 75.0 | 80.0 | 60.0 | 73.3 |
| 4846/2203/5726/1163 | Number of substances for which | 17 | 15 | 6 | 38 | 18 | 56 | 8 | 4 | 12 |
| | correct prediction was made | | | | | | | | | |
| | Predictive value (%) | 100.0 | 65.2 | 100.0 | 82.6 | 69.2 | 77.8 | 80.0 | 80.0 | 80.0 |
| 4846/2203/5726/1334 | Number of substances for which | 17 | 14 | 6 | 37 | 18 | 55 | 8 | 4 | 12 |
| | correct prediction was made | | | | | | | | | |
| | Predictive value (%) | 100.0 | 60.9 | 100.0 | 80.4 | 69.2 | 76.4 | 80.0 | 80.0 | 80.0 |
| 4846/2203/5726/2494 | Number of substances for which | 17 | 14 | 6 | 37 | 21 | 58 | 8 | 4 | 12 |
| | correct prediction was made | | | | | | | | | |
| | Predictive value (%) | 100.0 | 60.9 | 100.0 | 80.4 | 80.8 | 80.6 | 80.0 | 80.0 | 80.0 |
| 4846/2203/5726/3929 | Number of substances for which | 17 | 14 | 6 | 37 | 17 | 54 | 8 | 3 | 11 |
| | correct prediction was made | | | | | | | | | |
| | Predictive value (%) | 100.0 | 60.9 | 100.0 | 80.4 | 65.4 | 75.0 | 80.0 | 60.0 | 73.3 |
| 4846/2203/5726/6620 | Number of substances for which | 17 | 14 | 6 | 37 | 18 | 55 | 8 | 4 | 12 |
| | correct prediction was made | | | | | | | | | |
| | Predictive value (%) | 100.0 | 60.9 | 100.0 | 80.4 | 69.2 | 76.4 | 80.0 | 80.0 | 80.0 |
| 4846/2203/5726/6742 | Number of substances for which | 17 | 14 | 6 | 37 | 16 | 53 | 8 | 2 | 10 |
| | correct prediction was made | | | | | | | | | |
| | Predictive value (%) | 100.0 | 60.9 | 100.0 | 80.4 | 61.5 | 73.6 | 80.0 | 40.0 | 66.7 |

TABLE 18

| | | Training substances | | | | | | Validation substances | | |
|---|---|---|---|---|---|---|---|---|---|---|
| | | | | | Total | Total | Degree of | Total | Total | Degree of |
| | | Grp 1 | Grp 2 | Grp 3 | of C+ | of C− | consistency | of C+ | of C− | consistency |
| | | Number of substances | | | | | | | | |
| Gene No. | | 17 | 23 | 6 | 46 | 26 | 72 | 10 | 5 | 15 |
| 4846/2203/5726/154 | Number of substances for which | 17 | 14 | 6 | 37 | 16 | 53 | 8 | 3 | 11 |
| | correct prediction was made | | | | | | | | | |
| | Predictive value (%) | 100.0 | 60.9 | 100.0 | 80.4 | 61.5 | 73.6 | 80.0 | 60.0 | 73.3 |
| 4846/2203/5726/725 | Number of substances for which | 17 | 16 | 5 | 38 | 19 | 57 | 9 | 3 | 12 |
| | correct prediction was made | | | | | | | | | |
| | Predictive value (%) | 100.0 | 69.6 | 83.3 | 82.6 | 73.1 | 79.2 | 90.0 | 60.0 | 80.0 |
| 4846/2203/5726/1131 | Number of substances for which | 17 | 14 | 6 | 37 | 16 | 53 | 10 | 3 | 13 |
| | correct prediction was made | | | | | | | | | |
| | Predictive value (%) | 100.0 | 60.9 | 100.0 | 80.4 | 61.5 | 73.6 | 100.0 | 60.0 | 86.7 |
| 4846/2203/5726/1562 | Number of substances for which | 17 | 14 | 6 | 37 | 19 | 56 | 8 | 3 | 11 |
| | correct prediction was made | | | | | | | | | |
| | Predictive value (%) | 100.0 | 60.9 | 100.0 | 80.4 | 73.1 | 77.8 | 80.0 | 60.0 | 73.3 |
| 4846/2203/5726/1741 | Number of substances for which | 17 | 14 | 6 | 37 | 16 | 53 | 9 | 2 | 11 |
| | correct prediction was made | | | | | | | | | |
| | Predictive value (%) | 100.0 | 60.9 | 100.0 | 80.4 | 61.5 | 73.6 | 90.0 | 40.0 | 73.3 |
| 4846/2203/5726/1993 | Number of substances for which | 17 | 14 | 6 | 37 | 17 | 54 | 8 | 3 | 11 |
| | correct prediction was made | | | | | | | | | |
| | Predictive value (%) | 100.0 | 60.9 | 100.0 | 80.4 | 65.4 | 75.0 | 80.0 | 60.0 | 73.3 |
| 4846/2203/5726/2546 | Number of substances for which | 17 | 14 | 6 | 37 | 16 | 53 | 8 | 2 | 10 |
| | correct prediction was made | | | | | | | | | |
| | Predictive value (%) | 100.0 | 60.9 | 100.0 | 80.4 | 61.5 | 73.6 | 80.0 | 40.0 | 66.7 |
| 4846/2203/5726/3776 | Number of substances for which | 17 | 14 | 6 | 37 | 18 | 55 | 8 | 3 | 11 |
| | correct prediction was made | | | | | | | | | |
| | Predictive value (%) | 100.0 | 60.9 | 100.0 | 80.4 | 69.2 | 76.4 | 80.0 | 60.0 | 73.3 |
| 4846/2203/5726/4095 | Number of substances for which | 17 | 16 | 6 | 39 | 17 | 56 | 8 | 3 | 11 |
| | correct prediction was made | | | | | | | | | |
| | Predictive value (%) | 100.0 | 69.6 | 100.0 | 84.8 | 65.4 | 77.8 | 80.0 | 60.0 | 73.3 |
| 4846/2203/5726/4973 | Number of substances for which | 17 | 15 | 6 | 38 | 16 | 54 | 8 | 2 | 10 |
| | correct prediction was made | | | | | | | | | |
| | Predictive value (%) | 100.0 | 65.2 | 100.0 | 82.6 | 61.5 | 75.0 | 80.0 | 40.0 | 66.7 |
| 4846/2203/5726/5634 | Number of substances for which | 17 | 15 | 6 | 38 | 14 | 52 | 8 | 4 | 12 |
| | correct prediction was made | | | | | | | | | |
| | Predictive value (%) | 100.0 | 65.2 | 100.0 | 82.6 | 53.8 | 72.2 | 80.0 | 80.0 | 80.0 |
| 4846/2203/5726/5878 | Number of substances for which | 17 | 14 | 6 | 37 | 22 | 59 | 9 | 3 | 12 |
| | correct prediction was made | | | | | | | | | |
| | Predictive value (%) | 100.0 | 60.9 | 100.0 | 80.4 | 84.6 | 81.9 | 90.0 | 60.0 | 80.0 |
| 4846/2203/5726/6026 | Number of substances for which | 17 | 16 | 6 | 39 | 19 | 58 | 8 | 4 | 12 |
| | correct prediction was made | | | | | | | | | |
| | Predictive value (%) | 100.0 | 69.6 | 100.0 | 84.8 | 73.1 | 80.6 | 80.0 | 80.0 | 80.0 |
| 4846/2203/5726/6303 | Number of substances for which | 17 | 17 | 6 | 40 | 16 | 56 | 9 | 4 | 13 |
| | correct prediction was made | | | | | | | | | |
| | Predictive value (%) | 100.0 | 73.9 | 100.0 | 87.0 | 61.5 | 77.8 | 90.0 | 80.0 | 86.7 |

### Comparative Example 1

Among the genes in the combination of the genes which gave the highest predictive value in Example 1, one gene was replaced by a gene which was not selected in Examination Example 1, and the carcinogenicity of each of the training substances and the validation substances was predicted. The results are shown in Table 19. Incidentally, the gene used in the replacement for the gene in Example 1 in this Comparative Example is a gene randomly selected from the genes which were not selected in Examination Example 1.

TABLE 19

| Training substances | | | | | | Validation substances | | |
|---|---|---|---|---|---|---|---|---|
| | | | Total | Total | Degree of | Total | Total | Degree of |
| Grp 1 | Grp 2 | Grp 3 | of C+ | of C− | consistency | of C+ | of C− | consistency |
| Number of substances | | | | | | | | |
| 17 | 23 | 6 | 46 | 26 | 72 | 10 | 5 | 15 |

No. 4846 gene was replaced by another gene

| | | | | | | | | | | |
|---|---|---|---|---|---|---|---|---|---|---|
| 1161/2203/813 | Number of substances for which | 5 | 17 | 3 | 25 | 24 | 49 | 3 | 5 | 8 |
| | correct prediction was made | | | | | | | | | |
| | Predictive value (%) | 29.4 | 73.9 | 50.0 | 54.3 | 92.3 | 68.1 | 30.0 | 100.0 | 53.3 |
| 1507/2203/813 | Number of substances for which | 5 | 17 | 3 | 25 | 24 | 49 | 3 | 5 | 8 |
| | correct prediction was made | | | | | | | | | |
| | Predictive value (%) | 29.4 | 73.9 | 50.0 | 54.3 | 92.3 | 68.1 | 30.0 | 100.0 | 53.3 |
| 1856/2203/813 | Number of substances for which | 5 | 17 | 3 | 25 | 24 | 49 | 3 | 5 | 8 |
| | correct prediction was made | | | | | | | | | |
| | Predictive value (%) | 29.4 | 73.9 | 50.0 | 54.3 | 92.3 | 68.1 | 30.0 | 100.0 | 53.3 |

No. 2203 gene was replaced by another gene

| | | | | | | | | | | |
|---|---|---|---|---|---|---|---|---|---|---|
| 4846/2864/813 | Number of substances for which | 12 | 4 | 4 | 20 | 20 | 40 | 5 | 4 | 9 |
| | correct prediction was made | | | | | | | | | |
| | Predictive value (%) | 70.6 | 17.4 | 66.7 | 43.5 | 76.9 | 55.6 | 50.0 | 80.0 | 60.0 |
| 4846/3525/813 | Number of substances for which | 12 | 4 | 4 | 20 | 19 | 39 | 5 | 4 | 9 |
| | correct prediction was made | | | | | | | | | |
| | Predictive value (%) | 70.6 | 17.4 | 66.7 | 43.5 | 73.1 | 54.2 | 50.0 | 80.0 | 60.0 |
| 4846/4186/813 | Number of substances for which | 12 | 5 | 4 | 21 | 19 | 40 | 5 | 4 | 9 |
| | correct prediction was made | | | | | | | | | |
| | Predictive value (%) | 70.6 | 21.7 | 66.7 | 45.7 | 73.1 | 55.6 | 50.0 | 80.0 | 60.0 |

No. 813 gene was replaced by another gene

| | | | | | | | | | | |
|---|---|---|---|---|---|---|---|---|---|---|
| 4846/2203/5066 | Number of substances for which | 13 | 16 | 4 | 33 | 20 | 53 | 5 | 4 | 9 |
| | correct prediction was made | | | | | | | | | |
| | Predictive value (%) | 76.5 | 69.6 | 66.7 | 71.7 | 76.9 | 73.6 | 50.0 | 80.0 | 60.0 |
| 4846/2203/5877 | Number of substances for which | 13 | 16 | 4 | 33 | 20 | 53 | 5 | 4 | 9 |
| | correct prediction was made | | | | | | | | | |
| | Predictive value (%) | 76.5 | 69.6 | 66.7 | 71.7 | 76.9 | 73.6 | 50.0 | 80.0 | 60.0 |
| 4846/2203/6027 | Number of substances for which | 13 | 16 | 4 | 33 | 20 | 53 | 5 | 4 | 9 |
| | correct prediction was made | | | | | | | | | |
| | Predictive value (%) | 76.5 | 69.6 | 66.7 | 71.7 | 76.9 | 73.6 | 50.0 | 80.0 | 60.0 |

From Tables 15 and 16, it is found that, in Example 1, the predictive value for the carcinogens in Group 1 is 80% or more. On the other hand, in Comparative Example 1 in which the No. 4846 gene was replaced by another gene, as is apparent from Table 19, the predictive value for the carcinogens in Group 1 was 29.4%. Similarly, in the case where the No. 2203 gene was replaced by another gene, the predictive value for the carcinogens in Group 2 significantly decreased; and in the case where the No. 813 gene was replaced by another gene, the predictive value for the carcinogens in Group 3 significantly decreased.

Further, the predictive value for the validation substances with carcinogenicity was from 60 to 100% in Example 1, however, it was from 30 to 50% in Comparative Example 1.

1. A method for predicting the carcinogenicity of a test substance in a rodent, comprising the steps of:
administering a solution of the test substance prepared by dissolving or dispersing the test substance in a solvent to a test group and administering the solvent used for the preparation of the solution of the test substance to a control group;
extracting mRNA from each group after a period of administration of the solution of the test substance or the solvent to each group, then measuring the expression level of mRNA expressed from each of genes obtained by selecting one or more genes from each of the following (A) to (C):
(A) genes each comprising a nucleotide sequence depicted in any one of SEQ ID NOs: 1 to 5,
(B) genes each comprising a nucleotide sequence depicted in any one of SEQ ID NOs: 6 to 8, and
(C) genes each comprising a nucleotide sequence depicted in any one of SEQ ID NOs: 9 to 32,
determining whether or not a significant difference in the expression level of mRNA expressed from each of the selected genes is observed between the test group and the control group by a significant difference test; and
determining that the test substance has carcinogenicity when a significant difference in the expression level of mRNA expressed from any one of the selected genes is observed between the test group and the control group and the direction of increase or decrease in the expression level of the mRNA in the test group relative to the control group is the same as that previously defined for each gene from which the mRNA is expressed.

2. A method for predicting the carcinogenicity of a test substance in a rodent, comprising the steps of:
administering a solution of the test substance prepared by dissolving or dispersing the test substance in a solvent to a test group and administering the solvent used for the preparation of the solution of the test substance to a control group;
extracting mRNA from each group after a period of administration of the solution of the test substance or the solvent to each group, then measuring the expression level of mRNA expressed from each of genes obtained by selecting one or more genes from each of the following (A) to (C):
(A) genes each comprising a nucleotide sequence depicted in any one of SEQ ID NOs: 1 to 5,
(B) genes each comprising a nucleotide sequence depicted in any one of SEQ ID NOs: 6 to 8, and
(C) genes each comprising a nucleotide sequence depicted in any one of SEQ ID NOs: 9 to 32;
determining whether or not a significant difference in the expression level of mRNA expressed from each of the selected genes is observed between the test group and the control group by a significant difference test; and
determining that the test substance has carcinogenicity when a significant difference in the expression level of mRNA expressed from any one of the selected genes is observed between the test group and the control group and the direction of increase or decrease in the expression level of the mRNA in the test group relative to the control group is the same as that previously defined for each gene from which the mRNA is expressed, and determining that the test substance has no carcinogenicity when a significant difference in the expression level of mRNA is not observed between the test group and the control group for all of the selected genes, or even if a significant difference in the expression level of mRNA expressed from any one of the selected genes is observed between the test group and the control group, when the direction of increase or decrease in the expression level of the mRNA expressed from the gene in the test group relative to the control group is not the same as that previously defined for each gene.

3. The method for predicting the carcinogenicity of a test substance in a rodent according to claim 1 or 2, wherein the period of administration of the solution of the test substance is from 1 to 90 days.

4. The method for predicting the carcinogenicity of a test substance in a rodent according to claim 1 or 2, wherein a test animal in the test group and the control group is a rat, a mouse, a hamster, or a guinea pig.

5. The method for predicting the carcinogenicity of a test substance in a rodent according to claim 1 or 2, wherein the gene selected from (A) is a gene comprising a nucleotide sequence depicted in SEQ ID NO: 2, the gene selected from (B) is a gene comprising a nucleotide sequence depicted in SEQ ID NO: 7, and the gene selected from (C) is a gene comprising a nucleotide sequence depicted in SEQ ID NO: 10.

6. A method for predicting the carcinogenicity of a test substance in a rodent, comprising the steps of:
administering a solution of the test substance prepared by dissolving or dispersing the test substance in a solvent to a test group and administering the solvent used for the preparation of the solution of the test substance to a control group;
extracting mRNA from each group after a period of administration of the solution of the test substance or the solvent to each group, then measuring the expression level of mRNA expressed from each of genes obtained by selecting one or more genes from each of the following (A) to (C):
(A) genes each comprising a nucleotide sequence depicted in any one of SEQ ID NOs: 1 to 5,
(B) genes each comprising a nucleotide sequence depicted in any one of SEQ ID NOs: 6 to 8, and
(C) genes each comprising a nucleotide sequence depicted in any one of SEQ ID NOs: 9 to 32, and the following gene (D),
(D) a gene comprising a nucleotide sequence depicted in SEQ ID NO: 33;
determining whether or not a significant difference in the expression level of mRNA expressed from each of the genes is observed between the test group and the control group by a significant difference test; and
determining that the test substance has carcinogenicity when a significant difference in the expression level of mRNA expressed from any one of the genes is observed between the test group and the control group and the direction of increase or decrease in the expression level of the mRNA in the test group relative to the control group is the same as that previously defined for each gene from which the mRNA is expressed.

7. The method for predicting the carcinogenicity of a test substance in a rodent according to claim 6, wherein the period of administration of the solution of the test substance is from 1 to 90 days.

8. The method for predicting the carcinogenicity of a test substance in a rodent according to claim 6, wherein the gene selected from (A) is a gene comprising a nucleotide sequence depicted in SEQ ID NO: 2, the gene selected from (B) is a gene comprising a nucleotide sequence depicted in SEQ ID NO: 7, and the gene selected from (C) is a gene comprising a nucleotide sequence depicted in SEQ ID NO: 10.


SEQUENCE LISTING (66 sequences)

SEQ ID NO: 1 - DNA, 60 bp, Rattus norvegicus
ttttaaaaggaaccgagtacatctgcaaaacctaagtcttaagggacgtccaggaggtac

SEQ ID NO: 2 - DNA, 60 bp, Rattus norvegicus
tgagctgggagtatttgaggtgctaagtatttctaatattggtgttcaaacatggcacgt

SEQ ID NO: 3 - DNA, 60 bp, Rattus norvegicus
ctgaaattgagtaaccgtttgaatgacacatagatgtaatgcggtgttggaagcggatgt

SEQ ID NO: 4 - DNA, 60 bp, Rattus norvegicus
aaaaatactgagtggatcaccaactaccatcatggttggggtacacctttcaataaaatt

SEQ ID NO: 5 - DNA, 60 bp, Rattus norvegicus
gttatagcaatcatttgtaaagccttgctccatagcctcctaacactgaccatgttgctt

SEQ ID NO: 6 - DNA, 60 bp, Rattus norvegicus
cgggagcaagagtacaagtgtatttatgaattgtaaccacatgcaaataaagaccaagat

SEQ ID NO: 7 - DNA, 60 bp, Rattus norvegicus
aagcagaataagcctcagaaacaaaatgatggcacagggaaagactcttctaaaagcaca

SEQ ID NO: 8 - DNA, 60 bp, Rattus norvegicus
agagtcctgccgtaatttacatgtgtctttacatcttccttgctggcatgaatgttttgt

SEQ ID NO: 9 - DNA, 60 bp, Rattus norvegicus
cccagatgtatcagaagaatctaagcacgatgattgcaagtgacacgagtggagattaca

SEQ ID NO: 10 - DNA, 60 bp, Rattus norvegicus
tggacaagtccactggtaaacccacactgtacaatgtatcgctgatcatgtctgacacag

SEQ ID NO: 11 - DNA, 60 bp, Rattus norvegicus
ttcacatatgaaccattgctaatatattgtttaagcctctccctctctggtgtccttggc

SEQ ID NO: 12 - DNA, 60 bp, Rattus norvegicus
aggacgcctgcctggttagactttaaatttgctcaatgacaaacgagatcagtgttaatt

SEQ ID NO: 13 - DNA, 60 bp, Rattus norvegicus
gaacccacaggagactttaaactctagtagatggatgctaaatgcctaggcccacttaac

SEQ ID NO: 14 - DNA, 60 bp, Rattus norvegicus
cagaactttaacctgaaatctctggttcacccaaaggacattgatacgatgccagttctg

SEQ ID NO: 15 - DNA, 60 bp, Rattus norvegicus
gagccatagtaaccacactgtatgcatgtactggtggtgaaggcaggtgtaatttatttt

SEQ ID NO: 16 - DNA, 60 bp, Rattus norvegicus
tttaccgtccccttttctggccaagtaactgcttgaaaacctaaagcactaaacattgta

SEQ ID NO: 17 - DNA, 60 bp, Rattus norvegicus
ttttacccagtcccttccctttatcacccatcctgaattttgttttaagatcccgaaagc

SEQ ID NO: 18 - DNA, 60 bp, Rattus norvegicus
tgttaagagtgcttctctagtatgcatgaagcccagagtccaatctcagtaccagataca

SEQ ID NO: 19 - DNA, 60 bp, Rattus norvegicus
agaggcccacacaattccaaattctcacttcatgtcagagattgactgattgaaaagctt

SEQ ID NO: 20 - DNA, 60 bp, Rattus norvegicus
atgaataccttgaacaagcattgacatggatcagtggtccagatcttagagtggtcagtt

SEQ ID NO: 21 - DNA, 60 bp, Rattus norvegicus
cagcttccttgttaaccagataactgcaagtcagatgtatgacccctggttggtttattg

SEQ ID NO: 22 - DNA, 60 bp, Rattus norvegicus
tctgctgtggacccagttctatttccaagactcttcataatttgagtaaccggaacaact

SEQ ID NO: 23 - DNA, 60 bp, Rattus norvegicus
aggcatgtgcccaccttaccacatttgattgaaagcacaagttaagatcactgtagattt

SEQ ID NO: 24 - DNA, 60 bp, Rattus norvegicus
cgggcaacgtgcaatgctcctgtagataaaactgtggagacaaataaactatgacatctt

SEQ ID NO: 25 - DNA, 60 bp, Rattus norvegicus
aagtattgacatccctattcatgtttgtggttggatagctaaacccttctgttagggggt

SEQ ID NO: 26 - DNA, 60 bp, Rattus norvegicus
ctaagtattggctgccaggacggtgtctaagcacactacagtctgttcttacgaaatgtg

SEQ ID NO: 27 - DNA, 60 bp, Rattus norvegicus
acaggaatccctatacccttgagtgctccaccttcagaacaacccattaatctaagacta

SEQ ID NO: 28 - DNA, 60 bp, Rattus norvegicus
ggcctgagcctccagattgcagggcaagatctatttcttcatcctttgttctatacaata

SEQ ID NO: 29 - DNA, 60 bp, Rattus norvegicus
acttttatattaagaaaggggccaagtgccaacagtttaaaatcgtgggaaggagatccc

SEQ ID NO: 30 - DNA, 60 bp, Rattus norvegicus
agctcaatagaggcagggttggagtttctgatgtagaagaacacctaaaatgctcttagg

SEQ ID NO: 31 - DNA, 60 bp, Rattus norvegicus
atggtatctggaaggtacttttcatcttaatcagcaaagggtgtcagttggactcgctaa

SEQ ID NO: 32 - DNA, 60 bp, Rattus norvegicus
cagggattggccctgtagccaaaataatataagcaaagaggcattcaaaaatgcagacag

SEQ ID NO: 33 - DNA, 60 bp, Rattus norvegicus
aagcagcaggccactagtgagagtttctgttatgttcctatggaaacactgtgtattgta

SEQ ID NO: 34 - DNA, 530 bp, Rattus norvegicus
tttttttttttgctatgagaattacatttaaacttttgggtgttttataaaaagcagatttcacaagttttgaaaattgtgacctttactgaaatttgttacctttaatatttcttctagaggataggtatttataaaagaaaaattcgtcagaattgctgcctcaatctagtcccatttgagaaaatttgtttctactgtctcaataactggatgaaatatcactctgaaaacttgcctattgcactaaagctagtttaggcttgataaaacactccaggaggtttttaccacagactgtttctattaaaactgctgcttctcatgtacaattttgttttaaaaggaaccgagtacatctgcaaaacctaagtcttaagggacgtcaggaggtaccttcagaattataggaccaccatggtagtggggattctccatgctggccttgaatgtttgatcttcactgctgaaatgtgggtagctcctcagcgccctgtagagcctgagtctacctagaatagctgtaacca

SEQ ID NO: 35 - DNA, 4254 bp, Rattus norvegicus
gctcccatcttcgaggctcagctcaactcagagctacttcttccaaattctacatcttggcggacttcgcgaaggaaacccggagtgttacgtgaggtcctgatggagtttgaagagggccttaacggaagagcagacaagaacttctcaaagatgggcaaaaagagtaaaaaggagaaggagaagaaacctgctgttggcatattcgggatgtttcgctatgcagattggcttgacaagctgtgcatggctctgggaactctcgctgctatcatccacggaaccctgcttcccctcctgatgctggtgttcggatacatgacagatagttttaccccaagcagagacccgcattctgaccgagcgattactaatcaaagtgaaatcaacagtacacataccgtcagcgacacgagtctggaggaggacatggccatgtatgcctactattacacgggcattggtgccggtgtgctcatcgttgcctacatccaggtttcactttggtgcctggcagctgggagacaaatacacaagattaggcagaagtttttccatgccatcatgaatcaggagataggctggtttgacgtgaatgacgctggggagctcaacacccgtctcacagatgacgtctccaaaattaatgacggaattggtgacaaacttggaatgttctttcagtccataacgacattttcagccggttttataataggatttataagtggttggaagctaacccttgtaattttggccgtcagccctcttattgggttgtcatctgccatgtgggcaaaggtactgacttcatttactaataaggaactccaggcttatgcgaaagctggagcagttgccgaagaagtcttagcagccatcagaactgtgattgcgtttggaggacaaaagaaggaacttgaaaggtacaataaaaatttagaagaagctaaaagagttggcataaagaaagccatcacggccaacatttccataggtattgcctacctgttggtctatgcgtcttatgcactggcattctggtatgggacctccttggtcctctcaaatgaatattctattggacaagtgcttaccgtcttcttctctattttattggggactttcagtattggacatttagccccaaacatagaagcctttgcaaatgcaagaggggcagcctatgaaatcttcaagataattgataatgagccaagcatcgacagcttctcaaccaagggacacaaaccagacagtataatgggaaatttggaatttaaaaatgtttacttcaactacccatcacgaagtgaagttaagatcttgaagggcctcaacctgaaggtgaagagcgggcagacggtagccctggttggcaacagtggctgtgggaaaagcacaactgtccagctgctgcagaggctctacgaccccatagagggcgaggtcagtattgacggacaggacatcaggaccatcaatgtgaggtatctgcgggaaatcattggggtggtgagtcaggaacccgtgctgtttgccaccacgattgccgaaaacattcgctatggccgagaaaacgtcaccatggatgagatagagaaagctgtcaaggaagccaatgcctatgacttcatcatgaaactgccccacaaatttgacaccctggttggtgagagaggggcgcagctgagtgggggacagaaacagaggatcgccattgcccgggccctggtccgcaaccccaagatccttttgttggatgaggccacgtcagccttggacacagaaagcgaagccgtggttcaggccgctctggataaggctagagaaggccggaccaccattgtgatagctcaccgcttgtctacagtgcgcaatgctgacgtcattgctggttttgatggtggtgtcattgtggagcaaggaaatcatgaagagctcatgaaagagaagggcatttacttcaaacttgtcatgacacagactagaggaaatgaaattgaaccaggaaataatgcttatgaatcccaaagtgacactggtgcctctgagttgacttcagaagaatcaaaatctcctttaataaggagatcaattcgcagaagtatccacagaagacaagaccaggagagaagacttagttcgaaagaggatgtggatgaagatgtgcctatggtttccttttggcagatcctaaagctaaatattagtgaatggccctatttagttgtgggtgtactttgtgctgttataaatgggtgcatacaaccagtgtttgccatagtgttttcaaagattgtaggggttttttcaagagacgacgaccatgaaaccaaacaacggaattgtaacttgttttcccttctctttctggtcatgggaatgatttcttttgttacgtacttctttcaaggcttcacatttggcaaagctggagagatcctcaccaagcgactccgatacatggtcttcaaatccatgctgcgacaggatataagctggtttgatgaccataaaaacaccactggctcgctgactaccaggctcgctagtgacgcttctaatgttaaaggggctatgggctccaggcttgctgtagttacccagaatgtagcaaaccttggcacaggaattatcttatccttagtcttagtctatggctggcagcttacacttttacttgtagtaattataccactcattgtcttgggtggaattattgaaatgaaactgttgtctggtcaagccttgaaggacaagaaagagctagagatctctgggaagatcgctacagaagcaattgaaaacttccgcactgttgtctctttgactcgggagcagaagtttgaaactatgtatgcccagagcttgcagataccatacagaaatgctttgaagaaagcacacgtctttgggatcaccttcgccttcacccaggccatgatttatttttcctatgctgcttgtttccggttcggtgcctacttggtggcacgagaactcatgacgtttgaaaatgttatgttggtattttctgctgttgtctttggtgccatggcagcagggaataccagttcattcgctcctgactacgcgaaggccaaagtctcggcatcccacatcattgggatcattgagaaaatccccgagattgacagctacagcacggagggcttgaagcctaattggttagaaggaaatgtgaaatttaatggagtcaagttcaactatcccacccgacccaacatcccagtgcttcagggactgagcttcgaggtgaagaaggggcagacgctccgcctggtgggcagcagtggctgcgggaagagcacggtggtccagctgctcgagcgcttctacaaccccatggctggaacagtgtttctagatggcaaagaaataaagcaactcaatgtccagtgcgtccgcgcactgggcattgtgtcccaggagcccatcctgtttgactgcagcatcgccgagaacatcgcctacggagacaacagccgtgtcgtgtctcatgaggagatcgtgagggccgccagggaggccaacatccaccagttcatcgactcactgcctgagaaatacaacaccagagtgggagacaaagggactcagctgtcgggcgggcagaagcagcgcatcgccatcgcgcgcgccctcgtcagacagcctcacatcttacttctggatgaagcgacatcagctctggatacggagagtgaaaaggtcgtccaggaagcgctggacaaagccagggaaggccgcacctgcgttgtgatcgcgcaccgcctgtccaccatccagaacgcagacttgatcgtggtgattcagaacggccaggtcaaggagcacggcacccaccagcagctgctggcccagaaaggcatctatttctcgatggttcaggctggagcaaagcgctcatgagctgggagtatttgaggtgctaagtatttctaatattggtgttcaaacatggcacgtaaccaaagttaaaaggttaaaagcactgttaaaggtaatttcatcaagacgagaagccttcagagacttcataattaaatgaaccgaaattgaaaaaaaaatcattaaacagggccacattttttaattgtattatgtgattcaagagaacatatagtttttttaaaaagaaatgtgtagttttgtttcagtttttttaatttctaccctattcccttaaatgatcataaaggctgtaaaaagcactatttttttgcggcc

SEQ ID NO: 36 - DNA, 837 bp, Rattus norvegicus
gggatccggcaacgaaggtaccatggctcagttccagagcctgtgtaccgttccaggttacggagtttctgcacagtttgcaaactggaacttggcagaatggctgagatctgcaaaatgaaatacacggtgttggacagccctttggggaagatagagctgtccggctgtgagcgaggcctgcatgggatacgatttctcagtgggaagaccccaaacactgaccccacagaggctccagcctgtcctgaggtgctcggtgggccagagggagtgccagagcccctggtgcagtgcacagcctggctggaagcctatttccacgaacctgcagccacagaggggcttcccttgcctgctctccatcaccctgtgttccagcaagattcattcaccagacaggtgttatggaagctgctgaaggttgtgaaattcggagaaatggtttcttaccagcaattagcagccctggcaggcaaccccaaagcggctcgtgcagtaggaggagcgatgaggagcaatccagtccccatcctcatcccctgccacagggtgattcgcagtgacggtgccattggcaattactctggaggaggacagactgtgaaagagtggcttctggcccatgagggcatcccaactggacagccggcctccaaaggcttgggcctgattgggagctggctcaagccatccttcgagtcttccagcccaaagccgtctggctgaaattgagtaaccgtttgaatgacacatagatgtaatgcggtgttggaagcggatgtgtgccatggtaccttcgttgccggatcccgggaattcgtaatcatggtcata

SEQ ID NO: 37 - DNA, 3192 bp, Rattus norvegicus
cgcacgctgaaccggaggaaggctgcgcctagtcggggcgctgagggaccctccaccgggacgccggcccctccccgggcctctgctcacttgcccccctgcgagcccgtccccctagtcggcctctcggatcggggacgtggggcgagctgagagcaggcccggggtgggtggtcactgtggagaagacgtggctgtcaagatgatagaagtactgacaactgactctcagaaactgctacaccagctgaacaccctgttggaacaggagtccagatgtcagccaaaggtctgtggcctgaaactgattgagtctgcacatgataatggcctcaggatgactgcaagactccgggactttgaagtcaaagatctactgagtctaactcagttctttggcttcgacacagaaacattttcccttgctgtgaatttactggacagattcttgtctaaaatgaaggtacaggcgaagcatctcggctgtgtcggactgagctgcttttatttggctgtgaaatcgattgaagaggaaaggaacgtcccgctggcaactgatttgatccggataagtcagtataggttcacagtttcagacctgatgagaatggaaaagattgtgttggagaaagtgtgctggaaagtcaaagctactactgccttccaatttctgcagctctattactccctcattcgggagaccttgccatttgaaaggagaaacgatctgaattttgaaagactagaagcccaactgaaggcgtgccactgcaggatcatattttctaaggcaaagccttctgtgctggcgctggcaatcatcgctttggagatccaagcactgaagtatgtggagttaacagaaggagtagaatgtattcagaaacattccaagataagtggccgagatctgaccttctggcaagagcttgtttccaagtgtttaactgaatattcatcaaacaagtgttccaagccgaacggtcagaagttaaaatggatcgtgtctgggcgcactgcacgacaactgaagcacagttattacaggataacccacctcccaacaattcccgaaaccatgggttagttggcaaatctggttgttatcctctgtgtacagaacatttcccagtgagatcgtttttgtgctataacttaaggattgaaatactaccttcaatataaagaatacaggatgaaaacagtaaaggaaacgtgagtttgttggtctagacagagaatactgggaggcattcactgtgtaccgcagtctgaagagaaatgagtatcaaacctctagacacatgctcatactgctgtcaaaggactagcgtagaaaagagagtcctccaaaccggaagtttaaatgtagttactaaaatagcacttctttaacttacatatccccccactgtggcttatttaaagttacagaagtccaagcagaacgacaaaagatgtgacccatatatgaacacattttaatctgttcattgattaggagagtgaatatgaacttgcatgatgcccatgttaggtttctggaaactgccggggtatcttaattctctagtattctccctctgtggcagttgggctaatacaaagtaactatacgcatgagaatataaaatcagtctctgatacatacacatttttaccatcaaaatttcttaatcatagcaaagacttacctttttatgattaggaattttttttttaatgtatggcagcacatgcctttaatcccaacactagggaggcagaggcaggtggatctctttgagttcgaagccaggctggtctttacagtgagttccaggacagctggagagctacagaatggagagacgctgtctcaaaaacactgaaaacaaacaaacaaaccataccagtttgtaggcagacttctgttgggttgggtttgtactgtttgcctatgcagtgggattacagcagcagcaacaaaaactgtccctgaagtctttctctgccactgtgacctgagtttcctatggtacgcgatttattctaagaaacctcagcccctcaccacgttagctgttggcaaatggcctcacagttgcggaaagtcccaattctaggcttgggaaagcaatgcttagatttgaattggcccatgaagcattcaaatcaaggctaaagacataaatgtgaaataaaactgtgaaccttcattttaacattgatctcacttcccagatttaatcaatatatacttaggtggtattaaaaatggtaaactgcctaatttaaatctcaaaatttaaactatgaggtttacatcaaagccaacatttcacaaatgtacttttaaggtattaaaagaggtatttaagcagtaaatggtttcttggcacccataaccaagtaatagttaagttagaggtgggacttttttattgctatgagaattacatttaaacttttgggtgttttataaaaagcagatttcacaagttttgaaaattgtgacctttactgaaatttgttacctttaatatttcttctagaggataggtatttataaaagaaaaattcgtcagaattgctgcctcaatctagtcccatttgagaaaatttgtttctactgtctcaataactggatgaaatatcactctgaaaacttgcctattgcactaaagctagtttaggcttgataaaacactccaggaggtttttaccacagactgtttctattaaaactgctgcttctcatgtacaattttgttttaaaaggaaccgagtacatctgcaaaacctaagtcttaagggacgtcaggaggtaccttcagaattataggatcaccatggtagtggggattctccatgctggccttgaatgtttgatcttcactgctgaaatgtgggtagctcctcagcgccctgtagagcctgagtctacctagaatagctgtaaccattttgacaagtaatggataagaaaattatccattgagaagctaaaaacaaaacaaaacaaaaccaaagaacgggtgtattttattcttaacctttgtaaaccatcactgagaacacttcagttcttcctaacagctgttatgcttcgatttgaaaaaaatactgagtggataaccaactaccatcatgctttgggtacacctttcaataaaattactgaaatgcaaaaaaaaaaaaaaaaaaaaaaaa

SEQ ID NO: 38 - DNA, 1062 bp, Rattus norvegicus
gagtgagcattctgcagggacaaaggaatacaggcagctgtggaggctgactagaatggcaggcaaggtatacatgggaggtgaggactatgaaaaagagttcactcccaaagactacctgaccaccttctacagcttcgactctggcacggtggcagaacaggaaattgtaaaattcagcctgcagaacctctaccagaccttctctacaggaggtgtagggggagatgtcttgattgacattggctctggccccaccatctaccagctgctttcagcatgcgaggtcttccgggagatcatcgccactgactacaccccacagaacctgcaggagctgcagaaatggctgaagaaggagccaggagcctatgactggtcctccattgtacaacatgtgtgtgagctggagggagacagaagcagatggcaggagaaggaggccaagctccgaaggacagtcactcgtgtactgaggtgtgatgtgaccaagacacccccactggggtcagctcaagtgcctctggccgactgcgtgctgacctttctggccatggagtgtgcctgtcctgatgtagatacctaccgggcagccttgcgcagactggctggcctgctgaagccaggagggcatctggttaccttggttactctgcgcttccagcactatatggtgggccccaagaagttctctggggtctacctggagaaggagacggtagaaaaggctattcaagatgctggtttccaggtgctaaggtgcaactgtgtctccctcagctactcagaggcctactgtgtcaacgatggtttatacttcgtggttgcccgaaagggtcccagtgcctgaggccaccggcagagaattgccttccctgaggaagttatagcaatcatttgtaaagccttgctccatagcctcctaacactgaccatgttgcttctctctataacctggtcaccagttcacaagggaaaactcaaggttcagcaccaaaatccatcccccttactccttttgtaccctgatcaaagctcattaaaataaagtggtttctctgg

SEQ ID NO: 39 - DNA, 2103 bp, Rattus norvegicus
tccactcccacttcctgagcccggcactggagccctggaggccaggcccggccgctcccggcccccgggggcacgtcggcccagccaccaggcttgggaagtcgtggccaacgctgctcaggacgtccgggcttcccaccttcctcctaggcctccacccggtctggtcagccgacccgaaaggccgccatgcgcctgcctggggcctcctctccctgcggcctggtctggggaccactcctgctgggattctgcgggctcctggtggcctctcagccccagctggtgcccccatatcgcatagaaaaccaaacttgctgggacccggacaaggaatactacgagcctctgcatcaagtctgctgctcccgctgtcccccaggcaagtttgtccatgctgtctgcagccccagccaagacacggtttgcaagacttgcctccataattcctacaacgaacactggaaccatctcttctcctgccagctgtgccgcccctgtgactctgtgctgggcttcgaggagattgccccctgcaccagcgatcggaaacccgagtgccgctgcaagccggggatgtcctgcgtgtatttggacaatgagtgtgtgcactgtgaggaggagcggcttgtactctgccggcctggcacagaagctgaggtcacagatgaaattatggatactgaagtcaactgtgtcccctgtaagccaggacacttccagaacacgtcctcccccagagcccgctgtcaaccccacaccaggtgtgagagccagggcctggtggaggcagcttcaggtacctcgtactctgacaccatctgtaaaaatccacccgaggcagcaggaacaatgctgctactagccatcctgctgtcgctggtcttctttctgcttttcaccactgtcctggcctgtgcctggatgaggcacccttccctctgcagaaagctgggtactctgctcaagaggcatccagagggagaagaatctcccccctgccagcctccaagagccaacccacatttccgtgacctggcagagccactcctacccatgtctggagacttgtccccagcccctgctggacccccaacggccccctccttggaggaagtggtgctacagcagcagagtcccctgatccaggccagggagctggaggctgagcctggggaacatggccaggtggcccacggtgcgaatggcattcacgtgaccggaggctctgtgactgtcaccggcaatatctacatatacaatgggccagtgctggggggaacacggggccctggagaccctccagctccccctgagcctccatacccgactcccgaagagggagcgcctggcccctctgagctgtctacaccctaccaggaggatggcaaagcttggcatctggctgagacagagacactagggtgccaagacctctgacggggccaagggacctattagccacccatgcctgatggcatctgggaaaggcaaggaggagagagggtccagcaccttcttcctgaggctgctctacccaccaggactcacagagtttggctgggctctgagatacagagccctaagggacttggcctcagacacctcttcagagagacactagcggggcaccgtgcccgcccaggcccctgacgaccgcctgagcaagcctgagaccttgttgcagacccaccagctcccagaggcctcagacacaggcaaggcttgtgaccccaccatgcctctctgagccctaaacatggcagaggagggagctgggcccagggtcactttcaaggacatccggggaccttgcaaggctttgtggtgctcatccccaaccttcagaggccttgagggcttgtactgcgtggaccaagatagaccctgggtgaacatgatgtcgcatggaggagcacccctcccttgctcctgggggagagaggacagtgagaagggcaggggggcttcagtagcattaccacatgtggaggacagtttgggaacgggagaaagagtacaagtgtatttatgaattgtaaccacatgcaaataaagacaagatggagatccttaaaaaaaaaaaaaaaaaaaaaaaaaaaa

SEQ ID NO: 40 - DNA, 4461 bp, Rattus norvegicus
atggcggcgctgtgccttacggtgaacgccggaaaccctccactgggttgtcgagttaaagtgaacaagagaaataaatccttcatgttgtcatttttagaagctctgctggcagtggagcatgtgaaaggtgatgtcagcatttctgtggaagaagggaaggagaatcttcttcgggtttctgagagtgtggtgttcactgacacaaattcaatcctgcgctacttggctagagttgcagctacatctgggctgtacggttctaacctgatggagcacacggagattgatcattggttggagttcagcgctacaaagttgtcttcgtgtgatgtgctgacttcggcaatcaaggagcttaaccattgcctgtctctgagaacatacctggttgggaactctttgactttagcagatttatgtgtttgggccaccctaaaaggaaatgctgcatgtcaggagcacttgagacagagcaaaaccctagtccacgttaaccgctggtatggctttcttgaagcccagcaggccttccgttcagttggtaccaagtgggatgcttcagcaaacaaagctacaggggcacctgacagaaaacaagatattgggaaattcgtcgagcttccgggtgcagagatgggaaaggtgacagtcagattccccccagaggctagtggttacttacacattgggcatgcaaaggctgctcttctgaaccagcactaccaggttaactttaaaggcaaactgatcatgagatttgatgacacaaacccagaaaaggaaaaggaagattttgagaaggtcatcttggaagatgttgcaatgctgcacattaaaccagatcagtttacttacacttcagatcattttgaaactataatgaagtatgcagagaaattaattgaagaagggaaggcctatgtggacgacactcccgcagacgagatgaaggcggagcctgttgagaagaatctacaaatgtgggaagaaatgaaaagaggaagccagtttggtcagtcctgttgcctgcgagcaaaaattgacatgagtagtaacaatgggtgtatgagggacccaaccctttaccgctgcaaaatccagccccacccaagaactgggaataaatacaatgtttacccaacgtatgactttgcctgtcctatagtggacagcattgaaggtgttactcatgccttgaggacgacagagtaccacgaccgagatgagcagttttactggattattgaagccttaggcataaggaaaccatacatctgggaatacagtcgcttaaatctcaacaacacagtgctgtccaagagaaagcttacgtggtttgtcaatgaaggactgggctcctcaaggtctgttgtaaacatggaatgggacaaaatctgggcgtttaacaaaaaggttattgaccctgtggctccaaggtacgttgcattgctgaagaaggaggtgatcccagtgaacatcctggacgcgcaggaggagatgaaggaagtagccagacatcccaagaatcctgatgttggtttgaagcctgtgtggtatagtcccaaggttttcatagaaggagctgatgcagagactttctcagagggtgaaatggtcacatttataaactggggcaacatcaacattactaaaatacacaaaaatccagatggaaaaattacatctctggatgcaaaattgaatttggaaaacaaagactacaagaaaacaactaagatcacttggcttgcggagaccacacaggctctccctgtcccggcagtctgtgtcacttatgagcacttgattacaaagccagtgctaggaaaagacgaggacttcaagcagtacgtcaacaaagacagtaagcatgaagaactaatgctaggagatccctgccttaaggatttgaagaaaggagacatcatacaattgcagaggcgcggattcttcatatgcgaccagccgtacgaacctgtcagcccatatagttgcaaagaagccccctgcatcttgatatatatacccgatgggcacaccaaggagatgccaacatctggatcaaaggaaaagactaaagtggaaatctcaaaaaaggagaccggctctgctcctaaggagagacccgcagctgctgtgagtgctccctgtgctgcagctgaggacgctgccatcctctacagcagagtggcggtccagggtgatgcggttcgcgacctgaaagcgaagaaagcaccaaaggaggatattgacgcagctgtgaaacagcttttgactttgaaggctgagtataaagagaaaactgggcaggagtatagacctgggaacccccctactgcagcagtgcagactgtttctacaaagtccccatccaacaccggggaatacacatctttatacaataaagttgctgcccaaggggagctggtccggaagctgaaagctgaaaaggctcctaaggctaaaataaatgatgctgtagaatgcttactgtccctgaaagctgagtataaagaaaaaactgggaaggagtatgtacctggccaactcccagcatctcagaactcacattcaagtcctgtcagcaatgccaagcctgttggatcagagacaccggaagccaaactgctgtttgacagagtggcttgtcaaggagaagtagttcggaaacttaaagctgagaaggcctctaaggatcaagtggattcagccgtacaagaacttcttcagctgaaggcacagtacaagtcactgacaggaattgagtataagcctgtgtctgctactggggcagaagacaaagataagaagaagaaagaaaaagaaaataagtctgaaaagcagaataagcctcagaaacaaaatgatggccaagggaaagactcttctaaaagccaaggcagcgggctgtcgtccggtggagcaggagaagggcaagggcccaagaaacagaccagattgggtcttgaagcaaaaaaagaagaaaatcttgccgaatggtattcccaagtcatcacgaagtcagagatgatcgaatactacgatgtgagtggctgctatattctccgaccctggtcgtactccatctgggaatccattaaggacttctttgacgcggagatcaagaagctcggcgttgagaactgctacttccccatattcgtgtcccagggcgcactagagaaggagaagaaccacattgctgactttgctcccgaggttgcttgggtgacaagatctggaaagacagagctggcagagccgattgccatccgtcctactagtgaaacagtaatgtatcctgcatatgcaaaatgggtgcagtcccacagagacctgcccatcaggctcaaccagtggtgcaacgtggtgcgctgggagttcaaacacccacaacctttcctccgcactcgggagttcctatggcaggaggggcacagcgcctttgccacctttgaggaggcagctgacgaggtgttacagatcctcgagttatatgctcgagtgtatgaggagctcttggcaatccccgtcgtgagaggaaggaagactgagaaggaaaagtttgcaggaggagactatacaaccacactagaagccttcatatctgccagcggacgcgctatccagggagcaacatcacaccatttaggccagaatttctccaaaatgtgtgaaatagtttttgaagatcccaagacaccaggagaaaagcagtttgcataccagtgctcctggggcctgacaactcgcactatcggtgtgatgatcatggtccatggggacaacatgggcttagtgttacctccccgtgtagcgtctgtccaggtggtagtcattccctgtggaatcacgaataccttgtctgaagaagacagagaggccctgatggcaaaatgcaatgagtacaggagacggctgctcggcgctgacatccgagctcgagtcgatctacgagacaactactcaccaggctggaagttcaaccactgggagctcaagggtgttccagtcagacttgaggtggggccacgtgatatgaagagctgtcagtttgtagcagtcagacgagatactggagagaagctgacaattgctgaaaaggaggcggagtctaaactgaaaggggttttggaagacatccagcttaaccttttcacaagggcttctgaagaccttaaatctcacatggttgtatcggatacactggaagactttcagaaggtgctagattctgggaaggttgcacagattccattctgtggggaaattgactgtgaggactggatcaaaaagacaacggccagggatcaggatgtggaacctggtgctccatccatgggagccaaaagcctttgcattcctttcaaccctctgtgtgagctgcagccaggagccatgtgtgtctgtggcaagaatcctgccaagttctacaccttgtttggtcggagttactga

SEQ ID NO: 41 - DNA, 2181 bp, Rattus norvegicus
ggggacgcgccgggctgccacatcgggcttcgtggctgaaatacagtcagtgtcgcttagcggacgctgtcaggtctctctgcacttccattcctgaaggacccacacaatgctttccaaactagcaagtctgcagactgttgccgctctgcgtcgaggactccgcacctcagtcgcctctgccacatctgttgcaacgaagaagacagagcaaggcccaccatcctctgagtacatttttgaacgggaatctaaatatggtgcacacaattaccatcctttacctgtagccctggagagaggaaaaggcatttatatgtgggatgtggaaggcaggcagtacttcgacttcctgagtgcttatggtgctgtcagccaaggacactgccacccaaagatcatagaagccatgaagagtcaggtggacaagctgacattaacatctcgggctttctataacaatgtccttggtgaatatgaggagtacatcaccaagcttttcaactacaacaaagttcttcctatgaatacaggagtggaggccggagagactgcgtgtaagcttgctcgccgttggggctacaccgtgaaaggcatccagaaatacaaagcaaagatcgtttttgctgttggaaacttttggggtcggacgctgtctgcagtctccagttccacagatccgaccagttatgatggctttggacccttcatgccaggctttgaaaccatcccatataacgatctgcctgcgctagagcgtgctcttcaggatcccaatgttgctgctttcatggtggagcccatccagggtgaagcgggtgttatcgttccagatccaggatacctgacgggagttcgagaactttgcacccggcaccaggtcctgtttattgctgatgaaatacagacaggattggctagaactggtcgatggctagctgtggatcatgagaatgtcagacctgacatagttcttcttgggaaggccctttctggtggcttatatcccgtgtctgcagtgctgtgtgatgatgacataatgctgaccattaaaccaggcgagcacggctccacgtatggcggcaacccactaggctgccgaattgctattgcggctcttgaggttttagaagaagagcatcttgctgaaaacgcagacaagatgggtgccatcttgagaaaggagctcatgaagctgccatctgatgttgtgactgctgtgagagggaaagggttgctaaatgccatcgtcatccgagaaaccaaagattgtgacgcttggaaggtgtgcctgcgactccgagataatgggcttctggccaagccaacccatggtgatatcatccggcttgcccctccacttgtgatcaaagaggatgagatccgggagtcagtggagatcatcaacaagaccatcttgtccttctgagagtaggaactctggggagccatcttcagatggggctcttgtgaaactctgcttgggatgggcagattcggcttgtctgtctcctaaaagacaattttttgaatatgtattatatatttcagttgatgcatagtggagtgacacctaggaacctgcaggtggctgcgtgacacaagagtgagagcgagaggcatctctttgttaaagtttgactgtgtgggagctttctaaggagaaacagatctatctgcatacagcctgcagagtcctgccgtaatttacatgtgtctttacatcttccttgctggcatgaatgttttgtatttggaagtttttttctgagatactacataagaaactgttgaatcattataatcaatgaatggtaagatgattgagggttgagcatatgtaaaatactagtttaaagtacactttgcattggccaacagcagaatgtattatatagtttctgagaattcattaccaaattatactttaagtgcttgattgcaatttgtaaaacatttattttcagtatttctttgaataaagcttcatttttctttataccccaaaagagtattttgtatttatcttttggtaataatcagtgtattatttcacccctatgactggcatttcatcccctattgagatcactgggtgtgtttcaggctttttattctaaataaagctatgaccagttcatatctgtacagaaaaaaaaaaaaaaaaaaaaaaaaaaaaaa

SEQ ID NO: 42 - DNA, 2912 bp, Rattus norvegicus
aagctgaatcgaattcggcacgaggcagggtcccgcccgggcttgggggcggtccaggcagccagcatcctcgcgccgcccatgcgccacgccctccggccctccctggctccatattgcaggaaagcgggctagggtgtgacgctgctttctggttcagaatgtcatacccaggctaccccccgacaggctacccacctttccctggatatcctcctgcaggtcaggagtcctctttccccacttcgggtcagtatccgtaccctagtggctttccaccaatgggaggaggtgcttacccaccagctccaagtggtggctacccaggagctggaggctacccctcacctggaggttatccagcccctgggggctatcctggaaccctaaatccagggggtcctccatcctatcctggaggtcaaggctttggggccccacctggtggggcaggcttttctggctatccacagccacctgcacagtcttacggcggtggaccagcccaggttccagtcccaggtggctttcctggagggcagatgccatctcagtaccccggaggacagtctccctaccctggccagcctgctgcgatgactcagggcacccaaggaacaatccgcccagccttcaacttcgatgctatgagagatgcagagattctccgcaaggcaatgaaggggtttgggactgatgagcaagcgattgtggatgtcgtgtctaaccgttccaatgaccagaggcaacaaattaaagcagcttttaagaccatgtatggcaaggatttaattaaagatctcaagtcagagttgagtggaaacatggaagaattaatccttgccctgttcatgcctcctacatactatgatgcctggagtttgcggaaggcgatacagggagcaggaactcaagagcgtgtgttgatagagattttgtgcacaagaacaaatcaagaaatccgagacattgttagatgctatcaattagaatttggacgcgagctcgagagggacattagatcggatacctcaggacatttcgaacggctcctcgtgtccatgtgccagggaaaccgtgacgagagcccaagtataaaccaccagatggcccaggaagatgcccagcgcctctatcaggctggggaggggaggctagggacagacgaatcctgtttcaacatgatcctcgccacaaggagcttccctcagctgagagccaccatggaggcttattccaggatggctaatcgagatttgctaagcagtgtgagccgggaattttccggatacgttgaaagcggtttgaagaccatattgcagtgcgccctcaaccgccctgccttcttcgccgagcgactctactattccatgaaaggcgctggaacagatgactccaccctggtcaggattgtggtcactcggagtgagattgacctcgttcagataaaacagatgttcacccagatgtatcagaagactctaagcacgatgattgcaagtgacaccagtggagattacaggaagctgctcctggccatcgttggccagtgacggggatttttttccctttaaggaatgaagctcttcagggcctatctttctgagcaatgagacctgcatgcagccacgtcagacaccaactgaccagagtgcttttccactgaggcctgtcagggggtgtgctgcgtttgcacatgttgtcactgccttaattctaatgttagtctctttctttctgtatccaatcagtgtaaaagccatgtcaatgacatagtaatgtaaatttgtaaagcttcactcccactgctttcactttaatccggatttcaaattaaaaaaaaaggattcaaattaatgaaaaattcacagcaatctctaattctgtgtaacgttaaaagaatgagagaatgagaacggtgttcattctcattaaaacatgccgttctggtttgattgcagaaggtgatattcagttcaggaataagcctccgtgactcacatccatggctaaagtttcctggtacaaagggaataaatctgtctcagctagtaatagtgcaggacggaaaggccatgtggtgttcccctaaatacgacagtctatgcaggcaagcttctcggaggttctggaaatgtcacttggtgttcttgagacccctttccatcccaaggccagcagttgtcagccgttagtaacgcaccacactgtgtggtaggagtgccttgaacaccacacagctctgacagtggtgtcctgtacaaggctggccctcgtggtaaccagcatgtccctgagaccatcgagagcttaactggaagcaggggaaagctcctcctcttcctcctccccctcttcttcctcttcctcctccccctcctcttcctcctccctttattttttcttctttccttccttcttcttcctcatttcctcctttttttctcccccatagcccaggtctttgagtaacctgattacttctgtgttcctacccagtccagtgaatgaggaaaaggcaagcccattttacatttaattgccacaaggaaaattacctttaaaagcctcgttttttggtcttttaacaacaaatcttatgtcgtacgagtggtttgcctgcgttacatgcacatgcacccaaccacttgcatgcctattttcctgaggaggccaggagaggttttggaaaccctgaaatggagattatagatgcttgtaaactagccactcagtgctggcatcggaacccaggtcctctgtgtttggtttattagaatagaaaagtgaaaagctatagtctgagctttgattttaagataaatgtttaaacagtctggtctcatgactttacagaaacaataaaattgtataatacttctttaaaaccacaaaaaaaaaaaaaaaaaaaa

SEQ ID NO: 43 - DNA, 2175 bp, Rattus norvegicus
ctctgaagcaaagagggtgtagcctaaaagatgagaacgttgggtcttctgtacctgttgacagcccttcctggtatcctgtctgaggtgcagcttcaggagtcaggacctggccttgtgaaaccctcacagtcactctccctcacctgttctgtcactggttactccatcactagtaattactggggctggatccggaagttcccaggaaataaaatggagtggattggacacataagctacagtggtagcactagctacaacccatctctcaaaagtcgaatctccattactagagacacatcgaagaatcagttcttcctgcagttgaactctgtaactactgaggacacagccacatattactgtgcaagatgtcacggaggtcccctaactgggcggtactttgattactggggccaaggagtcatggtcacagtctcctcagagagtcagtcctccccaactgtcttccccctcgtctcctgcgagagccccctgtctgatgagaatttggtggccatgggctgcctggcccgggacttcctgcccagctccatttccttctcctggaactaccagaacaacactgaagtcatgcagggtgtcagaaccttcccaacactgaggacaggggacaaatacacagctacctcgcaggtgttactgtccgccaaaaatgtccttgaaggttcagatgaatacttggtatgcaaaatccaccatggcaacaaaaacaaagatctgcatgtgccgattccagctgtcgttgagatgaaccccaatgtgagtgtgttcattccaccacgtgatgccttctctggccctgcaccccgcaagtccagactcatctgcgaggccaccaacttcagtcccaaacagatcacagtatcctggctacaggatgggaagcctgtgaaatctggcttcaccacagagccagtgactgtcgaggccaaaggatccagaccccaaacctacaaggtcataagcacactgaccatcactgaaagcgactggctgaacctgaatgtgttcacctgccgcgtggatcacaggggtctcaccttctggaagaacgtgtcctccacatgcgctgccagtccatctacagacatcctagccttccccatccccccctcctttgctgacatcttcctcaccaagtctgctaagctgtcctgtctggtcacaaacctggcaacctatgacaccctgaatatctcctggtcttccaaaagtggtgaaccactggagaccaacactaaaatcatggaaagtcaccccaatggcaccttcagtgctgtgggtgtggctagtgtttgtatggaagactgggataacaggaaggaatttgtatgcactgtgactcacagggacctgccttcaccacagaaaaaattcatctcaaaacccaatgaggtggccaaacatccacctgctgtgtacctgctgccgccagcccgtgaacaactgatcctgagggagtcggccacagtcacctgcctggtgaagggtttctctcctgcagacatctttgtacagtggcttcagagagggcaacccttgtcctcagacaagtatgtgaccagtgccccaatgccagagcctggggctccaggcctgtacttcacccacagcatcctgactgtgacagaggaggaatggaactccggagagacctacacctgtgttgtaggccacgaggccctgccacacatggtgaccgagaggaccgtggacaagtccactgagggggaggtgaatgctgaggaggaaggctttgagaacctatggaccaccgcctctaccttcatcgtcctcttcctcttgagcctcttctacagcaccactgtcaccctgttcaaggtgaaatgactctcagcatggaaggacatcagagagcaagagaccctcccacagggacactacctctgggcctggggttcctgcctgtatgactagtaaacttattcccacatctttcctgtgttgccctccagctttgatctctgagacgggcttctttctagactggccaaagactttgtccacttgtgcaacctggaacaatgtctggaaccacagacagctgtgctgtatacaaatgtcactttgaaataaatacttcaccttgcgaacccaaaaaaaaaaaaaaaaaaaaaaaaaaaaaaa

SEQ ID NO: 44 - DNA, 494 bp, Rattus norvegicus
gaatttattaacatctttaatgttagaaaccagttatttctgggtgattataaaagcagaatatattaccacaaatacatatttaaagccaattctagcttttgtaagattctatatcataatccatttattataaattacatcttttaacactataacagctctctgaagttacattagttgtggctgagcagaaagagaaaaacctactcagttttcaaaagagctaggcagcctggaacttgacaacatacttaaaataaagagctaaaatgtgctaaaaatagttcatttcatggcgaggaacagaacatataagctctgtgtaagaaagtaaaaagaaaaaaatatctgtgatacctggccttgttgttgccaaggacaccagagagggagaggcttaaacaatatattagcaatggttcatatgtgaattgttcatttttcatccttaaatctttaaaatgatgtaataaatgacatatcatgtgctg

SEQ ID NO: 45 - DNA, 2132 bp, Rattus norvegicus
ctgcgttctggattttacacggggctcaggaaacagctttacctgtcagagacagagctcacgtcctttgcaggaagtgcacagcctctggtatggcagacttttctctccagcagaactaaaggacacttctctgtgaagggagcctctgatacattgcctatagcaagaagaaggggccaacctgaagaaaaacatgccatctgcacttgctttcgtcctacttgttctcaacatcagcctcctgaagggacagtcaccaccagggaaacctgagatccacaaatgtcgctctcctgacaaggaaacattcacctgctggtggaatcctgggacagatggaggacttcctaccaattattcactgacttacagcaaagaaggagagaaaaccacctacgaatgtccagactacaaaaccagtggccccaactcctgcttctttagcaagcagtacacttccatctggaaaatatatatcatcacagtaaatgccacgaaccaaatgggaagcagttcctcggatccactttatgtggatgtgacttacatcgttgagccagagcctcctcggaacctgacattagaagtaaaacagctaaaagacaaaaaaacatatctgtgggtaaaatggtccccacccaccataactgatgtgaaaactggttggtttacaatggaatatgaaattcgattaaagcctgaagaagcagaagagtgggagatccattttacaggtcatcaaacacagtttaaagtttttgacctatatccagggcaaaagtatcttgtccagactcgctgcaagccagaccatggatactggagtagatggagccaggagagttccgttgaaatgccaaatgacttcaccttgaaggacacaaccgtgtggatcattgtggccattctctctgctgtcatctgtttgattatggtctgggcagtggctttgaagggctatagcatgatgacctgcatctttccaccagttcctgggccaaaaataaaaggatttgatacccatctgctggagaagggcaagtctgaagagctgctgagtgccttggggtgccaagactttccccctacttctgactgtgaggacttgctggtggagttcttagaagttgatgacaatgaggacgagcggctaatgccatcccattccaaagagtatccaggtcaaggtgttaagcccacacacctagatcccgacagtgactctggtcacggaagctatgacagccattctcttttatctgaaaagtgtgaggaaccccaggcctacccccctactttgcacatccctgagatcactgagaagccagagaatcctgaagcaaatattcctcccaccgtggacccccaaagcaccaaccccaattttcatgtagatgcacccaaatcttcaacatggccattactgcctggccaacacatgcccagatctccttaccacagtgttgctgatgtgtgcaagctagccggaagtcctgtgaatacactggactctttcttggacaaagcagaggaaaatgttctaaagttgtctaaagcccttgagactggagaggaagaagtggctaagcaaaaaggggcaaaaagcttcccttctgacaaacaaaacacaccttggccgctgctccaggagaaaagccccactgtctatgttaaacccccagattatgtggagattcacaaagtcaacaaagatggagtgctatcattattccccaagcagagagaaaacaaccagacagagaagcctggggttcctgaaaccagtaaggagtatgccaaggtgtctggcattatggataacaatatcctcgtattagtgccagactcacgagcccagaacacagcgttgctcgaggaatcagccaagaaggctccaccatcgtttgaagctgaccaatctgagaaagatctggccagcttcactgcaacctcaagcaaccgcagactccaactgggtaggctggattacctggatcctacgtgcttcatgcactcctttcactgatagctagacttatggaacgattggctaaactgtgatttctcttcaggtaacactacagagtcatgaagtaatgtggtctgctagcaaatgttacaggatgtgg

SEQ ID NO: 46 - DNA, 546 bp, Rattus norvegicus
ctatgggcgaattgggccgacgtcgcatgctcccggccgccatggcggccgcgggaattcgatttcgagcggccgcccgggcaggtacaagctttttttttttttttttttttttttttttttttttttctttcttcctcccttcctttcattccttcccttcattccttcccttgttcctcatttctttctttaaggtgatctatctttctaccatggatcacctttcttaagcgtgatctacatcgacgacctcccgctgacaattacagtgtcaacctcccaagactcacgcatagcactagttctccatgtttccctgcttcacaaatgacatcatcctgagaggagaacattttgcttccagactactctcagagatactccaaaaaggatttaaatcttaacactctcaagccacttggcaactagacaagtttgaacagatatgttaatgttagagtgtagaggatctaattaaaatataaaatgcacatctttttaagagtagaaagtagatgcccttggacttttcactactcccag

SEQ ID NO: 47 - DNA, 869 bp, Rattus norvegicus
gtcatgcagcactgatgtcagtgatgttaacacttttgttcccttcgggatgaggtagttcctgaatttaatgtcacaggtcactgcatggggcaggttggtcgggacaaagttaatgaatctctgtacctcatgaatcatggcatctgtgtagggcatgtgttttctatcctgcatgcaggggctgcgatgtctgccaatcacacggtcaatctcttcctggactttagctgtgacatgtgggtacttcatcagaagcaggagagcatatctcaatgttgtgctcattgtcgctgtccctgcaccaatgagatccatgatactgcatgtcagattttcatgtgaatattctgattgttcgatgttgtttgcctgtttttgtttaatcaggtaataatcaacaaaatcacgagggtttgtaacatccaatgattcctggtgttcttctattttcttcaacaaatagcttttcatataattaatattttttgctattttgtgatgagttccaggaaaatagtcaatgagtgaaggaaaactattgcagacctgcatccatggggagctcataatcttgagattctcattcactttttccatgaacgtaagcattttccttatctttataatcaaaatgattctggaaaagtaatggagcagatgacattgcatggagcacagttcaggatcaaaggagcgggtcacagggtgaagccttgtgttttcctcagtttcttccactaggcaactgtgcttcctcttgaaccacggtcctcaatgtcctttttccaattccccaaattcccgaaggtcatgattgtggatcgtctcatctctttccatctgtttcattgtaaaaaaatggcaaa

SEQ ID NO: 48 - DNA, 3489 bp, Rattus norvegicus
ggcgcgctgggcgtactgtcgcgcgcagagaggcggcacacgtgtctcccggtgtgggttctgagtttcaccctacccttcaggatcgagagattggcgtggcccccagaccccttttggtgtacgctcaccctggcctgtgtgaacgtgatcctcgcagttccctgcgctcagggagccaacttggtcaagcaactgtcccgggagcggcgcgcgggggggtaccgggcactgcgcatgcggagctccaaattcaaacagctgtgtccagggctgcaggacgggtgaacccggagctgctggaattaggggactctttctcctggaggtggcctttccagagccatggtggaccggggtcccttactcacctcggccatcatattctacctggccatcggggcggcgatcttcgaagtgctggaggagccacactggaaggaggccaagaaaaactactatacacagaaactgcatctactcaaggagtttccgtgcctgagtcaggagggcctggacaagatcctacaggtggtgtctgatgctgcggatcagggcgtggccatcaccgggaaccagactttcaacaactggaactggcccaatgcgatgattttcgcagccacagtcatcaccaccatcggttatggtaatgtggctcccaagaccccagctgggcgcctcttctgtgtcttctatggcctgttcggggtgccactgtgcctgacatggatcagtgccctgggcaagttcttcgggggacgtgccaagaggctgggccagtttcttacaaggagaggagtgagcctgaggaaggctcagatcacatgtacggccatcttcatcgtgtggggcgtcctggtccacctggtgatcccgcccttcgtgttcatggtgacggaagagtggaactacattgagggcctctactattccttcatcaccatctccaccattggctttggggactttgtggccggtgtgaaccccagtgccaactaccacgccctctaccgctactttgtagagctttggatctacctggggctggcttggctgtccctctttgtcaactggaaggtgagcatgtttgtggaagtacacaaagccatcaagaagaggaggaggcggcggaaggaatccttcgagagctccccacactcccggaaggccctgcagatggccggaagtacggcttccaaggacgtcaacatcttcagcttcctatccaaaaaggaggagacctataatgacctcatcaaacagattgggaagaaggcaatgaaaacaagtgggggtggggagagggtcccaggacccggacacgggctgggagctcaaggcggggatggcttacccagcatccctgcatccctggcacctttggtggtctattccaagaatcgagtgcccagtttggaagaggtatctcagactctaagaaacaaaggacacgtgtcaaggccacttggtgaggacgctgcggcacagacccccaaggaaggttacccaacctccgaagtgtttattaaccaactggaccgtatcagcgaggagggtgagccgtgggaagccctggactaccacccgctcattttccaaaacgccaacatcacctttgagaacgaagaaaccggcctctctgatgaggagacctctaagtcttccgtggaggacaacctgacctcaaaggagcagcctcagccggggcccatgactgaggtgccctcgagcagcacgggtgaattcccttcatcggatgagtccaccttcaccagcactgagtcagagctctctgtgccttatgagaagctgatgaacgagtacaacaaggcagacagccccaggggcacgtgaggcgggcctggctcccagctgctttccagtggcttcctctcacaagggatgtcctacgatggccagaccctggggagaaggctctggaaatgagatgaggagccagggacctgcctttccttctgtcctctccagttggttgcttccatgggatgcagtgttggcccaggacaggcctccattctgtggcccagtgaggaggctgctgtcctgggccttcccggctggagtatctgctgactcagaggcctacatgtagacctcaacactcaccctggaggtcctgtgtttgctgctgaagccttcccccatcgttcggttgactgtcttacggttctctgaggccaagagcctcagctgagttcaccagtgttaatgggcaaagcccttgtgcccggcactaaactagacatctggaaggaggaggaggaggagcttgtaagacccaaggggttagcatgcggttctcgggtgttctgggaaggcacagacatgatgggggtttggggcaccttagtaccccagcagtagcagggcctacttgcccacctgttcatcacctcccagcaagccccttactgcaaacctcagggcaggggccgtgggagaggggacatgtgtatctcgtatgtggagccacgctcacctcggatcccctctgaagagcaacagcaggccaaaggtctcctaggccctgaaagtgcaggagaaagatagaagctccgggtgtggtcagagagctcagtaatgaggtgcaggcccctccgccccagcctaggcgcccacactcccagcccaccgtctcattttgtagagatccctcactgccccccccccccgcccctccactttaacggggcctgtagagtgaggccaaactgctctcggctcacggaactgtgaattgagcccctcccctgcctccagccactgtgtggtgtgagcatgcgcaggtgccagtgggcatgtgtgcgtgcgcatcctggctggggagaaaggaaaatgtgaatcttactggtccagctcctagcggctgggaactagctgccgtataagtgcttgatgctcagccttcaaccagcccactctggcctaaatgctttttttgttattaatatttttttaacgaactgtcttttttttttttttatacccagagccagtaaagaacagggtccctgccgttgggatggaggtctgtctgtcgggcactctgttgtcctcccaactcagcttgtcctttgtctagcgagggagagagagacagccgcaggtctcaggtgtggggcaggagatatggagttcccagctcagctgattacctgcctcagcccctccccttgccctgttcgtttgccaaggggcgtaatagggccagagcccccacgttatgacagtgagaggtgtgtgtccatacgtccgccatcctcaaagcggttgcataggccacaccggcctcggggtgggagaaagagcctggctcctgtgagatgtcctaagctgaatgtcccggagccatagtaaccacactgtatgcatgtactggtggtgaagacaggtgtaatttattttaacatttttttttacaataaaacacatgaacaagcaaaaaaaaaaaaaaaaaaaaaaaaa

SEQ ID NO: 49 - DNA, 2644 bp, Rattus norvegicus
ctagcctgtggtcctgtccccgcccgagcaggtggctcgcccctcccctgggcaggtacacactgctggagaggtggcccgtctgcgccctcctcctggccttatatgaggctccactcggacacccgggcatggagtacactgctcgacctcagctatggagttggatgagctgtgcctgctcgacatgctggtctacttggaaggtttcatggccttcgtgtccattgtggggctccggtcggttggctctccgtacggccgctactcgccgcagtggcccggcatccgagtgcccgcgcgacctgcctggttcatacaggagctgccctcgatggcctggccgctgtacgagtacattcgtcctgcagccgcgcgactgggcaacctgcctaaccgcgtcctgctggctatgtttctgatccactacgtgcaaaggacgctggttttcccggttctgatcaggggagggaagcccaccctcctggtcacctttgtcttggccttcctgttctgcaccttcaacggctatgtacagagcagatacttgagccagtttgcggtttatgctgaagactgggtgacccatccctgtttcctgacaggctttgccctgtggttagtgggcatggtgataaatatccactcagaccacatcctgaggaatctgagaaaaccaggggaaactggatacaagatacccaggggaggcctgtttgaatacgtatctgcagccaactattttggggagctcgtggagtggtgtggctttgcactggccagctggtccctccagggtgtagtgtttgcactgttcacactcagcacactgctcaccagagcgaagcagcaccatcagtggtaccatgagaagtttgaagattaccccaagtcaagaaaaatactgattccatttgtgctttagtgctctgttagcgctgttgcctcccatgagctgagtctgtctgtctccctggtgactttgctctgagcacttacgaatgaattgttttccttaattctcctgcagcccctttctcaggaaaggctgggggtgggggggtgtcgtcccctggtaaaggacaaagccaatgataaactaatccaccacatgcagttaggggctacactgcctgctggatccgaagcaggtagccctgagtcattatggcgctctctgacttcagcaatcagcagcccttacaatcctgcaaggattccacccaagtcagcagcagtcacgggcctccttcactgatgtgtgttctgcctgctcagcccctgccacagaggcctggaggtgtgggagtgtggcctaagcacagtctgccatccttgaccgcagacctcttggacccacccccactccctccagacactggtaagagaagccttcctgcaacatgtcctgtcctcaggaggtgagacagcagagtgcttccattcactcgatgaccccatttttgctcttcctttgggctagaattcattaaggtccttaaaaacaaaacaaaactttttcttaatagtacaaaacaaaatatcaaaacaaaatttgttattttgaatgcacccaaggaccaatcatgtcacacaaagaaagctcagggctagcctgggctgtgtagggagaccctgtttgggaaaaaaaaaatgaagataacaaccagctaactgtccaaagaagtgaccgcagtaataaaagacgccgcccacacaggcaccagcttgggagaaagatgtgcgcctgggattgtaaacccactgttgctctgggcaggctgaggcccactggtgaagagccattcccacccgacccatgcacactgcctcggggcagcgtctgcactcacctctcacccgctgccaccacagctaaagaacagaacggatagaactgtgtgctctgaacccagtgaagatgccgcatgaagacctgcaggcacacctgatggcgtgcacggtgcccaccactcgcctgactcggaccatctctgtgtgcccgttgccacctctgtgtgccctttccagctggctttcccatcagggcttcctcagctcttctgctctcagacagaaactattctctgttcctctggttcgcagaatgtctagatttgacccagaaaacttcatgacacagctacttcattttaacaaagagcagtgtttaatggggaactacccttcaatcctttaccctccccttttctggccaagtaactgcttgaaaacctaaagcactaaacattgtaggtctcctctcaaaacctcaggcctgtctggtgtgttctgaaacgtttgtgtggaaggagatattcagctgagaccctgggaatgtttgctgtgaacttgacctcccttggagggcatggtgctagataaacttggaacctaggactccaggttgctaggcagatgccctgacactaagccacatcacacattagctctgtgatgcctctttctttatgaaggaccaagctgcccacatactaagtgagattaatttaagaggaaccctgtcctaacactgtatacttcattccctacaactcaacttacttgtatgaaccatgattgttaaggaaattaataaactacatttataagtacaaaaaaaaaaaaaaaaaaaaaaaaaaaa

SEQ ID NO: 50 - DNA, 869 bp, Rattus norvegicus; identical to SEQ ID NO: 47

SEQ ID NO: 51 - DNA, 3070 bp, Rattus norvegicus
ctcgagggaagttgtagacgcgccctgcgctctgcgctgccttcatctctgctctgaggaagcggcggggtccggggtcctgtctggccatggacacggcctcctccccgcccaatgctgagaggaagcgcgcgggttggggccgcctgctaggcgcccggcggggaagcgcgggactagcaaagaagtgtcccttttcactggagctggccgaaggtggcccgacgggaggcacggtctacgcgcccatcgcaccaaccggagctccagggctcgcgccccccatgtcaccccctgtgtcgcccgtcccggcccctgcagacctcggcccacgtccgcgggtgagccttgacccgcgcgtctccatctacagtacgcgtcgcccgctgctggcgcgcacccacatccagggccgcgtctacaacttcctcgagcgccccacgggttggaagtgtttcgtgtaccacttcaccgtcttcctcattgttctggtctgcctcatcttcagtgtcctgtccactattgagcagtatgccgctctggccaccgggaccctcttctggatggagattgtccttgtggtgttctttgggacagagtatgtggtccgtctctggtctgcaggctgccgcagcaagtacgtgggcatctggggccggctacgctttgcccggaagcccatttccatcatcgacctcatcgtggttgtagcctctatggttgtcctctgtgtgggttccaaagggcaagtgttcgccacatcagctatcaggggtatccgcttccttcagatcctgcggatgctgcatgttgatcgccagggaggtacctggaggctcctgggctctgtagtcttcattcaccgccaggagctgatcaccaccctgtacattggctttctgggtctcatcttctcctcctactttgtctacctggctgagaaagatgcagtgaatgagtccggccgcatcgagtttggcagctacgcagatgctctgtggtggggagtggtcacagtcaccaccattggctacggggataaggtaccccagacatgggttgggaagaccatcgcctcctgtttctctgtcttcgccatatccttctttgcactcccagcgggcatacttggctctgggtttgcactgaaggtccagcagaagcagaggcagaaacacttcaaccggcagatcccagccgcagcctcactcatccagactgcatggaggtgctatgctgcggagaatcctgactcatccacttggaagatctatgtccggaagcctgctcggagccacactttgctctcccccagccccaagcctaaaaagtctgtcatggtaaagaagaagaagttcaagctggataaggataacgggctgagtcctggagagaagatattcaatgtccctcacatcacttgtgatcccccagaggatcggaggccagaccatttctccattgatggctacgacagctcagtaaggaagagccctacactgctggaagtaagcacaccccatttcttgagaacaaacagctttgctgaggacctggacctggaaggggagaccctgctgacccccatcacccatgtgtcacagctgcgggatcaccatcgggccaccatcaaggtcatcaggcgcatgcagtactttgtagccaagaagaaattccagcaagcacggaagccctacgatgtgcgagatgtcatcgagcagtactcccagggccacctcaaccttatggtgcgcattaaagaactacagagaaggctggatcagtccatcgggaagccatctttgttcatccccatctcagaaaagagcaaagaccgtggcagcaacaccatcggtgcccgtttgaacagggtggaagacaaggtgacacaactggaccagagactggtgatcatcacagacatgctccaccaactgctgtccctgcaacaaggtggtccaacctgcaacaacaggtcacaagtcgtagccagtgatgaacgtggctccatcaaccctgagctcttcctgcccagcaacagcctgcccacctatgaacagctgactgtgccccagacaggccctgatgaaggctcctgaaggagctcagaagggaggttcagggtaaccttccacaggtctgccccacctccctctcaacaggggcacctgcctggttctcaccctcttgaaggcctgatatgacagcctagctccctaaagccccaaaacccatgggtcaagccactggcctgaatctggagctcaccaagacccctctgcccagtcagtgggaactagaacttggctgagcatggggttcctctcaggcccctatcaagatggtgatgttattctcctgatggctggggacatacggatggggagtgtctgaccaggatgcaactcaggcagaaggaagcccatccaggtgatgccaaatggcttcctaaagggaaacaggaagaatctgaaagagtctggggtttccaccctcaactctgaatccagagcccagcagggagcaggcagggcaagacaggcccagcccacactaactacaagctgtagcccagtgggggctcaacaggccaaagtctgactccttcactctctagtgatgttgaccacttccgaataccagagggatttccagcttcccccaaaggatatcccaggcaggggaccattcactgtccaccctaaccaggtatggactgacaacttctcccctaaagtgaagagcagggccctcaagccctgtgataagcccttcgtgcagcctgcctcctccttgctggtcagaggtgccggagagatgttcagactccagtctcttcacgccacatccctcagccagcaggtgagccacagcaaggttaagggcatcgcggtttctcccaggatcggttccttgggcatcacacctcccagaaatcaagataatttctggtgattcagactctgtgttttaatgaatttcatagtatgatcttgattgagaggcttttgcaaataaagctgggacatgccaggttaaaaaaaaaaaaaaaaaaaaaaaaaaactcgag

SEQ ID NO: 52 - DNA, 2438 bp, Rattus norvegicus
atgataaaagctctaagctacctgatcagagctgtgtcactaaagagaaactcaatggatctggtcatgttgctggtgctcactctctcctgtctcattctcctgtctatctggagacagagttctgggagaggaaagcatcctcaggccctactcctctcccaattattggcaatttctttcatctagatttgaataacatcacccaatccttaaccagtttctcaaaagtgaatggctctgtgttcactctgtactttggcatgaagctcattgtgatattgcatggatatgcagcaacaaaagaaggcttgattgatcacggagaggagtttactaaaagaggaagcttcccagtagctgaaaaaattaataaaggccttggaattgcttttagccatggaaatagatggaaagaaataagacgctttacactcatgaccttgcagaatttgggtatggggaaagagagcattgaggaccgtgttcaagaggaaacacagtgccttgtgtaggaactgaggaaaaccaatggctcaccctgtgaccctaccttcatcttgggctgtgctccttgcaatgtcatctgctccattattttccagaattgttttgattataaagatcaagattttcttagcttgatggaaaaactcaatgagaacatcaagattgtgagcagtccctggatatagttctgcagttctttccctgttttcattgattattgtctgggaagtcatatgacattagctaaaaaatgtgtatcatactagaaactacattctgaagaaaataaaagaacatcaagaatcactggatgttacaaatcctcatgactttattgattatgacctaattaagtggaagcagttctcaaaagtgtatggtcctgtatttactctttactttggcctgaagcccactgtgatattgcatggatatgaagcagtaaaagaagctttgattgatcatggggaggagtttgctgaaagaggaagcttcccagtagttgaaaaaattaataaagaccttggaattgcttttagccatggaaatagatggaaagaaatacgacgctttaccctcacaactctgcggaatttgggcatggggaaaaggaacattgaggatcatgttcaagaggaagcacggtgccttgtggaggaactgaggaaaaccaatggctcaccctgtgaccccacgtttatcctgggctgtgctccttgcaatgtcatctgctccattattttccagaatcgttttgattataaagatcaggattttcttaacttgatggaaaaactcaatgagaacatgaaggttttgagcagtccctggacacagttttgcagttttttccctgttttaattgattattgtccgggaagtcatacgacattagctaaaaatatatattatattagaaactaccttctgaagaaaataaaagaacatcaagaatcactggatgttacaaatcctcgggactttattgattattacctaattaagtggaagcaggaaagtcacaatccacatttggaatttacacttgagaacttatcagtcactgtgactgatttgtttggtgctgggacagagacaacaagcacaacactgagatatgctctcctgctcctgctgaagtatccagaagtcacagctaaagtccaggaagagattgatcgtgtggttggcaaacatcgcagcccttgcatgcaggacaggagccgcatgccctacacagatgccatgattcatgaggttcagaggttcattgacctcattcctaccaacctgccacatgcggtgacctgtgacattaagttcaggaactacctaatacccaagggaacaacaataataacatcactctcatcagtgctgcatgacagcaaggaattccccgacccagagatatttgaccctggccactttttagatgggaatggaaagtttaagaaaagtgactatttcatgcctttctcagcaggaaaacggatgtgtgcaggagagggcctagcccgcatggagttatttttattcctgaccacaattttacagaactttaagctgaaatctgtacttcaaccaaaggatattgatacaactccagttttccatggatttgcctctctaccaccattttatgagctgtgcttcattcctctctaaagagatcaaattgcctggctcctgatgtgttgtattttctcccttcaaataactcctatattcttcaagattcaagaaatatccatattgcattttccagtttctggagtcactgctcacatatatctgcacttccctattctctgtaacagtctccccatctcatgtacctatgtagatctaaatttgagttcttactgtggtttagctgtagcactggtaattcacaaaaatttatcttctttatgttctcaaaaata

SEQ ID NO: 53 - DNA, 1720 bp, Rattus norvegicus
ggagtgctgtcgcccgtgcgcctcctagcagctgccagaatgccaaactggggaggaggcaagaaatgcggggtgtgccagaagacagtctactttgctgaggaggtccagtgcgagggcaacagcttccacaaatcctgcttcctgtgcatggtttgcaagaagaatctggacagcaccactgtggcagtgcatggagaagagatctattgcaagtcatgttatggcaagaagtatggaccaaaaggctacggctacgggcagggtgcaggcacgctgagcatggacaagggggagtctctgggcatcaagcatgaggaagcccccggacacaggcctaccaccaaccccaatgcatccaagtttgctcagaagatcggcggctctgagcgctgtccgcgatgcagccaggcagtctatgcagcggagaaggtgatcggtgccgggaagtcctggcataagtcctgcttccgatgtgccaaatgtggcaaaggcctcgagtcgaccaccctggcagacaaggatggtgagatctattgcaaaggatgctatgccaaaaactttgggcccaaaggttttggctttggacaaggagctggcgccttggtccattcagagtgaggctgccgcctgcgtaccctgcctactcctgcactctcataagcagtccgttcctggaagccatggacacctccaagatcctctctctcactcagccctgctgcacatcactaatgccttggacttgggtgttctttggcttaggggtctgcctgagttccttccccactaagggcttcctcctgcctggcattcgatacccttatctttaggagacatctgtctagtcaccccttcccagataccaggtccctctccccacaccttacccctacagacctctgtggccaggacactctctactggccaggacacctgaccccacatctttggagcccaaaagagcaaggcggaagacctgcgctagggaaggctgtggtttattgtatcccagagtctctctctgggtaggatgctgagcttcttggtgcctctcagtctgggaagtccccgtgagaggcagagaggtgcggataggattgtggggtcatcagaaggagcttgttctctgacctcttgcctttgaatgtggaaataataacttttcacttagggatgaagaagaacgcaggtcagaggaccccaaaatctagaggttgcctgacctcaagttccctgttccatgggcaagggagagcctaatgaataccttgaacaagcattgacatggatcagtggtccagatcttagagtggtcagttctggttctaagcttgggtctggtggctgggatggacagcttctgttgcagcatagcccagggtagagctgtgttctagccactcctgagggtcctccgaaccccagtcctcctctccaacccagacccttcgttcaccccacctttctctagtaaaccttcgctcccttgcccatcccttccaggccccaaggtcaggagcagagggagggaggggaagagctgggccttaatgctcctggggatggggacggggacagaagggacaaggctgtgtacagctatttgctgcaagggctgtaggcatgggctgttgaagctgatttatcatctgatcaataaagcaatttagaactgaaaaaaaaaaaaaaaaaaaaaaaaaaaaaaaaaaaaaaaaaa

SEQ ID NO: 54 - DNA, 2563 bp, Rattus norvegicus
tccagctgttccctcttctcctcgtcctctccacctctgccttcgttcgccatgctctcggtccgcgccccgctcgccaccatcgctgaccagcagcagctgcacttgtcgcccctgaagcgactcagtctggctgacaaggagaacacgcccccaaccctcagcagcgcccgcgtcctggctagcaaggctgcaaggagaatcttccaggactctgccgagctggaaagtaaagcacccactaagcccagcattgaggaagagccgttactgagagaaaatccccgccgtttcgttgtctttcccatcgaataccatgatatctggcagatgtacaagaaagctgaggcctccttttggactgccgaggaggtggacctttccaaggatattcagcactgggaagctctgaaaccagatgagagacattttatatctcatgttctggccttctttgcggcgagtgacggcatagtcaatgagaacttggtggagcgatttagccaagaagttcaagtcacagaggcccgctgtttctatggcttccaaattgccatggagaacatacactccgaaatgtacagtctccttattgacacttacattaaagattccaaagaaagagaatatctcttcaacgccattgagacaatgccttgtgtgaagaagaaggctgactgggccttgcgttggattggggacaaagaggctacgtatggagaacgagttgtggccttcgctgcggtagaaggaatcttcttttctggttcttttgcatcaatattctggctcaagaaacggggactgatgccgggccttacattttccaatgagcttattagcagagatgagggtctgcactgtgactttgcctgcctgatgttcaagcacctggtacacaagccctcggagcagagagtaaaagaaataattaccaactcggtcaggatagagcaggagttcctcacagaggccctgcctgtgaagctcatcgggatgaattgcaccttgatgaagcagtacatcgagtttgtggccgacaggcttatgctggagctgggttttaacaagattttcaaagtagaaaatccatttgacttcatggagaatatttcactagaaggaaaaacaaacttctttgagaagcgagtaggcgagtaccagaggatgggagtaatgtcaaattcgacagaaaattctttcaccttggatgctgacttctaagcaaccgatccgtgtgctctttgctgattattctccccttgtcattaaaagaaatcagcaaaaccaaacaactggctacaccacgaattgtcgttaaatttgctaactggtgtctaaaagccgtgtagctacctcggtcctgcttgctaggtttgccactagaaggaagcatacttaaaacaatggctacttggatcctcagggagatcctgtctgcaagtcgcgtggtcacccttagcttcatcaaagcactaacagctcacccggccaggcttcatgagcactgaccctcaagcaagcaggtttattaaacatttagatgccaacctcacttactgtttcctgcagtcatggagagtttacttaacaagtttgtaaataataaaactggcactttgcacacagacttggtactatcctaggggaaggcctgctttatttggtttctagaccgagtaggaagtgatccatttaccactgagggcagccccattcagagtcttaagtgactaagccagtgttgaacaagcaatttccaggctttgttcttcagggaacttcccatcagctttgaagtcggtcctgtgcaccctaggcacatggatcagttcacaagtggggttcagtggagagaacttccccctcagaagtcacttgaaacttagatgagatttgggacacttgctggttgactctgtctcatttgtgtaaaaagtagtttttttttttttttttttccaagttatactttgtcccattcctagttagtacaaagtcttgaaagggcctttgtagggctttttaagtcagggtcttaactatgtaactctggcttggcctggaacttgctatgtagaccaggttaccctcaaacttgcctgtcttcccaaatactgggattaaggtttctgtgaccatacctggctttacctgattaattcctaaacaccagaaaaccagtactgtatgagatgttaatgtgtgttcctttcagactggagtacagaccagtagataacagataacagctggttcaccttaatctgcctttttgtgtattaatctgtgtttagagaacggaacaatagccagaattcacctagcgagttcgaggccagttggtgtatatgtgggactcttaaccaaaacagcaagcgttccctggggtagttcacaatgatctccagcttccttgttaaccagataactgcaagtcagatgtatgaccctggttggtttattgtattgatatgtttctgtaatatgagtaaattattgttacttaaaagtaataaattcaagtttcaaaattgaaaaaaaaaaaaaaaaaaaaaaaaaa

SEQ ID NO: 55 - DNA, 2176 bp, Rattus norvegicus
ctttccgtcccaagcaccgagcggagcgcagcacccccgcgccggcggtatggcgctgtcctggaggagctggctggccaacgaaggggttaaacacctctgtctgcttgtttggctgtccctaaatgtcctgcttttctggaaaaccttcctgctgtacaaccaagggccagaatactactacatccaccagatgttgggcctaggattgtgtttgagcagagcttctgcatctgtcctgaacctcaactgcagcctgatccttttacccatgtgccgcacagtcctggcttaccttcgcggatcacagaaggtccctagcaggagaacaagaagattgttggacaaaagcaagactctacatatcacctgtggcataactatttgtattttctcaggtgtgcatgtagctgcccacttggtgaacgccctgaacttctcagtgaactatagtgaacatttccttgcactgaatgcagcaagataccagaatgaggatcccagaaagcttctcttcacaactgttccgggcctgacaggtgtctgcatggtggtggtattgttcctcatggttacagcttctacctatgcaataagagtttctaattatgatatcttctggtatactcacaacctcttctttgtcttctacatgctgctgctgctgcatgtttcgggtggcttgttgaagtatcaaaccaatttagacactcaccctcctggctgtatcagtcttaaccggaccccatctcagaatatgtccatagcagactacgtctcagaacattttcatggatctttgcctggagggttttcaaaattagaagatcattaccagaaaacactggtgaagatttgcctggaagaacccaagttccaagctcatttcccacagacctggatttggatttctggacctttgtgcctatactgtgctgagagactttaccgatgcatccggagcaacaaacctgtcaccattatctcagtaatcaatcatccctcagatgtcatggaactccgtatgatcaaagaaaactttaaagcaagacctggccagtatattattctacattgtcccagtgtatcagcattagaaaaccacccatttactctcacaatgtgtcctactgaaaccaaagcaacatttggtgtccactttaaagtagtaggagactggacagaaagattccgagatttactactgcctccatcaagccaagattctgagattctgcccttcattcaatctagaaactaccccaagttatacattgatggcccatttggaagtccatttgaggagtcactgaactatgaagttagtctgtgtgtggctggaggcattggggtcactccgtttgcatcgatactaaacactctactggatgactggaaaccatacaagctaagaagactgtattttatctgggtctgcagagacatccaatcattccagtggtttgcagacttgctctatgtgctgcataacaagttttggcaagaaaacagacctgactttgtgaacatccagctgtacctcagtcaaacagatgggatacagaagataattggagaaaaataccacacattgaattctagactttttattgggcgtcctcggtggaagcttttatttgatgaaatagcaaaatgtaacagagggaaaacagttggagttttctgctgtggacccagttctatttccaagactcttcataatttgagtaaccggaacaactcatatgggacaaaatttgaatacaataaagaatctttcagctaaaaccttaggagactactgggactctaaagaaggaacaagtgcaatttctaagacttagagactcggctgaatcagacagctatgctatgccaaagaatatcaaagttttgctatttatgattatttaaaatgagaattcaaaaagtgtggcaaaaatgacatggttaatctgcaagccaaaggggccctgaagaatatttgatgtggtgattcacatattgatgggcaaattaaaagaatgctgttagatgcacactgttgatttttatgggaaattcaagaactctctaatgaggagctgaactcactcactctgaagctgatagccacagccctctttaaattgttttcagtcgaacaggttcaaagattgaacaaaattaaaaattc

SEQ ID NO: 56 - DNA, 1737 bp, Rattus norvegicus
caagcaaaagcaggagctgtccagcgctgagagacaggaaaggccatggctaaggagtggggttacgccagccacaatggtcctgagcactggcatgaactttatccaattgccaaaggggacaaccagtcacccattgaactgcatactaaagacatcaggcatgatccttctctgcagccttggtcagtatcttatgatcctggctctgctaagaccatcctgaacaatgggaagacctgcagagttgtgtttgatgataccttcgacaggtccatgctgagaggtggccctctctctggaccctaccgacttcgccaattccatcttcactggggctcctcggatgaccatggctctgagcacacagtggatggagtgaagtatgctgctgagcttcacctggttcactggaacccgaagtataacaccttcggagaggctctgaagcagcccgatgggattgctgtggttggcatttttctgaagataggacgggagaaaggcgagttccagattctccttgatgccctggacaaaattaagactaagggcaaggaggctccttttaatcacttcgacccatcgtgcctgttccctgcttgccgggactattggacctaccatggctccttcaccacgccaccctgcgaggagtgcattgtgtggctgctactgaaagagcccatgacagtgagctcagaccagatggccaagctgcgcagcctgttcgccagtgcagagaatgagcccccggtgcctctggtggggaattggcgccctcctcagccgatcaagggcagggtggtgagggcctccttcaagtaaggctctggacgtgccctcttcaggaaaggaattctgtccctgaagagccagcttgcctcctcctggtgctccctgctccaagctatcctacaacactgagagaaagaagagacgcagtcagatgaaaccgcagtgccttttgacatgatctaacccagaagcatgaatttcacacctaacctttttaataactaccttttctaaaaaaattagtatttctagtataaattcagtgaagaagaaatagatggaaaaataacgacagtgacagtggcttattaagcatattaagtttctcagaatctcagcactcctgttttcaggctgagttactgacaagtgatgggtccatgctatgtatgtgggtatggaggcatgtgcccaccttaccacatttgattgaaagcacaagttaagatcactgtagatttcagaaggtgaatacataatgtttacctcaaataataccatcgctactctatcactttttaaaaatttgcctactaccaacttcgcctggttttaaattaccgataaacacacacccataaggccaggtcttttaaattttttgatccagcatttaaatttcttcttcataaagatggttttctttgcccaatctagggtcatttattttttatttcactactttaatctttgcatgcctattaaaaacaaagcaaaacaaacaaacaaaaaaaaaaaaccaaaaaaaaaaaaaaaaaaaaagctgtctctggtgtcttttgagttggaagttggaatgactggttcctgagacaggaaggagggaatgccagcactgaagctgagagtttgtactgatcgcagaagcaataaagacgggatggaaatgaaaaaaaaaaaaaaaaaaaaaaaaaaaaaaaaaaaaaaaaaaaaaaaaaa

SEQ ID NO: 57 - DNA, 626 bp, Rattus norvegicus
  misc_feature (45)..(45): n is a, c, g, or t
cgataatgccattattatttggctttcatgtgattcaccgatccntagtcaagcacactacaacatctagcaccaacgaccacatctnatatttagatacacatattgttcttttatccttggaacactttcttatccctcctacgggcaacgtgcaatgctcctgtagataaaactgtggagacaaataaactacgacatctttgcaatactgtctagatgaaaaggcttttcacaaaacacatatggcaaagaactcataaaaaagaaacttgagttggtccaagcttaatgtgcaatactgacttcttactgattataacgtattcatatgactgactatgagaatccatcagatttcggtaattcaggtcaaacttttaaaaaacaaagatgatatttcagacttgcttgctaggtggagtgaacttccttgcctagtctaaattctggcacatgttcaagcatctgcttgttaaacatggtttatgttagaacaggaataagttaaagctttctcncacatagagaagacagctttcctttgaaagattgtatggtggcagatttttctgtgtaagccctaaaatcgcttaattttgatggcaatanatactaanattaac

SEQ ID NO: 58 - DNA, 1277 bp, Rattus norvegicus
ttagggctcagctcctggaagtggagtgtgtgctggacccgggttcgaaggcaggcggcgagatgaggcgggcgccagcgtttctgagcgccgacgaggtgcaggaccacctccgcagctccagcctcctcatcccgcccctggaggccgcactggccaacttctccaaaggtcccgacggaggggtcatgcaaccggtgcgcaccgtggtgcctgtggccaagcaccgaggcttcttgggagtcatgccagcctacagtgccgctgaggatgcactcaccaccaagttagtcaccttctatgagggccacagcaacaatgctgtcccctcccaccaggcatcagtgcttctctttgatcccagcaatggttccctgctggcggtcatggatggaaatgtcataactgcaaagaggacagcagccgtctctgccatcgccaccaagtttttgaagcccccaggcagtgatgtgctgtgcattcttggggctggggtccaggcgtacagtcactatgagatcttcacagaacagttctccttcaaggaggtgagaatgtggaaccgcaccagggaaaatgctgagaagtttgcaagctcagtgcaaggagatgttcgggtctgttcatcagtgcaggaggctgtgacaggtgccgatgtcatcatcacagtcaccatggcaacggagcccattttatttggtgaatgggtgaagcccggggctcacatcaatgctgttggagccagtagacctgactggcgagaactggatgacgagctcatgaagcaagcagtgctgtatgtggactcccgggaggctgccctaaaggagtcaggagatgttctgttgtcaggggctgacatctttgctgagcttggagaagtggtttcaggagcgaagcctgcatactgtgagaagaccacggtgttcaagtctttggggatggcagtggaggacctggtcgcagccaaattagtgtacgattcgtggtcatctggcaagtgagcagaaggagctgtgcctgagctggatggacgtcacggctcaaacgctggctcagtgtctagatcaaaggaggcctagtccccagtgaacgggagtgagagtcactcataagtattgacatccctattcatgtttgtggttggatagctaaacccttctgttagggggtgatggccacattacctacccttgatcttactagccttgtgtgtctctgaaataaatcatttccagttcttccatgaaaaaaaaaaaaaaaaaaaaaaaaaaaaa

SEQ ID NO: 59 - DNA, 2413 bp, Rattus norvegicus
cttccgggctcgggagccgcgacaggagggggcctctgaaaagggtcctgttctgagaagtccattgtgtaccttgtcaccagcgcgtctgaaccctctctgaaccttcctgaagctggaagatttcaccctgatggctgactcaaaaccactcagaaccctggatggggaccctgtggctgtggaggctttgctccgggacgtgtttgggattgtcgtagatgaggccattcggaaggggaccaatgcctctgagaaggtctgcgaatggaaggagcctgaagagctcaagcagctgctggacttggagctgcagagccagggcgagtctagggagcggatcctggagcgctgccgggctgtgattcattacagtgtcaagactggtcacccccggttcttcaaccagctcttctcaggattagatccccatgctctggccgggcgcatcattacggagagcctcaataccagccagtacacatatgagattgcccccgtgtttgtgctcatggaagaggaggtgctgaagaaactccgtgcccttgtgggctggaacactggggatggggtcttctgtcctggtggttccatctctaacatgtacgccataaacctggcccgctttcagcgctacccagactgcaagcagaggggcctccgggccctgccacccttggccctcttcacttcaaaggagtgccactactccatcaccaagggagctgcttttctgggacttggcaccgacagtgtccgagtggtcaaggctgatgagagagggaagatgatccctgaggatctggagaggcagatcagtctggcagaggctgagggctcggtgccatttctggtcagtgccacctctggtaccaccgtgctaggggcctttgaccccctggatgcaattgccgatgtttgccagcgtcacgggctgtggttacacgtggatgccgcctggggtgggagcgtcctgctgtcccggacacacaggcatctcctggatgggatccagagggctgactccgtggcctggaaccctcacaagcttctcgccgcggggctgcagtgctctgctcttcttctccgggacacctcgaacctgctcaagcgctgccacgggtcccaggccagctacctcttccagcaagacaagttctacaacgtggctctggacaccggagacaaggtggtgcagtgtggccgccgcgtggactgtctgaagctgtggctcatgtggaaggcgcagggtgggcaagggctggagtggcgcatcgaccaggcctttgctctcactcggtacttggtggaggagataaaaaagcgggaaggatttgagttggtcatggagcccgagttcgtcaacgtgtgcttctggtttgtgcctcccagcctgcgggggaagaaggagagcccagattacagccagaggctgtctcaggtggcccctgtgctcaaggagcgcatggtgaagaagggaaccatgatgatcggctaccagccccatgggacccgggccaacttcttccgaatggtggtggccaaccccatactggtccaggccgatatagacttccttctgggcgagctggagcgtctgggccaggacctgtgagctgcttcctctctctgccccacccaagctctgcataagctcctgggttcccaaaagcgacctttctaggaaacagtggccttgactgtgtgagcccccacacactaactctcctagctaagtattggctgccaggacggtgtctaagcacactacagtctgttcttacgaaatgtgcttcttttaagtcggtcatagtggtacacaccgttaataccagcactggggaggcagaggcagacacaagcagatctcttgagtttgacgccagcccggtctacagagctggcctacacagaaaaaaaacctgtcccaaaaaaaaagaaaggaaggaagtaagaaaggaaaagaaagaaatatttttcattaagattatgtctataaaaaattgttattaatatgagagatatggtacgatgtattaagaaagctagatatgggggttggggatttagctcagtggtagagcccttgcctaggaagcgcaaggccctgggttcagtccccagctccgaaaaaaagaaccacaaaaaaaaaaaaaaaaaaaaaaaaaagaaagctagatatgagtttatatatcatggtatctgagttagactaaaaaaaaaaaatacataggaaaaggcggtgagtggaactgtgccaaaggtcagcagttttccctggaggaggataacaggctgttcctaagtcagcctctcagaccttccctgcttccccactttattatgtaaccacatcacctacttctgagatataacaataaagctttgtcactataaaaaaaaaaaaaaaaaa

SEQ ID NO: 60 - DNA, 1753 bp, Rattus norvegicus
acctggcactcctcacttgcctgcacctgggtggagccagagcccagggctacatattttagccctggcaccagcaggctccagagctgtagctgtcttttcctagctatgatgggctttgagttctggatgctggcgttgtgtgccctgctgctgctagtcttggggctgctgagcttcctgtggctggatagtgacctgacactgctgcgggctgcttggatgggccagtgtcctgaacaggcactggctgacaaggtggtgtggattactggagcatcaagcggcattggtgaggagctggctttccagttatctaaactgggggtctgtctggtgctgtcagcccgaagggggcaggagctggagcgggtgaagagaagatgcctggagaatggcaacctaaaagaaaaagacatcctggttttgcctcttgacctggctgacaccagttcccatgacattgctaccaaaactgttctccaggagtttgggagaattgacattctggtcaacaacggtggagtagcccatgcttcccttgttgaaaataccaacatggatatcttcaaggtgctaatagaggtgaactacttagggacagtgtcattgaccaagtgtgttctacctcatatgatggagagaaatcaaggaaagattgttgtcatgaaaagccttgtgggaattgtaccccgccccctttgcagtgggtacgctgccagcaaattagctcttcgggggttttttgatgtacttcgaactgaactttttgactatccaggtataacattgtctatgatttgcccaggacctgtgcattcgaatattttccagaatgcttttactggagacttcacggagaccagactgcctaagattccgctattcaagatggaaacaagccgttgtgtccagctaatccttgtctccctggccaatgatctggaggacatttggatagctaatcagcctgtcttgcttcgggcatatgtgtggcagtatgtgccattccgggactggatacttcaaggacgctatggaaaatatatatcgaaagttttaggaataacatggtataggtgactcacttgtttccagtagtttatgtgcatcttgcatgcaaatatcaagtcttcaaatgctttaggatagcttttgctaacttccagacccagctcacaatataaataccaaaaaatacataggcattattctaacatcacacgtaactgacaacttaccttcaatcgccactggtctaggtgttctagaagttttacattgcaagcaacgttatcttctatacttaatgactgagagagtacatttcagaaaactttcttctctgctccttcccatcatgtcctacctggccttccatcttagctcaggactcactttcttgaagcgaaacttatccacctttctacttctcctggggacaggaatccctatacccttgagtgctccaccttcagaacaacccattaatctaagactattggggaccgggatcggactgtcagactgggcaaagctagagccctgccctgagcagattcctgaccttttcaaagaaagaacatgtccccggaagactgttgcctcattgtctaaggaggatatcttgcggtttaatgattcaccttatgtccttgggcacttcccagtactcccccagccctaagcttctattcctgcttcagagctttaaatgctgtacattccactcaataaacagaccttgacaagg

SEQ ID NO: 61 - DNA, 447 bp, Rattus norvegicus
ttttttttttttttttttaagtgcaagggtaatcatttattgcactgcaagagcaagaaatttgtgcggaatgatcatgagtggggcaaagagaaatttaagaaagcttttaattctcgatgtgttgtcctgggtaactagggaagatgctggagagaccaggattgcacttttctgtgagacaggatggaaatcagatcgcagaatttgtctcaggatgctccatggacaggaaatggtaatgctggagtcctggtgagaagtctccactcagcacggagtaatccaggaagaaagaataaaggaacccattaagcacttcttggattgacttctggacagagaggcactctattgtatagaacaaaggatgaagaaatagatcttgccctgcaatctggaggctcaggcctttcttcaacctcgggcctggagacagcgatcagt

SEQ ID NO: 62 - DNA, 788 bp, Rattus norvegicus
  misc_feature (753)..(753): n is a, c, g, or t
agcgcggtcggtccgattcccgggatcgatacctacagagctcacacacgatgagggtcatcctcctcctgctcacactggatgtgctaggtgtctccagtatgatgacagacaagaatctcaaaaagaagattgaagggaattggagaaccgtttacttagctgccagtagcgtggagaagataaatgaaggctcaccattgaggacctacttccgtcgcattgagtgtgggaagagatgcaaccgaatcaatctctacttttatattaagaaaggggccaagtgccaacagtttaaaatcgtgggaaggagatcccaagacgtttactatgcaaagtatgaagggagcacggcattcatgttaaagacagtgaatgagaagatattgctgtttgattattttaacagaaacagaagaaatgacgttacacgagtggctggagttttggcgaaaggcaggcaactgactaaggatgagatgacagaatacatgaacttcgtggaagaaatgggcattgaggatgagaatgtacaacgtgtcatggacacagacacctgtccaaacaagatcagaattagatgacatcaggaattttccactatattcttcctggaacctgaaacatcaatatgaagatgaagcaatcttttctttcagatcatatcttcctatttgctgcaaattacaattcttgtctccatactttctctttcattcatactttcccatgttctaattggattagtacatncttgaatgtttaantaatctatttcactgcaaaaa

SEQ ID NO: 63 - DNA, 960 bp, Rattus norvegicus
atggacagatccaacgagacttcccttgtgtcctacttcattctcctcggcctctctgcccacccaaggctggagaaaaccttcttcgtgctcatcctgctgatgtacctggtgatcctgctgggcaatggggtccttatcctggtgaccatcctcgactcccacttgcacacgcccatgtacttcttcctggggaacctctccttcctggacatctgctacaccacttcctcaatccccttggtcctggatggttttctcacccccaggaagaccatctccttctcaggctgtgccatgcagatgtttctgtccttcgccatgggagccacagagtgtgtgctcctgggcatgatggcgtttgatcgctatgtggccatctgcaacccccttaggtacccagtggtcatgagcaaggctgcctatgtccccatggccgccggctcctgggcagggggaagcatcactgccacagttcagacatctttagcaatgcggctgccattctgtggggacaacgtcatcaaccacttcacctgtgagatcctggctgtcctgaaactggcctgtgccgacatctccatcaatgtcatcagcatggcggtaggtaatgcagtatttttgggggtcccagtcctgttcatctttgtctcctacatcttcatcctctccaccatcctgaggatcccctctgctgaggggaggaagaaggccttctccacctgctctgcccacctcactgtggtgattgtcttctatgggaccatcctcttcatgtacgggaagcccaaatccaaggacccactgggggcagacaagcaggaccttgcagacaagctcatctccctcttctatggggtgttgacccccatgttgaaccccatcatctacagcctgaggaacaaggacgtgagggccgctgtgaggaaccttctacatcagaaacacttcaagtggtga

SEQ ID NO: 64 - DNA, 1304 bp, Rattus norvegicus
  misc_feature (884)..(884): n is a, c, g, or t
aattcggaacgaggcgagtagccacaggagtaacttgaatagacaataatttttagtttaatgaatatagattttcctctactctatcatgtgctccgtcattcattttacctatgttattttgaaaggtttgtttcaggacctctgtgcgtatgtggcctctcgtatgcagcctgtatgtgagcaccctcagaggtgagatgaggaatgggggccaccaggtacaagaacctttcagccatacaatgtgggtgtcaggaattgaattccatttctccagaagagagatcatccatcaagcaggaactgctcttgatggatgatgtgtttctgcaaatgggtatttaggttttattttatttcaagatgtctcactacatagcaggttttccatgatcttataatctctcgccctactgtcatcctcatcattacacaagttacactgaagtattcccacagcatctctgcatgttgtagcccctgaggatgctggtcaggagcgtggacacatctcagtcctctctggagcatcccaggggaaggggcagcatccaggccagatgtacagacctgacttggtagaggctcaaaagcatccatgatgagcctgaacagtgtgtacagagcaggaagtgccctgtaaagtggtccaaggctgcaggctacatccttggtggaggcccctgtggagtaaatattcaaagctaacagcacccacccacactcttcctggctctggcgggccacatggtatctggaaggtacttttcatcttaatcagcaaagggtgtcagttggactcgctaagttcccagtttccatcccatgctgttgcttgctactctgtggggctgtgcagcgagctcgcctccaaggctggncccacatttccgtgggctgctctctagcctcagcagccgccctcttgtgactctttgctgcgaacattcctgcatccnccctatggggatagtccagctcccaggaagcataaatgaaactcagaaaaaaaaaaaaaaaaagttaccgcgncncagctatcccttaggnggtaatttagctggcctggcgnntttaacgcngacnggaacctgggtacaattatccctgaaaatcccttcncgtgggaaaacaaagccccnaccctccaatgccccngaggnagganncngacgcntaaccgnggggggtcngagggcntantgcgnctngcgtctctttctctncncgtccgttcnnagtaagggnctagncattgtcgcccccaatgtagggnccnggccccnaagttcctntgacct

SEQ ID NO: 65 - DNA, 2205 bp, Rattus norvegicus
gccttaaaggccttggtcttgagagaacagagcaggtgctcacacggaaaaagaaagttacacagagatagcctgggtttggaatcaggcggaccggcttccttcattgggaaaccgaatacaacattatgtccacaccggtggcatcagagaccacacaaaggcttcagaagccaaagaaaggtcaaaagagaaaagtgcctgtgaaagcaatgctagctgtgacagacagaagatcagagatgtcacctgtctccccaaaggtgtcctgcaagcagaatgattcagggaagcaggtgccaggggataaagtttgcttggcacaaaaagctccacaggcgagcagcattctggcttccagtgatgcctctgcaggggatgtcccggagcagagatccaagaggaagagaggccaaagaaaaagaaaactggagaatatcaagacagatccagaagcctgtatcgttcttgcctccagtgatgcctctgcaggggatgtccctgtgcagcgaaccaaaaggaagagggtccacaagacaaagacactggtggatgtcaaagcagctacccaggagaacagcatgcaggcctctagcacagccacccctgaagctgcccctggaactgcctcagagctcaagttcctcaggagggggaagaggaagagcatatggactgtggaccgtatagaggggacaaaactcataatgaacaagaagagaagacccagctatcgccctgaggacctcgaagcattctaccgactcctggaggatcctgtggtccagaacttcttggcagctgacatcttcttcagggtgaccgacaagtatctgctgtctatggtggtggagtactttggtcgcgttgggcttcctggacatctctacaacaggatccacttcttcctggccctttacatcgcctgcgacatggaggaagacgaccccatatccaagaggagcatcttccaattcctgctgggcagggacacctggcaagacttgtacaaggatttcctgaagctgcagagggatttcttccaagccatggattaccgagcctgggtcacaccagagcagtgtgtagagatccagaaccagaacccacaccactgggtctggagccgggtgcgccagggcaccccttagcttcccgggcctgggaaccatctgcagggtcgtggagcatggggctgtgcctgaaccagctcctgtccacccctgccaccccctatccccaacaagaagctagagcttatccccatgatacaggcacccgaagaacccatcatccggccctggttctccttacaccttcaggatgaaggatccaggagagcatgtgccttagctctggggtatagcatgggaccaggaaaggaggaacaagcgaagtcggaagatgaaaatgggcccacctgctgggcaagcaatgtctttggaaattattgtcaatttccaaaatagtccaccaggtcatccaataatggcttatcccacacggtgatggggaaatctccccagggggctgatgggaagcactaagacactgagcataaagacgtggagacctgaggcataatcaaagtaggataggagaaaggggatcacatgaaagtgcaggctactaccactgggggacaacccaacctgcaaaggagagagtcaggaagcagaggtgggtgagggggaaatgaggagatagatccccaacaccgggagcaaagtgttgaaagctgaagagggaagatggactcacagaggacaaggagggccaatcccggggtcacagtggtacttgcagccttgacaagtgcaaacaggattgaaaacaaaagagacaaagacataaatttgggacactattgttttggttatacttcaactcatttttgttataattgcttgtaatttgattataccttttggttataatttttgttattttcactataatttggttagatttgtttcatcgtaaaattttagttttggttatatttggtgttttatgatattttggtaatagtacttctgtttaatcatcttgcttataatgttcctattatatttatgccattttcatattatttgggctataattttgttatattatttttattatagcattcagcacatgttattttgcttatattattttcattaaaactatttttgttataaaaaaaaaaaaaaaaaaaaa

SEQ ID NO: 66 - DNA, 2720 bp, Rattus norvegicus
ggaatttcccatcgcgggggctcgggtgttctgggccagccggcaggccctttctgtttacggagagaaaggggaaatggaaaaggcggggaggacgctggcgtcggctacgccgccccggggccagttcagacgccgagagtccggggctgcagcgtaccgctcctcccgctgcggatcgcccggcctttggtcggccgccggtcgtccggacgcccgtacgtctggctcccgctggcaagccacccgctgcccaccaagcccgagctccgggcgggcacacggaacactcagactccccagcaggcaccacagtgatggagtacatgagcaccggaagcgacgagaaagaagagattgatttattaattaaccatttaaacgtgtcggaagtcctggacatcatggagaacctttatgcaagtgaagagcctgcagtgtatgagcccagtctgatgaccatgtgtccagacagcaatcaaaacaaggaacattcagagtcgctgcttcggagtggccaggaggtgccctggttgtcgtctgtcagatatgggactgtggaggatctgcttgcatttgcaaaccatatctcgaatacgacaaagcatttttacagatgtcggccccaagaatctgggattttattaaatatggtaatcagtccccagaatggtcgctaccaaatcgactcggatgttctccttgtcccgtggaagctgacgtacaggagcattggttctggtttcgttcctcggggggcctttggaaaagtgtacttagcacaagacatgaagacaaagaaaagaatggcatgtaaactgatccctgtagatcagtttaagccatcagatgtggaaatccaggcctgcttccggcacgagaacattgccgagttatacggtgcggtcctatggggcgacactgtccatctcttcatggaagccggcgagggagggtctgtcctggagaagctggagagctgtgggcccatgagagaatttgaaattatctgggtgacaaagcacgttctcaagggacttgattttctgcactccaagaaagtcatccaccacgatatcaaacctagcaacattgtattcatgtctacgaaagctgtgttggtagattttggcctgagtgttcaaatgacagaagatgtctatctccccaaggacctccggggaacagagatctacatgagccctgaggtgattctgtgcaggggccattccacaaaagcagacatctacagccttggagccacgctcattcacatgcagacaggcaccccaccctgggtgaagcgctaccctcgatcggcctatccctcctacctgtacataatccacaagcaggcacctcccctggaagatattgctggtgactgcagtccaggcatgagggagctgatagaagccgccctggagaggaaccccaaccaccgcccaaaagcagcagacctactgaaacacgaagccctgaatcccccaagagaggaccagccacggtgtcagagtctggactctgccctctttgaccggaagaggctgctgagcaggaaggagctagaacttcctgagaacattgctgattcatcatgcacaggaagcaccgaggagtctgaagtgctcaggagacagcgttccctctacattgatctcggagctctggctggctacttcaatattgttcgtggtccaccaaccctggaatatggctgatggatgactctattggcaacagtagggcggatatttctctcctggatgttggtttcacagatcctacacagcagctctggatagtgaattttacccaatttttttaggaagcagggaggaggtctctagtgacacaagaatgtcaaagccctggccccctttgtgaagctcctctggcatgttccagagcccaaggttctcatttctcaggtggtgggactggacaaaagggagtggtgagctcaggaaagaatcatttctgatgacaattctattcactttgcactttaatggacattaaaaaatagctctcacaagatagtaacctaaaatacctgtttttggttcttatataaccatgggttcttcattcaactcagaagacctgatctgtgtatatatttgtgtgtattatatggtaactctttgtaccttggttggtagagtctagtataagtttagttaatagtattttgggtggatagaacaactctaatattacagcaattcactggactagtgtctcacaaatgactgatttactcagagccattaagcagcaggccactagtgagagtttctgttatgttcctatggaaacactgtgtattgtacgtgctatgcttaaaacatttaaaacacaatgttttaaatgtggacagaactgtgtaaaccacataatttctgtacatcccaaaggatgagaaatgtgaccttcaagaaaatggaaacatttgtaaattctttgtagtgatacctttgtaattaatgaaactatttttctttaaagtgtttctatattaaaaatagcatactgtgtatgttttattccaaaattccttcatgaatctttcatatatatatgtgtatatattttaacattgtaaagtatgagtattcttatttaaagtatatttttacattatgcaaatgaacttcaacgttttagtccaatgtgactggtcaaataaaccaaataaactgagtattttgtcttaa